(19) United States
(12) Patent Application Publication
(10) Pub. No.: US 2004/0039601 A1
(43) Pub. Date: Feb. 26, 2004

(54) Virtual file cabinet including health information method and apparatus

(76) Inventor: Corey D. Anderson, Centennial, CO (US)

Correspondence Address: Bradley M. Knepper, SHERIDAN ROSS P.C., 1560 Broadway, Suite 1200, Denver, CO, 80202-5141, US

(21) Appl. No.: 10/226,929

(22) Filed: Aug. 23, 2002

(51) Int. Cl. G06F 17/60

(52) U.S. Cl. 705/2

(57) ABSTRACT

A virtual file cabinet system for organizing and providing a central repository for personal information is provided. Information is maintained in the virtual file cabinet according to various categories. Information that is particular to individual users of the virtual file cabinet is maintained within each category of information. Access to information maintained in the virtual file cabinet may be had by the user with whom such information is associated, or by authorized third parties. Information maintained in the virtual file cabinet is collected through forms, and through direct deposit of information by service providers and others generating the information. Resources, arranged according to categories of information to which they generally pertain, are available to users through the virtual file cabinet. Reports containing information collected through forms or otherwise, and that may contain information generated in connection with the application of information to resources, may be generated. The virtual file cabinet allows for the convenient retrieval and storage of personal information in a secure, centrally accessible site.

### FIELD OF THE INVENTION

The present invention is directed to providing a secure, centralized store for personal data. In particular, the present invention facilitates the storage and retrieval of information related to an individual's biographical, health and/or financial information.

### BACKGROUND OF THE INVENTION

In modern society, a large amount of detailed information regarding various aspects of an individual's life is generated. The ability to access and retrieve such information is increasingly important. Accordingly, it is desirable to organize and store such information so that selected pieces of that information can be conveniently and reliably retrieved.

In order to provide for the secure and reliable storage and retrieval of personal information, individuals often maintain file cabinets containing paper documents on which biographical, health and financial information related to that individual and any immediate family members can be found. In order to aid in accessing desired information, files dividing such information into selected categories and subcategories are often created. However, even with a file cabinet containing narrowly targeted categories and subcategories of information, searching for a desired piece of information can be time consuming and frustrating. In addition, paper files are vulnerable to being lost or destroyed. Furthermore, retrieving information from a paper based filed system requires direct access to the files.

In order to increase the convenience with which information can be accessed, computerized databases may be created. However, computerized databases are time consuming to set up, and are not particularly useful in connection with the storage of many pieces of different types of information. In addition, the individual must decide what information to load into the database. Furthermore, although such databases can provide for search facilities and for making redundant copies of information, for security reasons such databases are generally not accessible from a terminal that is remote from the computer on which the database has been created.

Databases for storing personal information that are accessible from remote terminals over computer networks have also been proposed. However, such systems offer little advantage over databases that are established in a local computer, except for providing remote access. Because of the lack of advantages of such systems, and because of security concerns related to placing personal information on a computer network, such systems have been considered to be undesirable.

As computer networks are increasingly relied upon to transfer information and to conduct business generally, more and more enterprises store information regarding consumers on computers interconnected to such networks. Such systems can be a convenience to users in that personal information may be accessed from remote terminals. In addition, such systems provide a means for consumers to update information held by an enterprise regarding the consumer. However, there is very little integration between enterprises regarding information held by consumers. In part, this is due to privacy concerns. As a result, in order to update information held by enterprises regarding a consumer electronically, the consumer must typically inform each enterprise of a change in information regarding the user individually.

One reason that consumers require convenient access to their personal information is in connection with requesting or obtaining services. For example, insurance companies require detailed personal information regarding consumers requesting insurance. As a further example, lending institutions require detailed personal information before extending loans. As yet another example, detailed medical information is required by medical service providers. Without convenient access to one's personal information, the paper based or electronic forms typically used by insurance companies, lending institutions, and medical service providers are time consuming and laborious to complete.

It would be advantageous to provide a method and apparatus that allowed consumers to conveniently enter personal information. In addition, it would be advantageous to provide such a method and apparatus that allowed personal information to be conveniently and accurately retrieved. Furthermore, it would be advantageous to provide a method and apparatus that facilitated requests for services involving the provision of personal information, and that could be accessed from remote terminals.

### SUMMARY OF THE INVENTION

In accordance with the present invention, a method and apparatus for providing a secure, centralized store, or virtual file cabinet, for personalized data are provided. The present invention generally allows an individual to enter personal information for storage on a centrally accessible, secure site. In addition, service providers or others maintaining information regarding the individual may store that information on the site. Selected portions of stored information may be retrieved from the site in response to a properly authenticated request. Information retrieved from the site may be provided to the individual to whom the information pertains, as well as to parties designated by that individual.

The entry of information for storage may be facilitated by the use of forms. In particular, forms related to a selected category or subcategory of personal information may be provided by the virtual file cabinet system to a user. The user may then complete the form, and upload the responses to the central store. The use of forms facilitates the collection of information by providing a framework within which information is collected. In addition, the use of forms can organize the collection of information such that related information is collected during the completion of a particular form. This can make the provision of information by an individual user more convenient, for example, by limiting the source material that must be searched in order to complete a particular form.

The provision of personal information to the central store may also be at least partially automated. For example, records maintained or entered electronically by service providers, such as health care providers or financial institutions, or others, concerning an individual user may be provided to the central store electronically and maintained thereon.

Data in the centralized store or database may be characterized as belonging to at least one of a plurality of categories. In addition, data may be stored in the database according to category. Examples of such categories include biographical information, health information, and financial information.

The information maintained on the central store may be retrieved in the form of reports containing selected pieces of information. The reports may be generated according to the purpose for which the information has been requested. That is, the pieces of information that are included in a particular report may be selected according to the purpose for which the personal information is requested. For example, a report generated by the virtual file cabinet system in connection with a request for life insurance may include identifying biographical information, financial information, and information regarding the individual user's medical history. As a further example, a report generated in connection with a request for a loan may include identifying biographical information and information regarding the finances of the requesting individual. The report may be populated with the relevant data in response to instructions received from the individual user, or in response to a request for the report received from an authorized third party. The completed report may be provided to the user and/or a third party identified or authorized by the user.

In accordance with another embodiment of the present invention, information maintained in the central store regarding a plurality of individual users may be searched. For example, particular items of information maintained in the central store may be referenced in connection with a search by a third party for an individual or individuals having desired characteristics. Individuals who have given consent and who have the desired characteristics may then be identified.

In accordance with yet another embodiment of the present invention, resources for generating additional information are available through or in connection with the virtual file cabinet system. For example, an individual may manually enter information, or may authorize the provision of previously stored information, to a resource capable of using the provided information to generate additional information. Examples of such resources include tables or calculators capable of providing information based on and in response to provided information, such as body mass indexes, and mortgage calculators, and forms for requesting information from third parties, such as a driving record request. Furthermore, information generated by or in connection with resources may be incorporated into reports prepared by the virtual file cabinet system.

In accordance with an embodiment of the present invention, access to the central store is provided through a computer network, such as the Internet. Accordingly, an individual may access information related to that individual from any communication device or computer having access to that network. Similarly, authorized third parties may access information regarding an individual over the network.

### BRIEF DESCRIPTION OF THE DRAWINGS

FIG. 1 is a block diagram of a virtual file cabinet system in accordance with an embodiment of the present invention;

FIG. 2 is a block diagram of a terminal in accordance with an embodiment of the present invention;

FIG. 3 is a block diagram of a server in accordance with an embodiment of the present invention;

FIG. 4 is a diagram depicting the contents of a database in accordance with an embodiment of the present invention;

FIG. 5 is a flow diagram depicting the entry of information and the generation of reports in accordance with an embodiment of the present invention;

FIG. 6A is a flow chart depicting aspects of the operation of a virtual file cabinet in accordance with an embodiment of the present invention;

FIG. 6B is a flow chart depicting additional aspects of the operation of a virtual file cabinet in accordance with an embodiment of the present invention

FIG. 7 is a screen shot of a virtual file cabinet log in page in accordance with an embodiment of the present invention;

FIG. 8 is a screen shot of a virtual file cabinet category selection page in accordance with an embodiment of the present invention;

FIG. 9 is a screen shot of a biography home page in accordance with an embodiment of the present invention;

FIG. 10 is a screen shot of an “add a goal” page in accordance with an embodiment of the present invention;

FIG. 11 is a screen shot of an additional aspect of an “add a goal” page in accordance with an embodiment of the present invention;

FIG. 12 is a screen shot of a “view all goals” or “edit goals” page in accordance with an embodiment of the present invention;

FIG. 13 is a screen shot of an “edit goal” page after selection of a goal to edit in accordance with an embodiment of the present invention;

FIGS. 14A-14B are screen shots of a general information form in accordance with an embodiment of the present invention;

FIG. 15 is a screen shot of a contacts form in accordance with an embodiment of the present invention;

FIGS. 16A-16B are screen shots of a career information form in accordance with an embodiment of the present invention;

FIG. 17 is a screen shot of an education form in accordance with an embodiment of the present invention;

FIG. 18 is a screen shot of a civic involvement form in accordance with an embodiment of the present invention;

FIG. 19 is a screen shot of a hobbies and sports form in accordance with an embodiment of the present invention;

FIG. 20 depicts a driving record request template resource in accordance with an embodiment of the present invention;

FIG. 21 is a screen shot of a file uploader utility resource in accordance with an embodiment of the present invention;

FIGS. 22A-22B are screen shots of a biography report in accordance with an embodiment of the present invention;

FIG. 23 is a screen shot of a contacts report in accordance with an embodiment of the present invention;

FIG. 24 is a screen shot of a resume selector in accordance with an embodiment of the present invention;

FIG. 25 is a screen shot of an example resume created in accordance with an embodiment of the present invention;

FIG. 26 is a screen shot of a transcript report in accordance with an embodiment of the present invention;

FIG. 27 is a screen shot of a health home page in accordance with an embodiment of the present invention;

FIG. 28 is a screen shot of a health goals page in accordance with an embodiment of the present invention;

FIGS. 29A-29B are screen shots of a general health information form in accordance with an embodiment of the present invention;

FIG. 30 is a screen shot of an insurance information form in accordance with an embodiment of the present invention;

FIG. 31 is a screen shot of an allergy information form in accordance with an embodiment of the present invention;

FIG. 32 is a screen shot of a medication information form in accordance with an embodiment of the present invention;

FIGS. 33A-33D are screen shots of a medical condition information form in accordance with an embodiment of the present invention;

FIG. 34 is a screen shot of a surgeries and therapies information form in accordance with an embodiment of the present invention;

FIG. 35 is a screen shot of a laboratory test information form in accordance with an embodiment of the present invention;

FIGS. 36A and 36B are screen shots of an immunization information form in accordance with an embodiment of the present invention;

FIGS. 37A and 37B are screen shots of a medical questionnaire information form in accordance with an embodiment of the present invention;

FIGS. 38A and 38B are screen shots of a dental information form in accordance with an embodiment of the present invention;

FIGS. 39 is a screen shot of a vision information form in accordance with an embodiment of the present invention;

FIG. 40 is a screen shot of a cholesterol resource in accordance with an embodiment of the present invention;

FIG. 41 is a screen shot of a blood pressure resource in accordance with an embodiment of the present invention;

FIG. 42 is a screen shot of an ideal weight resource in accordance with an embodiment of the present invention;

FIG. 43 is a screen shot of a risk of coronary disease resource in accordance with an embodiment of the present invention;

FIG. 44 is a screen shot of a personal energy resource in accordance with an embodiment of the present invention;

FIG. 45 is a medical information bureau disclosure request in accordance with an embodiment of the present invention;

FIGS. 46A and 46B are screen shots of a health report in accordance with an embodiment of the present invention;

FIGS. 47A-47E are screen shots of an underwriting report in accordance with an embodiment of the present invention;

FIG. 48 is a screen shot of an immunization report in accordance with an embodiment of the present invention;

FIGS. 49A and 49B are screen shots of a medical history report in accordance with an embodiment of the present invention;

FIGS. 50A and 50B are screen shots of a dental report in accordance with an embodiment of the present invention;

FIGS. 51A-51C are screen shots of a vision report in accordance with an embodiment of the present invention;

FIG. 52 is a screen shot of a finances home page in accordance with an embodiment of the present invention;

FIG. 53 is a screen shot of an “add a reminder” page in accordance with an embodiment of the present invention;

FIG. 54 is a screen shot of an “edit reminders and goals” form in accordance with an embodiment of the present invention;

FIG. 55 is a screen shot of a financial summary form in accordance with an embodiment of the present invention;

FIG. 56 is a screen shot of an update financial information form in accordance with an embodiment of the present invention;

FIG. 57 is a screen shot of a personal assets information form in accordance with an embodiment of the present invention;

FIG. 58 is a screen shot of an income information form in accordance with an embodiment of the present invention;

FIG. 59 is a screen shot of an insurance information form in accordance with an embodiment of the present invention;

FIG. 60 is a screen shot of a real estate information form in accordance with an embodiment of the present invention;

FIGS. 61A and 61B are screen shots of a financial concepts information resource in accordance with an embodiment of the present invention;

FIG. 62 is a personal credit report request in accordance with an embodiment of the present invention;

FIG. 63 is a social security information request in accordance with an embodiment of the present invention;

FIG. 64 is a screen shot of mortgage calculator resource in accordance with an embodiment of the present invention;

FIG. 65 is a screen shot of an interest calculator resource in accordance with an embodiment of the present invention;

FIG. 66 is a screen shot of a return on investment calculator resource in accordance with an embodiment of the present invention;

FIG. 67 is a screen shot of a return on assets calculator resource in accordance with an embodiment of the present invention;

FIG. 68 is a screen shot of an arithmetic return calculator resource in accordance with an embodiment of the present invention;

FIG. 69 is a screen shot of an accounting rate of return calculator resource in accordance with an embodiment of the present invention;

FIGS. 70A and 70B are screen shots of a finance report in accordance with an embodiment of the present invention;

FIGS. 71A and 71B are screen shots of an asset allocation report in accordance with an embodiment of the present invention;

FIG. 72 is a screen shot of a journal information home page in accordance with an embodiment of the present invention;

FIG. 73 is a screen shot of an “add a goal” page in accordance with an embodiment of the present invention;

FIG. 74 is a screen shot of an “edit goals” page in accordance with an embodiment of the present invention;

FIG. 75 is a screen shot of a daily journal entry form in accordance with an embodiment of the present invention;

FIG. 76 is a screen shot of a novel information form in accordance with an embodiment of the present invention;

FIG. 77 is a screen shot of a to do list form in accordance with an embodiment of the present invention;

FIG. 78 is a screen shot of search utility resource in accordance with an embodiment of the present invention;

FIG. 79 is a screen shot of a journal report in accordance with an embodiment of the present invention;

FIG. 80 is a screen shot of a novel entry report in accordance with an embodiment of the present invention;

FIG. 81 is a screen shot of a to do list report in accordance with an embodiment of the present invention;

FIG. 82 is a screen shot of an account manager page in accordance with an embodiment of the present invention; and

FIG. 83 is a screen shot of an interest update form in accordance with an embodiment of the present invention.

### DETAILED DESCRIPTION

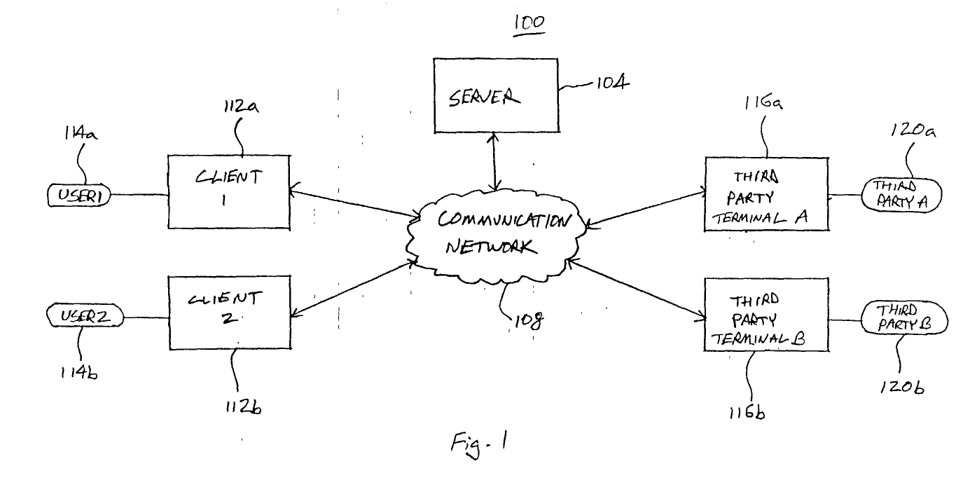

The present invention is directed to a virtual file cabinet system that provides for the collection and maintenance of personal information at a central location, such that selected items of information may be easily located and used by authorized users or third parties. FIG. 1 is a block diagram of a virtual file cabinet system 100 in accordance with an embodiment of the present invention. In general, the virtual file cabinet system 100 includes a server or control 104 interconnected to a communication network 108. The server or control 104 may comprise one or more general purpose server computers. The server or control 104 may include mass storage devices provided as part of or interconnected to the server computers. The communication network 108 may comprise one or more communication or computer networks. For example, the communication network 108 may include the public switched telephony network (PSTN), a local area network, a wide area network, or a combination of networks. Furthermore, the communication network 108 may comprise the Internet.

Interconnected to the server or control 104 through the communication network 108 are a plurality of client terminals 112. In general, the client terminals 112 are associated with individual users 114. A client terminal 112 may be utilized by an associated user 114 to enter information for storage in the virtual file cabinet established in connection with the server 104. Furthermore, the client terminal 112 may be utilized to retrieve information from the server 104 through the communication network 108. Accordingly, as can be appreciated, the client terminals 112 may comprise any device or devices capable of receiving user input and communicating across a communication network 108. Furthermore, the client terminals 112 may comprise devices capable of providing output to a user 114. Accordingly, the client terminals 112 may include general purpose computers, laptop computers, personal digital assistants (PDAs), and other such devices.

The virtual file cabinet system 100 may additionally include third party terminals 116. The third party terminals 116 are typically associated with third parties 120 such as service providers or others that may be granted access to personal information associated with one or more users 114 who have stored personal information in the virtual file cabinet system 100. Accordingly, third parties 120 utilizing third party terminals 116 may include medical service providers, such as doctors, pharmacies, and hospitals. As a further example, third party terminals 116 may be associated with financial institutions, including banks and insurance companies. Third parties 120 may also include educational institutions and government entities, such as the Social Security Administration. The third party terminals 116 may comprise general purpose computers capable of communication over the communication network 108. Furthermore, the third party terminals 116 are generally capable of receiving input that can be transmitted to the server 104 to verify the identity and/or authority of the third party 120 to receive personal information regarding an individual user 114. In addition, the third party terminals 116 generally include an output device for providing requested information to the third party 120 (e.g., through an agent of the third party 120) associated with the third party terminal 116.

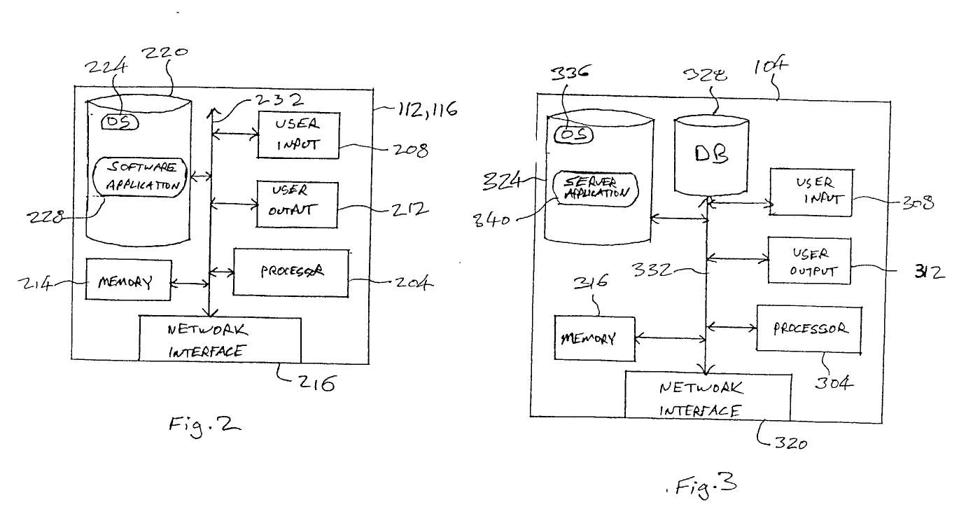

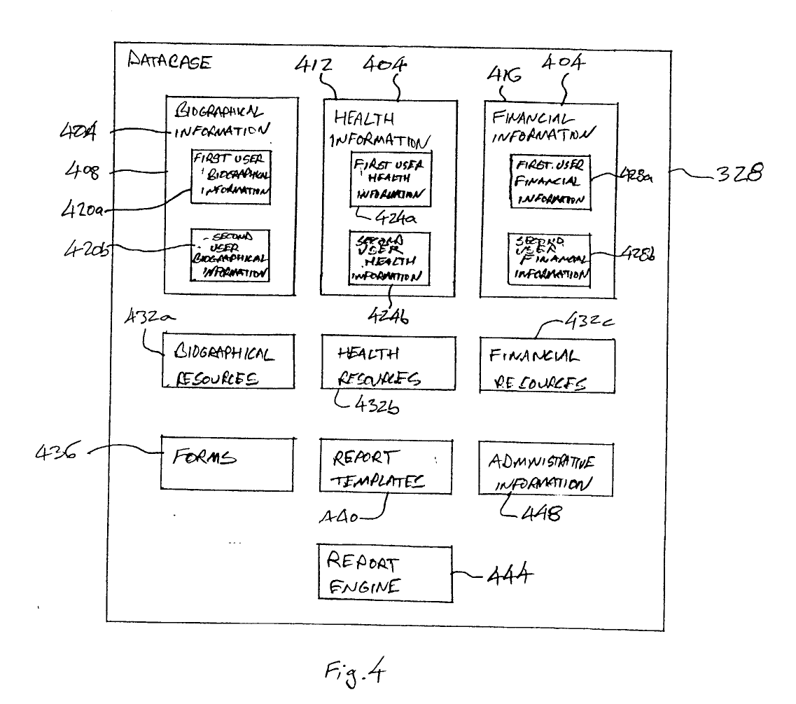

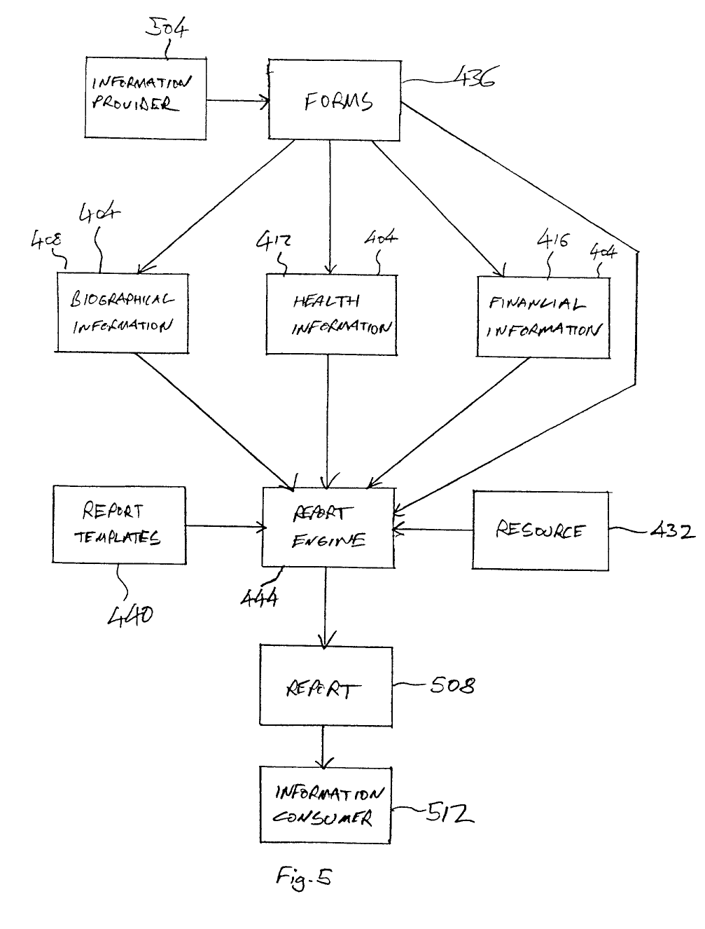

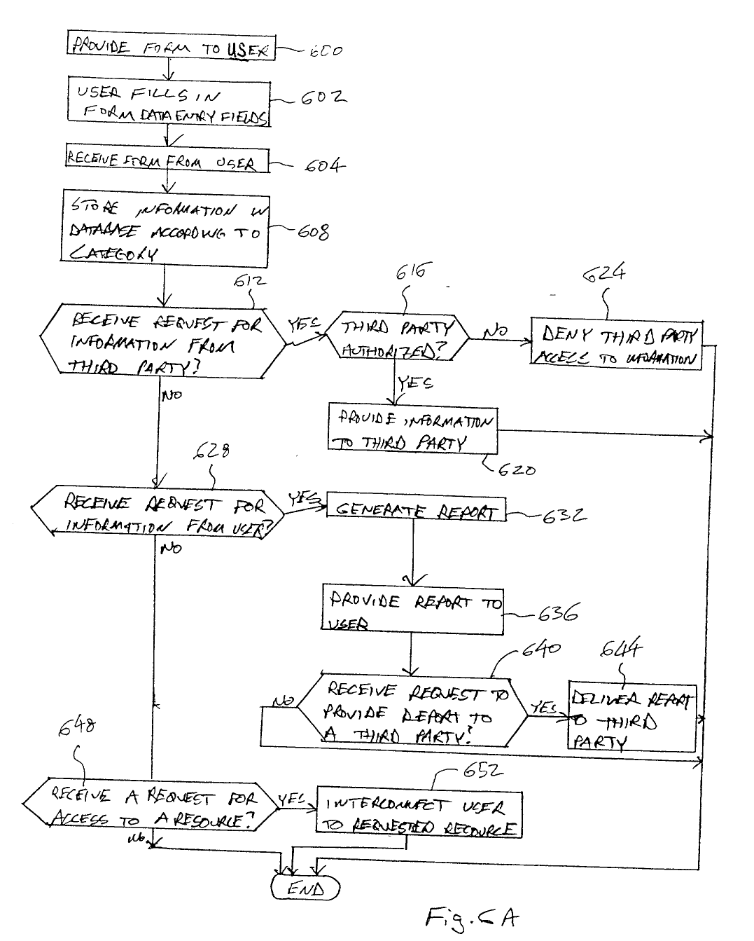

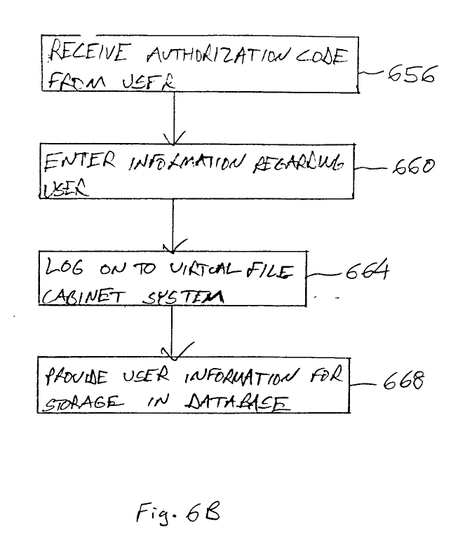

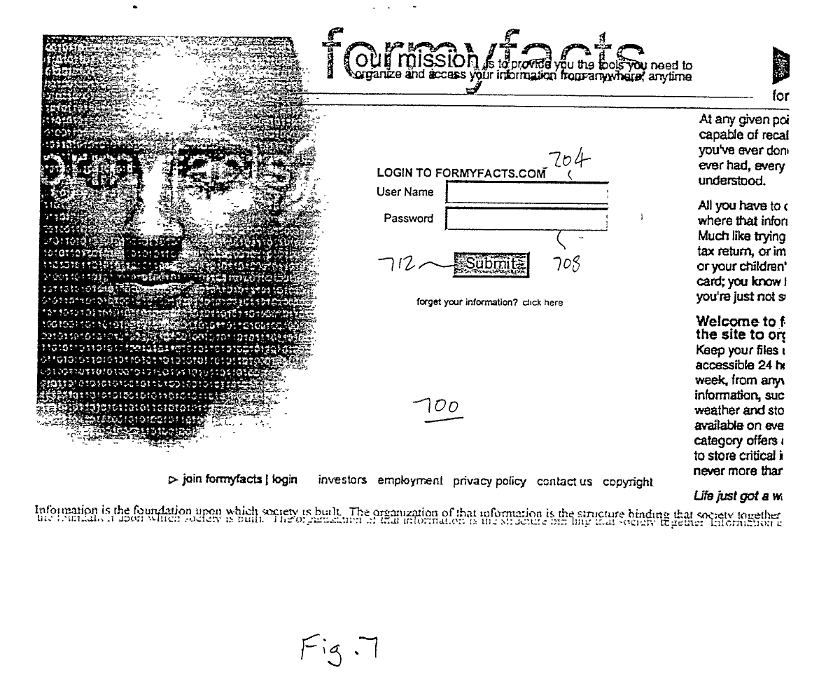

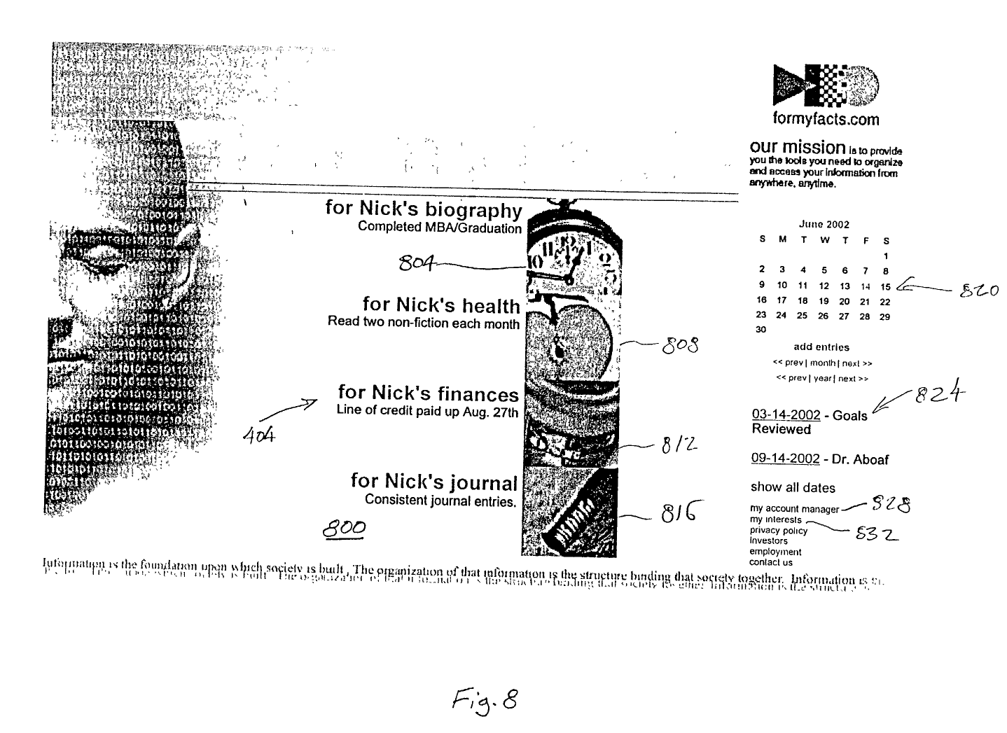

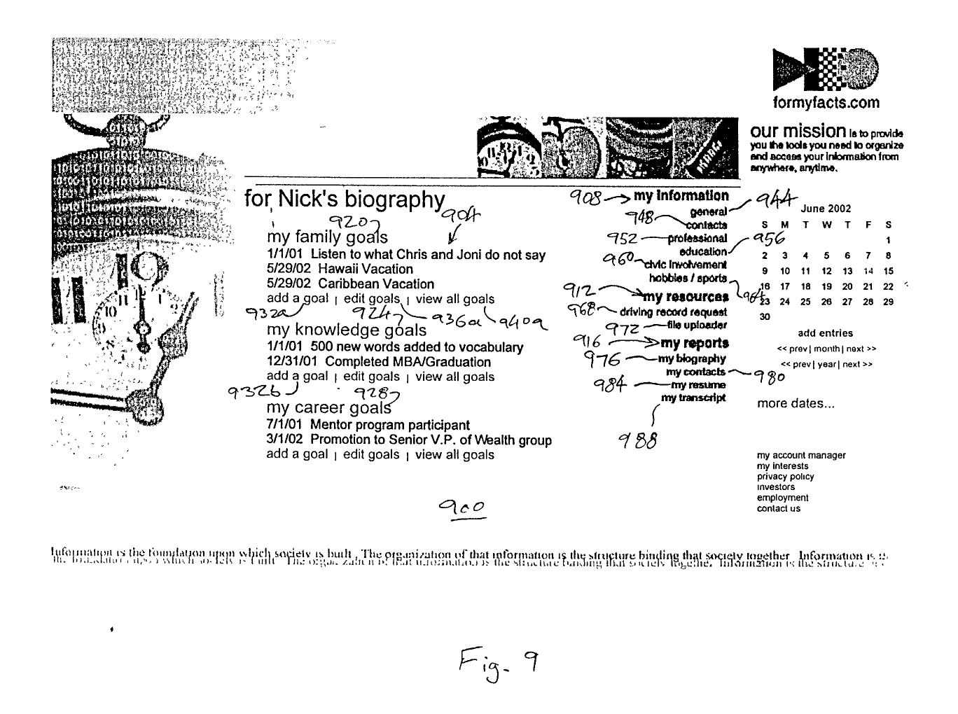

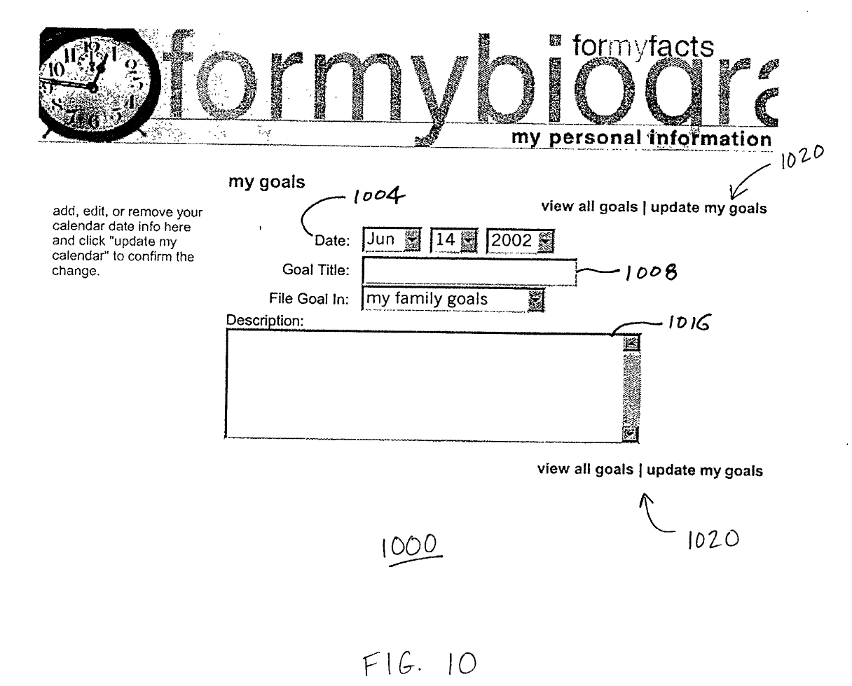

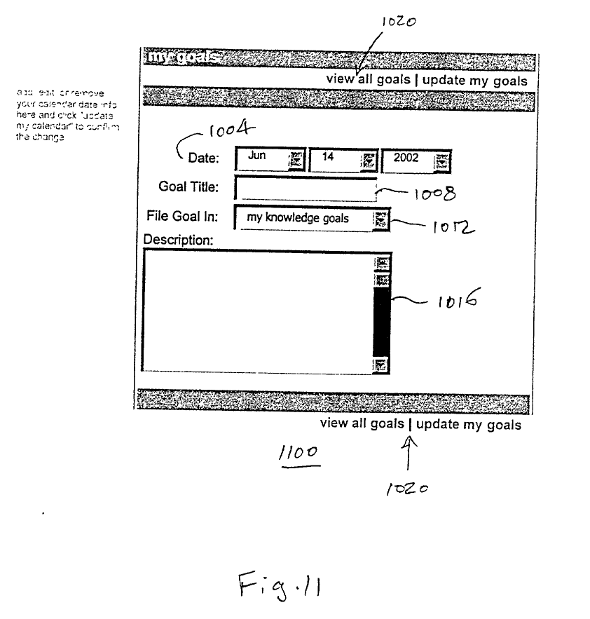

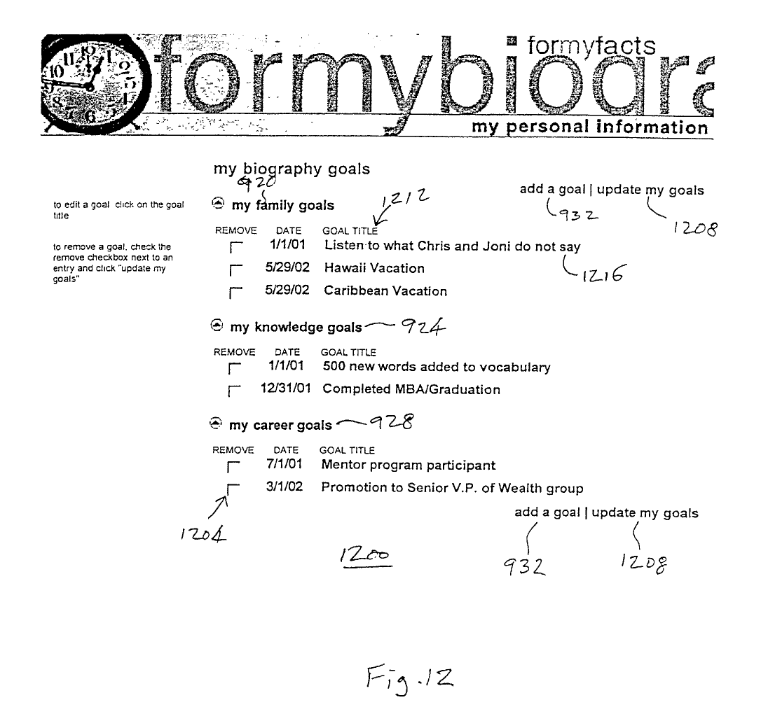

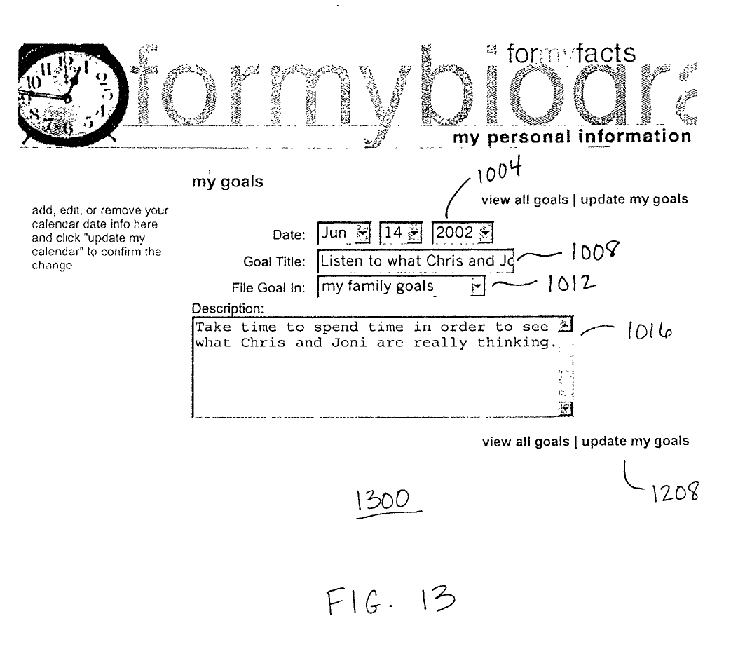

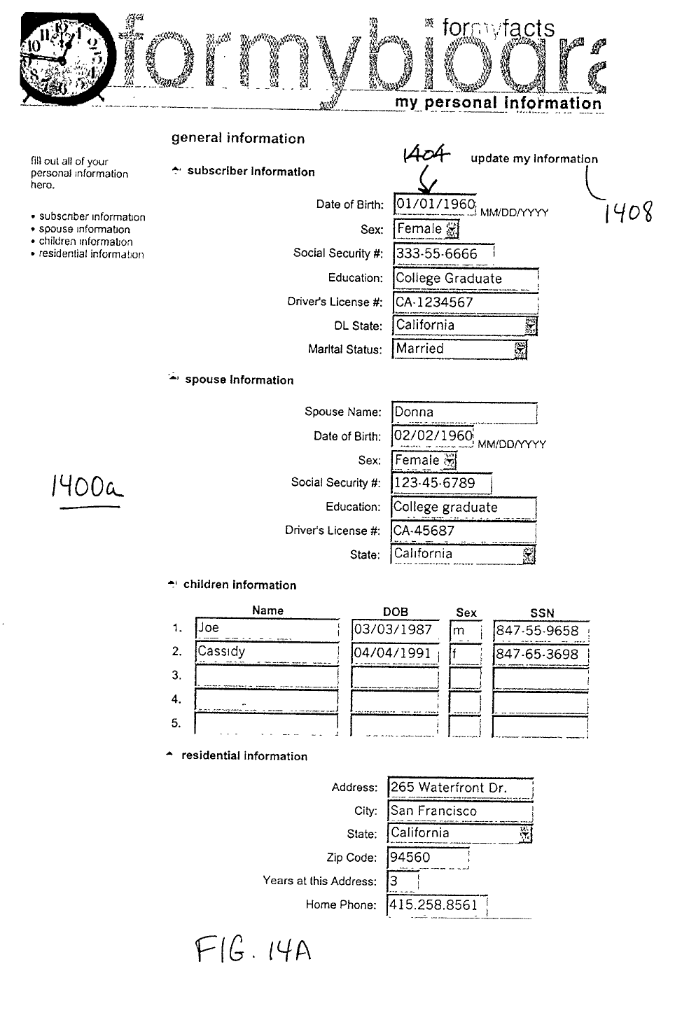

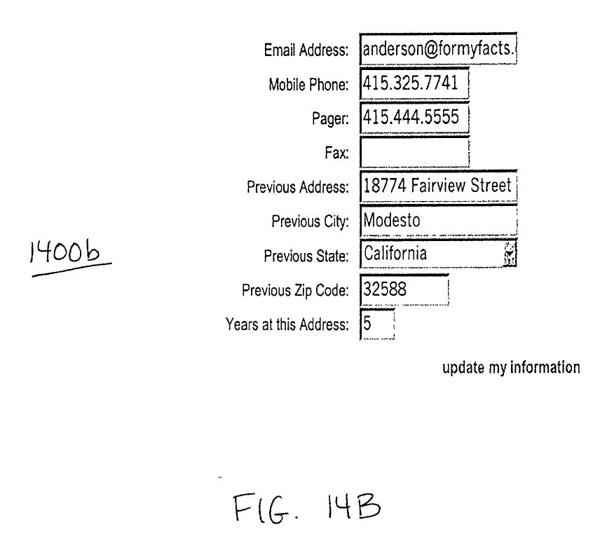

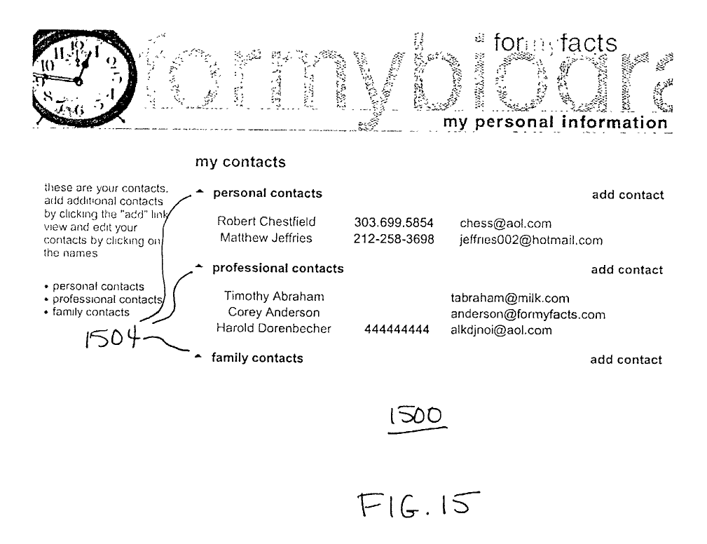

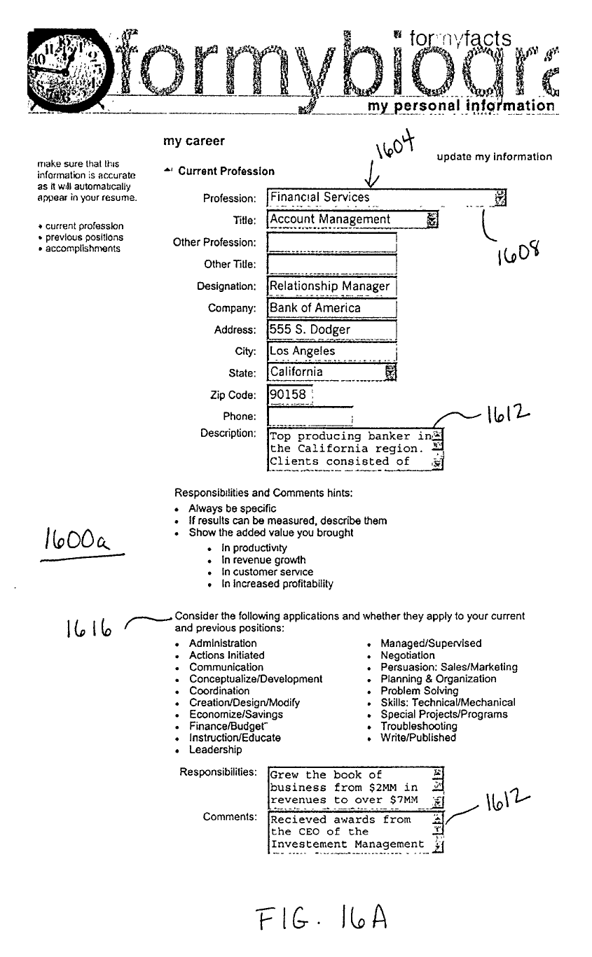

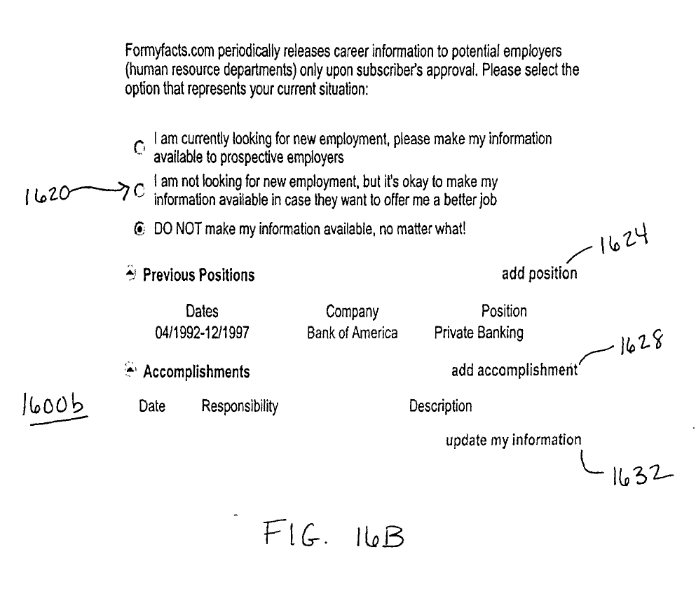

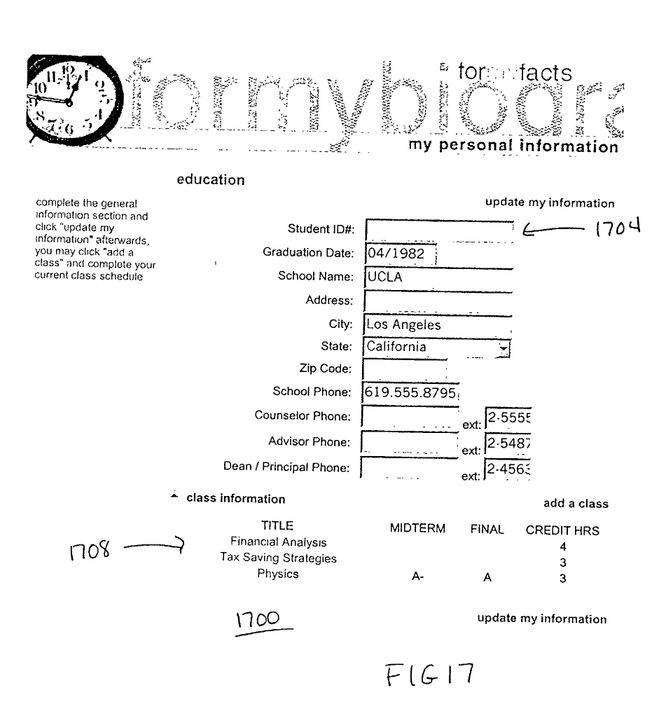

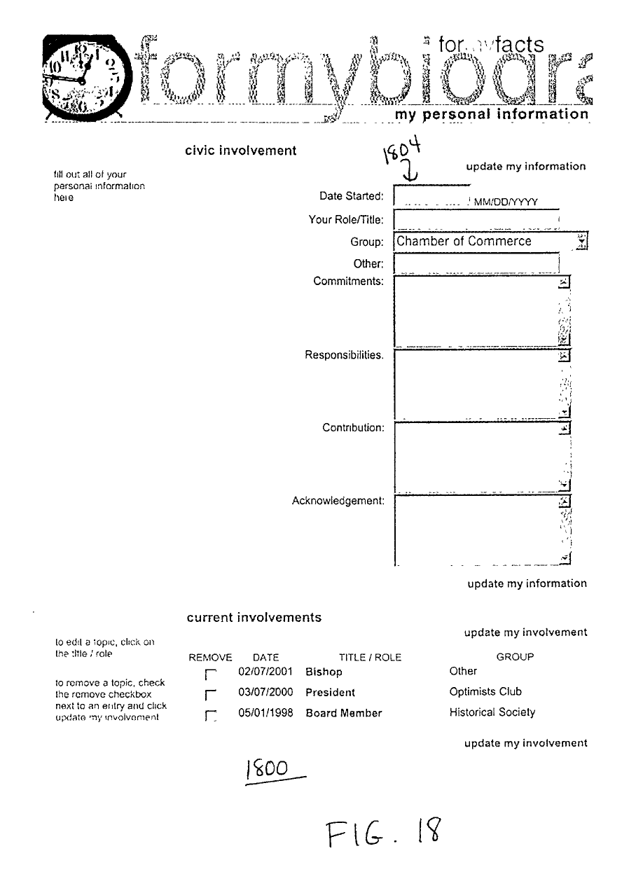

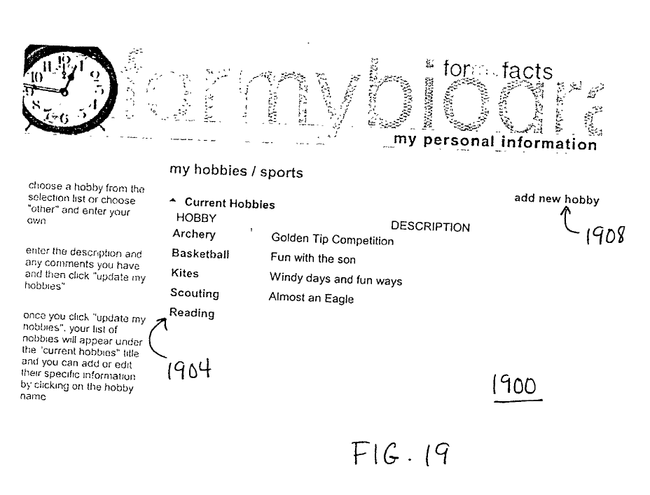

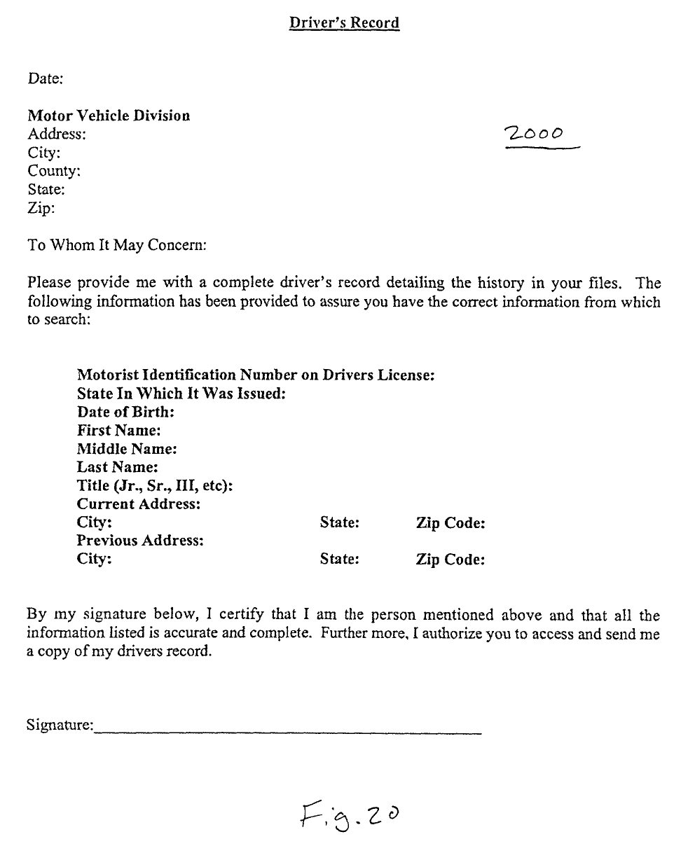

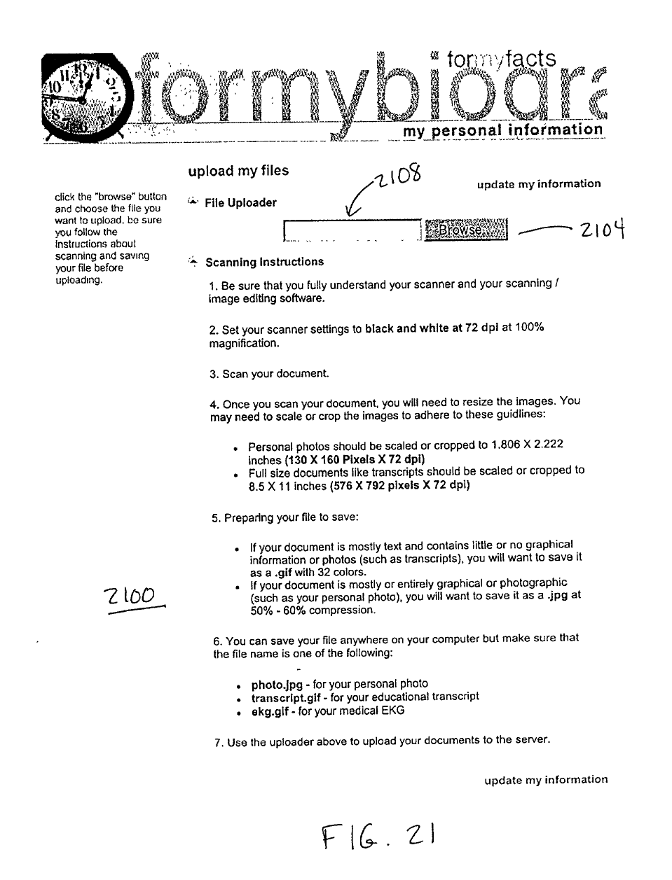

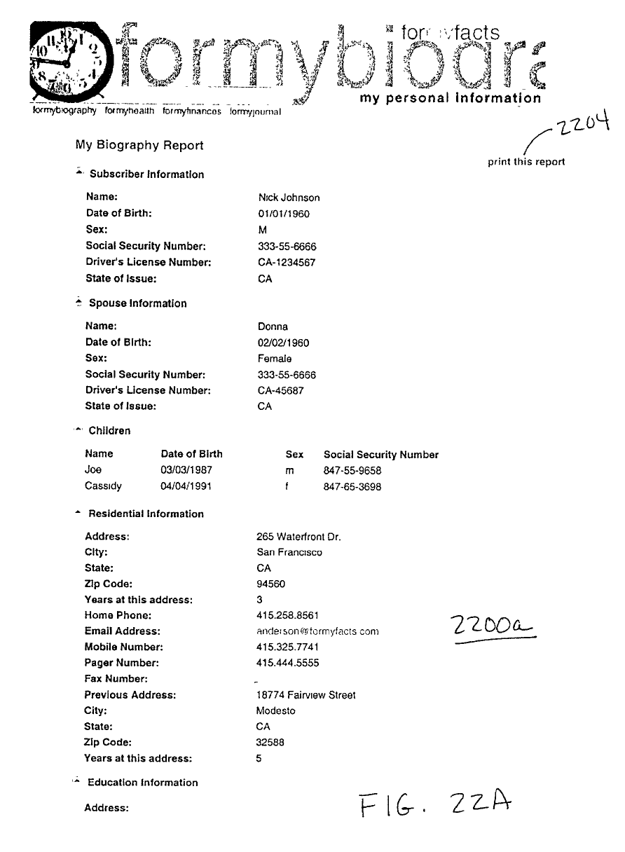

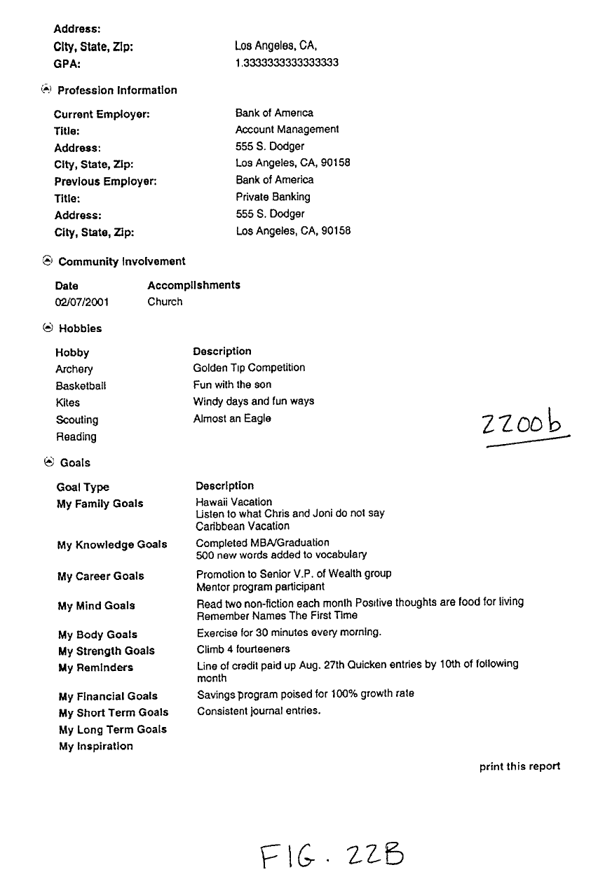

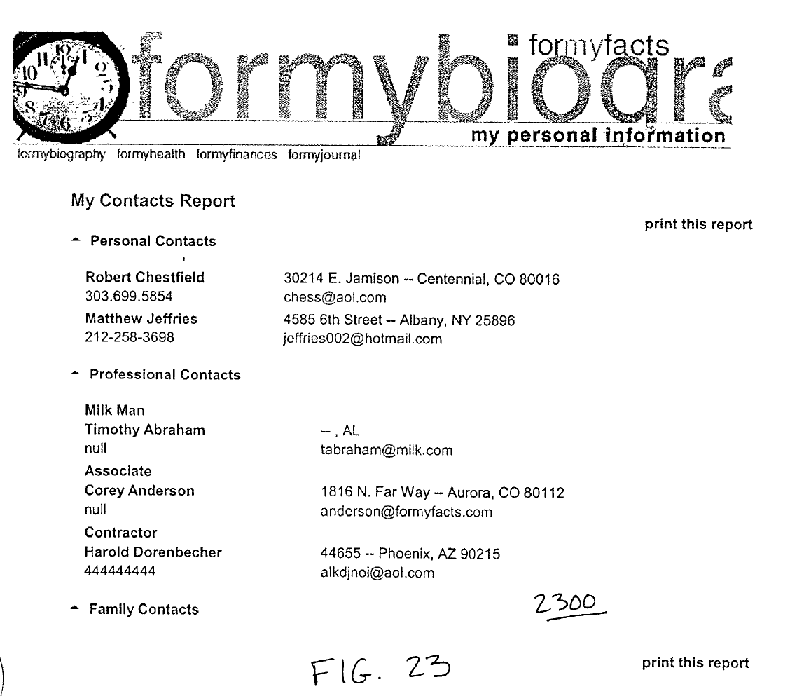

With reference now to FIG. 2, a block diagram of a client 112 or third party 116 terminal in accordance with an embodiment of the present invention is illustrated. The terminal 112, 116 generally includes a processor 204, a user input 208, and a user output 212. In addition, the terminal 112, 116 includes memory 214, a network interface 216 and data storage 220. The data storage 220 may include, for example, an operating system 224 and one or more application programs 228, such as a communication software application. The various components 204-220 of the terminal 112, 116 may be interconnected by a communication bus 232. As noted above, a terminal 112, 116 may comprise any one of a variety of devices capable of communicating over the communication network 108. Thus, the terminal 112, 116 may comprise a general purpose computer having a general purpose programmable processor 204, such as a Pentium™ processor, a digital signal processor, or a controller. The user input 208 may include a keyboard, keypad, pointing device, microphone, barcode reader, magnetic card reader, or a personal identification system, such as a retinal scanner or a fingerprint reader. User output 212 may include a visual display, such as a flat panel display, an audible output, and a printer. Furthermore, it can be appreciated that the user input 208 and user output 212 may be at least partially combined, for example, in connection with a touch screen. Also, it should be appreciated that the user input 208 and user output 212 may each include a plurality of devices.

The memory 214 generally provides temporary storage for data or programs running on the terminal 112, 116. The network interface 216 provides interface between the terminal 112, 116 and the communication network 108. Accordingly, the network interface 216 may comprise a modem, or network access card, such as an Ethernet interface card.

The operating system 224 and application 228 will in many cases be dependent upon the particular terminal 112, 116 with which the software 224, 228 is associated. For example, a terminal 112, 116 comprising a laptop or desktop computer may include a Windows™ operating system 224 and Internet Explorer™ browser application 228. As a further example, a terminal 112, 116 comprising a PDA may have a Palm™ operating system 224 and a PALM™ compatible Internet browser application 228. As still another example, terminal 112, 116 comprising a cellular telephone may include a proprietary operating system 224 and a proprietary Internet browser application 228.

With reference now to FIG. 3, a server or control 104 in accordance with an embodiment of the present invention is illustrated in block diagram form. In general, the server 104 may include a processor 304, a user input 308, and a user output 312. In addition, the server 104 includes memory 316. The server 104 also includes a network interface 320, data storage 324, and a database 328. The various components 304-328 of the server 104 may communicate with one another over a communication bus 332.

As noted above, the server 104 may comprise a general purpose information or data server computer. Accordingly, the processor 304 of the server 104 may comprise one or more general purpose processors, such as Pentium™ processors. Typically, a user input 308 and user output 312 are provided for administering the server 104. As can be appreciated, the user input 308 may include a keyboard and a pointing device. As can further be appreciated, the user output 312 may include a display. The memory 316 generally comprises temporary storage for programs running on the server 104, or data being accessed, provided, or operated upon by the server 104. The network interface 320 generally allows the server 104 to be in communication with the terminals 112, 116 over the communication network 108. Accordingly, the network interface 320 may include a network interface, such as an ethernet interface. The data storage 324 may include any device suitable for storing computer data. For example, the data storage 324 may include a hard disk drive or solid state memory. In addition, the data storage 324 may comprise a variety of such devices.

An operating system 336 and a server application 340 may be stored on the data storage 324. An example of an operating system 336 suitable for use in connection with a server 104 is the Windows NT™ operating system. The server application 340 generally functions to communicate with a communication software application 228, such as an Internet browser, running on a terminal 112 or 116. In addition, the server application 340 may function to regulate the collection of data for storage on the database 328, and the provision of data from the database 328 in response to requests.

The database 328 generally serves as a store for information included in a virtual file cabinet provided in connection with the present invention. Accordingly, the database 328 stores personal information regarding individual users. Furthermore, the personal information stored on the database 328 is categorized into at least one of a plurality of categories. In addition to storing personal information regarding users, the database 328 may store templates of forms used to obtain information from users, and report templates used to output information in an organized manner to a user 114 or third party 120 associated with a terminal 112 or 116. The database 328 may be implemented within or on the data storage 324. Alternatively or in addition, the database 328 may be implemented in connection with a storage device or devices that are separate from the data storage 324. In accordance with an embodiment of the present invention, the database 328 is implemented in connection with a redundant array of inexpensive disks (RAID) subsystem.

With reference now to FIG. 4, a diagram depicting the contents of a database 328 in accordance with an embodiment of the present invention is illustrated. In general, the database 328 contains information belonging to one or more of a plurality of categories of information 404. Individual categories of information 404 may include biographical information 408, health information 412, and financial information 416. Within each category of information 404, information may be separately maintained for different individual users 114. Thus, biographical information regarding a first user 420a may be maintained as part of the category of biographical information 408 separately from biographical information regarding a second user 420b. Similarly, health information 412 regarding a first user 424a and a second user 424b may be maintained in the database 328 as distinct sets of information. As a further example, financial information regarding a first user 428a and regarding a second user 428b may be maintained separately within the category of financial information 416. The division of information into categories 404 facilitates the collection, storage and retrieval of information. As can be appreciated by one of skill in the art, the information may be stored in fields provided as part of records belonging to a particular category of information 404 and user 114. As can be appreciated, additional or alternative categories of information 404 may be maintained as part of the database 328.

The database 328 may additionally include a plurality of resources 432. For example, biographical 432a, health 432b, and financial 432c resources may be provided. The various resources 432 may include calculators, tables, and reference materials that may be used in connection with information regarding users 114 stored as one of the categories of information 404, or provided by a user 114 specifically for use in connection with a resource 432.

For example, a biographical resource 432a may provide general information, including career information, to a user 114. Accordingly, a biographical resource 432a may include reference material such as a resume tutorial to assist a user 114 in preparing a resume. As another example, a biographical resource 432a may include a personality exam, to assist a user 114 in selecting a career that is compatible with the interests and abilities of the user 114. Other examples of biographical resources 432a include a driving record request resource and a file uploader for providing photographs and other biographical information 408 to the database 328 for storage.

Health resources 432b generally provide information to assist a user 114 in assessing or maintaining their health. Accordingly, a health resource 432 may include a growth chart, an ideal body weight calculator, a body mass index calculator, cholesterol information, blood pressure information, an immunization chart, a Medical Information Bureau (MIB) information request, and information regarding particular conditions. A health resource 432b may additionally include a file uploader for providing health information 412 for storage in connection with the user 114.

Financial resources 432c generally allow a user 114 to assess their financial situation, and to assist a user 114 in obtaining information about the user held by others. Accordingly, financial resources 432c may include mortgage calculators, financial definitions, return on investment calculators, and tools to assist users 114 in organizing financial asset and liability information. Examples of financial resources 432c that assist a user 114 in requesting information include a Social Security information request and credit report requests.

The database 328 may additionally serve as a store for forms 436 used to collect information 404 from users 114. In general, forms 436 are organized by category. For example, a first form may request biographical information 408 from a user 114. Such biographical information 408 may include the user's 114 name, address and other identifying information, such as the user's Social Security number. Another form 436 may be provided for collecting health information 412 regarding a user 114. Accordingly, a form 436 for obtaining health information 412 may prompt a user 114 for information regarding preexisting medical conditions and medical history. Another example of a form 436 is a form adapted for collecting financial information from a user 114. A form 436 for collecting financial information 416 may prompt a user 114 for information regarding assets and liabilities. It should be appreciated that a user 114 need not provide every item of information requested by a form 436 in order for the form 436 to be successful in collecting information. Furthermore, it should be appreciated that a form 436 can be utilized in multiple sessions. Accordingly, a user can continue providing responses to inquiries presented as part of a form 436 as time permits, or as the user 114 collects required information. Forms 436 may also be used to solicit information from third parties 120 that generate and/or maintain information regarding a user 114.

The use of forms 436 can assist a user 114 in efficiently organizing and collecting personal information. In particular, forms 436 provide a structured series of inquiries to assist a user 114 in collecting important pieces of information for use in connection with a wide variety of personal activities, including requests for services or other activities that require the provision of certain personal information to a third party. Furthermore, the forms 436 are typically arranged by themes or categories of information 404, so that a user 114, for example, entering information from paper records, can reference particular types of documents in connection with providing responses to any one form 436.

The database 328 may additionally include report templates 440 and a report engine 444 for generating reports. In particular, report templates 440 may be populated with information drawn from the categories of information 404 regarding a particular user 114 by the report engine 444. Examples of reports that may be generated include reports generated in connection with a request for health or life insurance, or for a car loan. For instance, in connection with a request from a first user 114a for health insurance, relevant pieces of information may be drawn from the first user biographical information 420a, and the first user health information 424a. A report generated in connection with a request by a first user 114a for a car loan may draw information from the first user biographical information 420a and the first user financial information 428a.

In general, the information included in a particular report template 440 is adapted to provide a convenient summary of personal information relevant to a particular aspect of a user's 114 life, or to provide a third party 120 with information relevant to a request made by the user 114 in connection with the provision of the information. Furthermore, the use of report templates 440 and a report engine 444 allows a user 114 to conveniently and quickly provide information related to a variety of request types that would otherwise be laborious and time consuming to prepare. For example, a user 114 may make a request for insurance simply by directing the report engine 444 running on the server 104 to populate an appropriate report template 440 and to print the report or deliver the report to the insurer (i.e. the third party 120) over the communication network 108. Furthermore, the use of report templates 440 facilitates obtaining competitive bids from service providers. For example, a report template 440 populated with information for use in connection with a request for insurance may be provided to a number of insurers, without requiring any additional effort on the part of the user 114, apart from directing that the report be provided to more than one insurer. Where particular service providers require particular information, or require that provided information be formatted in a particular way, report templates 440 may be obtained from such service providers (or created according to their specifications), and populated with information regarding the user 114 that is maintained on that database.

The database 328 may additionally store administrative information 448. The administrative information 448 may include account information regarding individual users 114. In addition, access codes may be maintained as part of the administrative information 448 for permitting access by users 114 themselves, or by authorized third parties, such as personal physicians, emergency service providers, etc. In connection with access by third parties 120 authorized by a user, reports containing pertinent personal information regarding that user 114 can be generated and delivered to the third party 120 in response to that party's request. For example, a first user's 114a health information 424a can be provided to a third party 120 emergency medical services provider assisting the first user 114a. Such authorization may be obtained by, for example, establishing a connection between the third party's terminal 116 and the server 104 and entering an authorization code carried by the first user 114a as part of a medical identification card.

With reference now to FIG. 5, a flow diagram depicting the flow of information through a virtual file cabinet system 100 in accordance with an embodiment of the present invention is shown. Initially, forms 436 are used to solicit information from information providers 504 in connection with a user 114. An information provider 504 may include the individual user 114, and others having information regarding the user 114, including third parties 120. In general, a form 436 may be presented to the user as part of an initial user registration (e.g., for the collection of general biographical information 408). In addition, a form 436 may be presented to a user 114 and/or a third party 120 in connection with a particular category of information 404 selected by the user 114. Furthermore, the solicitation of information from a user may be organized by category and subcategory, to further facilitate the collection of such information. For instance, a user 114 may choose to work with biographical information 408. In response to the user's selection, various subcategories of forms may be presented. In order to add or edit information, the user 114 may then select a particular form. As used herein, forms 436 may include data structures used by third parties 120 to organize information. For example, a third party 120 service provider may make records, including billing information, available for storage in the database 328 in connection with a user 114, in which case the records function as a form. Such information may also be made available to the database 328 as the information is generated or stored on a terminal 116 associated with a third party 120.

The information collected in connection with a form 436 may then be provided to an appropriate category of information 404, such as biographical information 408, health information 412, and financial information 416. Although forms 436 are generally targeted to a particular category of information, it can be appreciated that there might be some overlap in the information collected by a first form 436 and a second form 436. Accordingly, information collected by a particular form 436 may be stored as one or more categories of information 404.

The information collected in connection with a form 436 and stored in the database 328 may be provided to a report engine 444. In general, the report engine 444, in response to a request for a particular report 504, accesses report templates 440 and categories of information 404 to create the requested report 504. As noted above, a report 508 may be tailored to provide information regarding a particular request or requirement. For instance, a report 508 may be generated in connection with a request for services.

In addition to drawing select pieces of information stored on the database 328 into a report template 440, the report engine 444 may also access a resource 432 in populating a report template 440. For example, the report engine 444 may provide height and weight information to a body mass index calculator resource so that a body mass index value may be provided as part of a report 508 summarizing the health of the user 114.

The report engine 444 may also function in connection with a form 436. For example, a user 114 may request a report by using a form in which the user 114, as an information provider 504, manually enters information. In addition to manually entered information, data may be drawn from the categories of information 404 automatically. Accordingly, it can be appreciated that information from both categories of information 404 and manually entered by a user immediately before the report 508 is generated may be used by the report engine 444.

The report 504 generated by the report engine 444 may then be made available to an information consumer 512. An information consumer 512 may include a user 114 or a third party 120. Furthermore, a report 508 may be distributed to multiple information consumers 512. For example, a report 508 may be provided to the user 114 in connection with whom the report 508 was generated, or to one or more third parties 120 authorized by the user 114 to receive the report 508.

With reference now to FIG. 6A, a flow chart depicting aspects of the operation of a virtual file cabinet system 100 in accordance with an embodiment of the present invention is illustrated. Initially, at step 600, a form 436 is provided to a user 114 through a client terminal 112. As can be appreciated by one of skill in the art, the form 436 may be provided to the terminal 112 by the server 104 over the communication network 108 as a web page. In general, the form 436 that is provided to the user 114 may depend upon whether the user 114 has previously entered information for storage in the database 328 of the virtual file cabinet, or on the selection of the user if that user is already registered. If the user 114 is a new user, the form 436 may solicit general information, including billing information, regarding the user, so that an account can be established. If the user 114 is already a registered user of the virtual file cabinet system 100, the user 114 may select a form 436 to work with. The user may then fill in all or some data entry fields included in the form 436 (step 602). After providing responses to the fields included in the form 436, the user 114 may send the completed (or partially completed) form back across the communication network 108 to the server 104. At step 604, the form 436, with the user's responses, is received by the server or control 104.

The information received in connection with the form 436 is then stored in the database 328 according to the category 404 assigned to each piece of information that is received (step 608). In general, each field of information provided in connection with a form is associated with a category of information 404. As an example, fields associated with the first user's home address may be defined as belonging to the biographical information 408 category and stored as first user biographical information 420a. As a further example, a field containing the user's weight may be associated with the health information 412 category and stored as first user health information 424a. As a further example, a field for the user's salary may be associated with the financial information 416 category and stored as first user financial information 428a. Because information provided by a user may be categorized according to the field in connection with which that information is provided, the separate pieces of information may be stored in the appropriate category 404 of the database 328 without requiring the server 104 to characterize the data itself.

At step 612, a determination is made as to whether a request for information has been received from a third party 120. If such a request has been received, a determination is made as to whether the third party request has been authorized by the user 114 (step 616). In general, information is not provided to any third party 120 (or to any other user 114) unless prior authorization from the user 114 for a release of the user's information has been received. The authorization status of third parties 120 in connection with particular users 114 may be stored as part of the administration information 448 maintained on the database 328. If at step 616 it is determined that the third party requesting the information is authorized, the requested information is provided to the third party 120 (step 620). The authorization granted to a third party 120 by a user 114 may be limited to a discrete piece of information, or to information related to a particular subject matter. For example, a user who has requested that a third party lender extend a loan to the user may authorize access to all user information belonging to the financial information category 416 and to certain portions of the user's biographical information 408, for example by authorizing that a financial summary report 508 be generated in response to a request made by the third party 120. Regardless of whether all or a portion of the information related to a user 114 is provided to a third party, it is the user 114 that determines the extent of the access granted to the third party 120. If the third party 120 has not been authorized to receive the information, that party is denied access (step 624).

If a request for information from a third party 120 has not been received, a determination is made as to whether a request for information from a user 114 has been received (step 628). In particular, a determination is made as to whether a user 114 has requested their own information. As can be appreciated, a request for information made by a user 114 may be in the form of a direction to provide a report 508. If such a request has been received, a report 632 containing the requested information may be generated and provided to the user 114 (step 636). At step 640, a determination is made as to whether a request to provide the generated report 508 to a third party 120 has been received. That is, a determination is made as to whether the user 114 has directed that the generated report 508 be provided to any third party 120. If such a request has been received, the report 508 is delivered to the third party 120 (step 644). In accordance with an embodiment of the present invention, the report 508 is delivered to the third party 120 across the communication network 108 if an instruction to provide a report 508 to a third party has been received. In accordance with another embodiment, the report 508 may be printed and delivered in hard copy form to the user 114 and/or the third party 120.

At step 648, a determination is made as to whether a request for access to a resource 432 has been received. If a request for access to a resource 432 has been received, the user 114 may be interconnected to the requested resource 432 (step 652). For instance, a user 114 may be interconnected to a resource 432 comprising a database or a portion of the database 328 containing selected information. In addition, the use of a resource 432 may result in the generation of a report 508. For example, in connection with a request for a mortgage qualification amount, information regarding the user's assets and liabilities may be fed into a financial resource 432c comprising a mortgage qualifier calculator, and a report 508 consisting of the inputs and the calculated maximum mortgage amount for which the user 114 qualifies may be returned.

With reference now to FIG. 6B, additional aspects of the operation of a virtual file cabinet system 100 in accordance with an embodiment of the present invention are shown. In particular, FIG. 6B illustrates an additional method by which information can be provided for storage in the virtual file cabinet system 100. Initially, at step 656, a third party 120 receives an authorization code from a user 114. At step 660, the third party 120 enters information regarding the user 114 into a computer or electronic file system maintained by the third party 120. For example, the third party 120 may enter the information into a terminal 116. Next, the third party 120 logs onto the virtual file cabinet system 100 using the authorization code provided by the user (step 664). In connection with logging into the virtual file cabinet system 100, the third party 120 may be required to provide information in addition to the authorization number, such as additional information identifying the user 114 to which the information that will be provided by the third party 120 pertains. At step 668, after successfully logging into the virtual file cabinet system 100, the third party 120 uploads the information that it has collected regarding the user to the virtual file cabinet system 100 for storage in the database 538. Of course, various of the steps described above in connection with FIG. 6B may be performed at different times. For example, a third party 120 may log into the virtual file cabinet system 100 prior to entering information in their system. As a further example, a third party 120 may enter information regarding a user 114 into a terminal 116, and then log into the virtual file cabinet system 100 using an authorization code obtained from the user 114. Examples of third parties 120 that generate information regarding a user 114 that may be conveniently stored electronically include health services providers, financial institutions, and educational institutions.

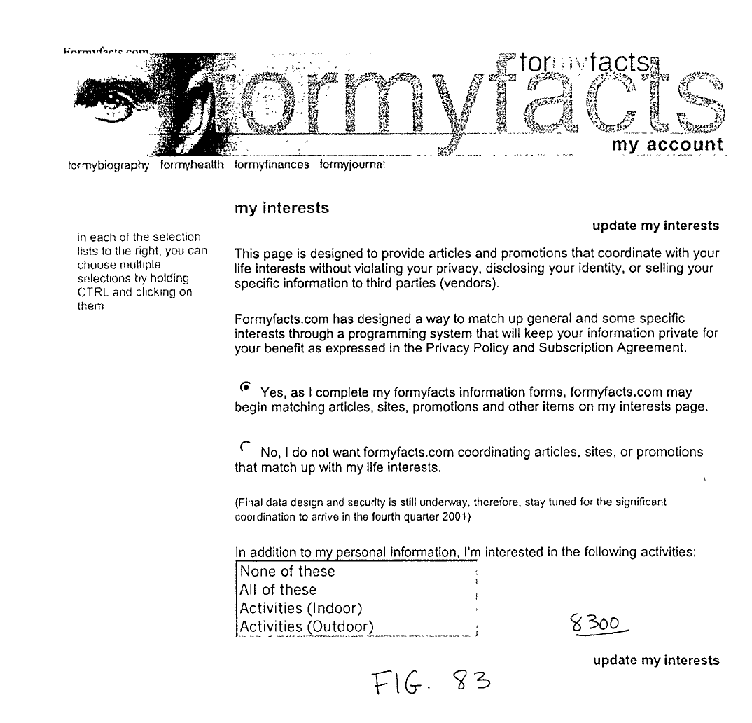

An example of the steps taken and information provided and received in connection with the operation of a virtual file cabinet system 100 in accordance with an embodiment of the present invention will now be given in connection with FIGS. 7-83.

With reference now to FIG. 7, a screen shot of a virtual file cabinet log in page 700 in accordance with an embodiment of the present invention is shown. The log in page 700 may be accessed by a user 114 by directing a communication software application 228 (e.g., a web browser) running on a client terminal 112 to the Internet address of the server 104 of the virtual file cabinet system 100. In general, the log in page 700 may include a user name field 704 and a user password field 708, to allow a user 114 to authenticate their identity so they can access their information. In particular, and after submission of a registered user name 704 and password 708 by clicking on the submit button 712, access to all of that user's information may be gained.

FIG. 8 illustrates a virtual file cabinet category 404 selection page 800 in accordance with an embodiment of the present invention. In general, the user 114 may select a category of information 404 from which information may be accessed or added. In particular, by clicking on a first selection area 804, the user may choose to access or provide information generally related to that user's biographical information 408. By clicking on a second selection area 808, the user may choose to access or provide health information 412. By clicking on a third selection area 812, the user may choose to access or provide financial information 416. As can be appreciated, categories of information 404 in addition to those illustrated in FIG. 4 may be maintained in connection with the database 328. For example, as shown on the virtual file cabinet category selection page 800, a journal information category may be accessed by selecting a fourth selection area 816.

In response to clicking within the first selection area 804, the user 114 is presented with a biography home page 900 (see FIG. 9). The biography information home page 900 allows the user 114 to work with different biographical information and to perform different activities with respect to biographical information. For example, the user 114 may select from biographical goals 904, biographical forms 908, biographical resources 912, and biographical reports 916.

Within the goals 904, the user may work with family goals 920, knowledge goals 924, or career goals 928. Furthermore, under each of the goals 920-928, selections of “add a goal” 932, “edit goals” 936, and “view all goals” 940 may be made. Selections of particular forms, resources and reports may be made from among the forms 908, resources 912 and reports 916. In particular, each of the options to add a goal 92, edit goals 936 and view all goals 940, and each of the individual forms 908, resources 912, and reports 916 included in the biography homepage 900 act as links to other pages. Accordingly, by directing a pointing device to a desired link, a user 114 may be able to access a different page.

For example, by clicking on the link “add a goal” 932a under the my family goals 920 subcategory, the user 114 is presented with a child window presenting an add a goal page 1000 (see FIG. 10). The add a goal page 1000 allows the user 114 to set a date for the goal 1004, enter a title for the goal 1008, select a category of goal 920-928 using a drop-down window 1012, and enter text in a description box 116. In the example add a goal page 1000 illustrated in FIG. 10, the window 1012 for categorizing the goal shows the goal category from which the add a goal selection was made. For example, FIG. 11 illustrates an add a goal window 1100 that is presented to a user 114 in response to selecting the add a goal link 932b under the my knowledge goals 924 subcategory.

However, if desired, the user 114 may select a different category 920-928. In accordance with a further embodiment of the present invention, the user 114 may enter text in the window 1012 to create a new category of goals. Goals entered by the user 114 appear in the biography homepage 900 under the category 920-928 assigned to the goal by the user 114.

FIG. 12 is a screen shot of a view all goals page 1200, presented to a user in response to the selection of the edit goals link 936 included in the biography home page 900. In accordance with an embodiment of the present invention, FIG. 12 also illustrates an edit goals page 1200 presented to a user 114 in response to the selection of a view all goals link 940 from the biography home page 900. That is, in accordance with an embodiment of the present invention, both the selection of the edit goals 936 and view all goals 940 links presents the user's goals in the same format. As shown in FIG. 12, check boxes 1204 may be provided to allow a user 114 to select goals to remove, for example upon completion or abandonment of the goal. The indicated goals are moved when an update my goals 1208 link is selected. The view all goals or edit goals page 1200 may also be accessed by selecting a view all goals or update my goals link (links 1020) presented by the add a goal page 1000 or 1100.

The goal titles 1212 for each goal included in the edit goals or view all goals page 1200 act as links to an edit goal page 1300 (see FIG. 13). For example, the edit goals page 1300 shown in FIG. 13 is presented to a user 114 in response to the selection of the first goal 1216 listed under the my family goals 920 subcategory of the edit goals or view all goals page 1200. As can be appreciated, the edit goals page 1300 is identical in format to the add a goal pages illustrated in FIGS. 10 and 11. However, because the page shown in FIG. 13 was accessed in connection with editing a particular goal, the date, goal title, goal category, and description boxes 1004-1016 have the information related to the goal being edited already loaded therein. The user 114 may then make changes to any or all of the information contained in the windows 1004-1016. The edits made by the user 114 are stored upon selection of the update my goals link 1208. Upon selecting the update my goals link 1208, the user 114 is returned to the edit goals or view all goals page 1200. The view all goals and edit goals page 1200 may be exited by selecting the update my goals link 1208 presented on that page, or by cancelling the child window in which the page 1200 appears on the user's client terminal 112.

FIGS. 14A-14B illustrate a general information form 1400 presented to a user 114 in response to the selection of the link to the general information form 944 under the biographical forms 908 heading shown on the biography home page 900. As shown in FIGS. 14A and 14B, the general information page 1400 includes subcategories of information related to the subscriber (i.e. the user 114), the user's family, and address. Information may be updated by directly entering the new or updated information in the provided data entry fields 1404. The changes made by the user 114 may be saved to the virtual file cabinet by selecting the “update my information” link 1408.

With reference now to FIG. 15, a contacts form 1500, which is presented to a user 114 in response to the selection of the contacts link 948 under the my information 908 heading on the biography homepage 900, is shown. Accordingly, it can be appreciated that the virtual file cabinet may be utilized as a centrally accessible address book. Furthermore, the contacts may be divided into subcategories 1504 to assist the user 114 in organizing and later locating contacts. The individual contacts may be edited by clicking on the contact name, which results in a subwindow presenting fields in which items of information related to the contact may be edited, added or deleted.

FIGS. 16A and 16B illustrate a career form 1600 presented to a user 114 in response to the selection of the professional link 952 included under the my information 908 heading on the biography home page 900. The career form 1600 provides data entry fields 1604 for the user 114 to enter information regarding their current profession. Drop down windows, such as for the window 1608 in which the user's profession appears may provide suggested descriptions. Fields 1604 may be provided to allow the user 114 to enter information regarding the name of the company and the user's work address. In addition, fields 1604 may be provided to allow the user 114 to enter text describing their duties and responsibilities, and other information related to their profession in text windows 1612. Textual commentary 1616 may be interspersed with the various fields 1604, to assist the user 114 in providing appropriate information. This commentary 1616 is in particular directed to assisting the user 114 in developing text that is appropriate for inclusion in a resume. Selection boxes 1620 may be provided to allow the user 114 to select whether information regarding the user 114, and in particular the user's professional information, can be released to prospective employers. Links to add a position 1624, to add an accomplishment 1628, or to update information 1632 entered in the windows 1604 may also be provided to facilitate the maintenance of career information using the career form 1600.

With reference now to FIG. 17, an education information form 1700 such as may be presented to a user 114 in response to the selection of the education link 956 on the biography home page 900 is shown. General information regarding the user's 114 education may be entered in data entry fields 1704. In addition, transcript information 1708 may be included. In accordance with an embodiment of the present invention, the transcript information 1708 may be edited by the user 114. In accordance with another embodiment of the present invention, the transcript information 1708 may not be edited by a user 114. Instead the transcript information 1708 may only be provided by the relevant educational institutions by uploading that information to the virtual file cabinet maintained in connection with the user 114. In this way, transcript information 1708 may be presented to, for example, prospective employers or to other educational institutions, with assurance that the information presented is accurate.

FIG. 18 illustrates a civic involvement form 1800 presented to the user 114 in response to the selection of a civic involvement link 960 included on the biography home page 900. Data entry fields 1804 may be provided to allow the user to enter relevant information regarding the user's participation in civic activities.

FIG. 19 illustrates a hobby/sports page 1900 in accordance with an embodiment of the present invention. The hobby/sports page 1900 is presented to a user 114 in response to a selection of the hobby/sports link 964 included in the biography home page 900. An entry concerning a hobby may be edited by selecting one of the displayed hobbies 1904. In addition, a new hobby or sport may be added by selecting the add new hobby link 1908.

FIG. 20 illustrates a driving record request form 2000 that is presented to a user 114 in response to the selection of a driving record request link 968 included under the resources 912 available from the biography home page 900. In accordance with an embodiment of the present invention, the driving record request 2000 may be automatically populated with information regarding the user 114 using information maintained in the virtual file cabinet with respect to the user 114. The user 114 may then add any additional information, such as the motor vehicle division to which the driving record request will be submitted, and print out the request from the client terminal 112. Accordingly, the driving record request page 2000 is an example of a resource 432 that can be used to generate a report 508.

In FIG. 21, a file uploader resource 2100, which may be accessed by selecting the file uploader link 972 on the biography home page 900, is illustrated. In general, the file uploader resource 2100 allows a user 114 to upload files to the virtual file cabinet. For example, photographs or images of documents may be uploaded. In addition, documents such as educational transcripts and medical charts may be uploaded. In accordance with another embodiment of the present invention, documents and other information may be uploaded in formats allowing the virtual file cabinet to access the information contained in the files directly. For example, educational transcript information received in a format that can be accessed by the virtual file cabinet received from an educational institution authorized to do so by the user 114 can be used to update the user's educational information. As a further example, records generated by a physician in connection with services provided by the physician to the user 114 may be provided to the virtual file cabinet and used to update the user's health information. An example of a format that may be used in connection with a medical services provider is the ICD 9 and 10 codes commonly used by physicians and other medical service providers. Furthermore, it should be appreciated that the file uploader 2100 may be provided to an educational institution or medical service provider to allow such information to be uploaded without direct intervention by the user 114. For example, a user 114 may provide, for example, an authorization code to permit updating of the user's records by the third party 120 using the file uploader 2100. Accordingly, the uploader page 2100 may include windows to allow a third party 120 to identify the user 114 whose records are being provided. A browse button 2104 may be provided to allow a user 114 to identify a file for uploading. Alternatively, the path and file name of the desired file may be entered directly in a text box 2108.

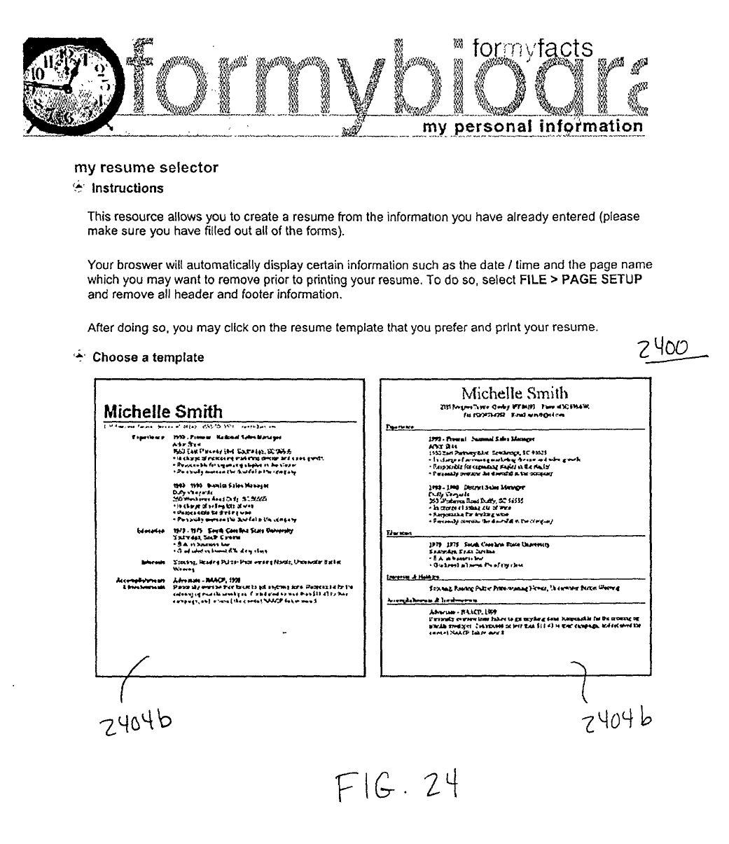

With reference now to FIGS. 22a and 22b, an example biography report 2200 is shown. The biography report 2200 may be generated in response to the selection of the my biography link 976 available from the biography home page 900. In general, the biography report 2200 draws from biographical information 408 maintained in the database 328 in connection with the requesting user 114. In particular, by selecting the my biography link 976, the report engine 444 populates a report template 440 with information from the biographical information category 408 to generate the completed report 508. The completed report 2200 may be printed by selecting a print this report link 2204. Alternatively or in addition, the user 114 may choose to download an electronic version of the report to the user's client terminal 112, or to provide the report 2200 to a terminal 116 associated with a third party 120.

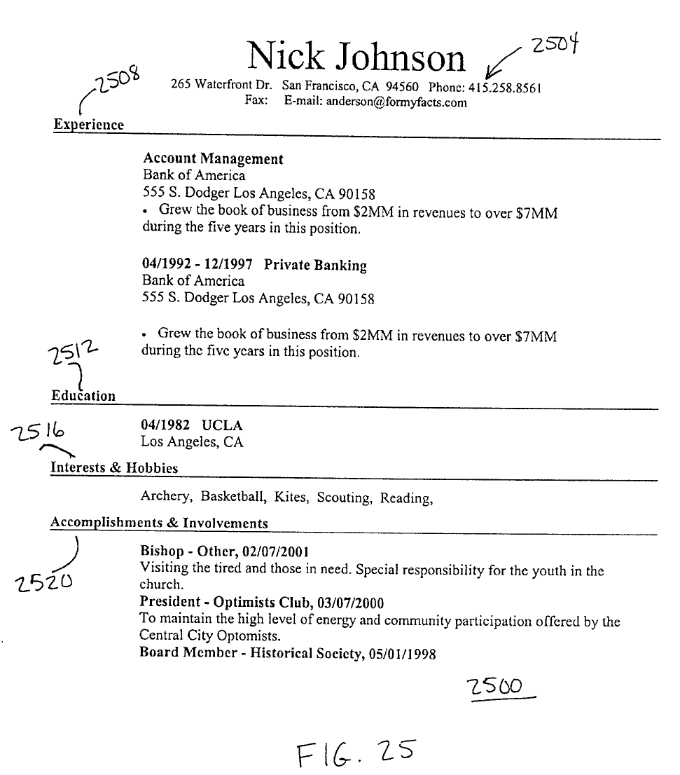

FIG. 23 illustrates a contacts report 2300 generated in response to the selection of the my contacts link 980 provided as part of the biography home page 900. In general, the contacts report 2300 draws from biographical information 408 maintained in connection with the user 114. In particular, the contacts report 2300 draws from information entered in connection with the contacts form 1500 entered by the user 114.

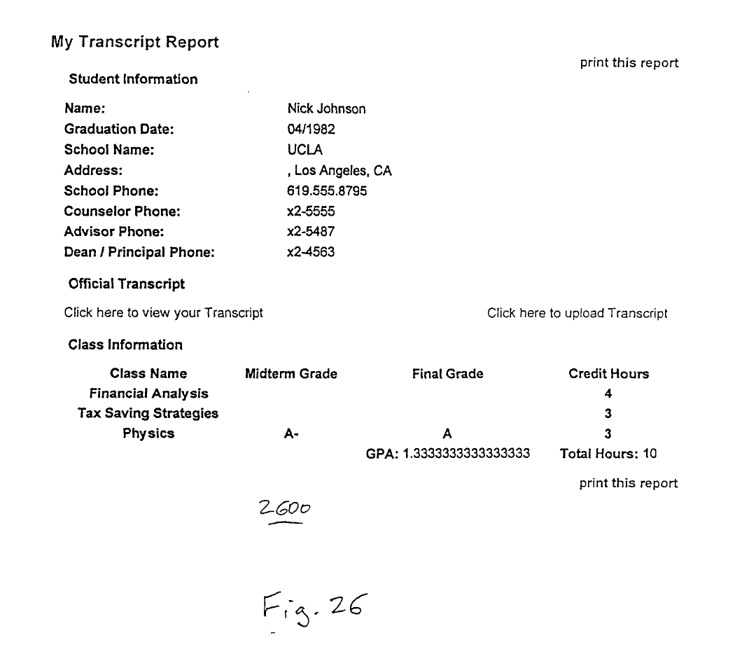

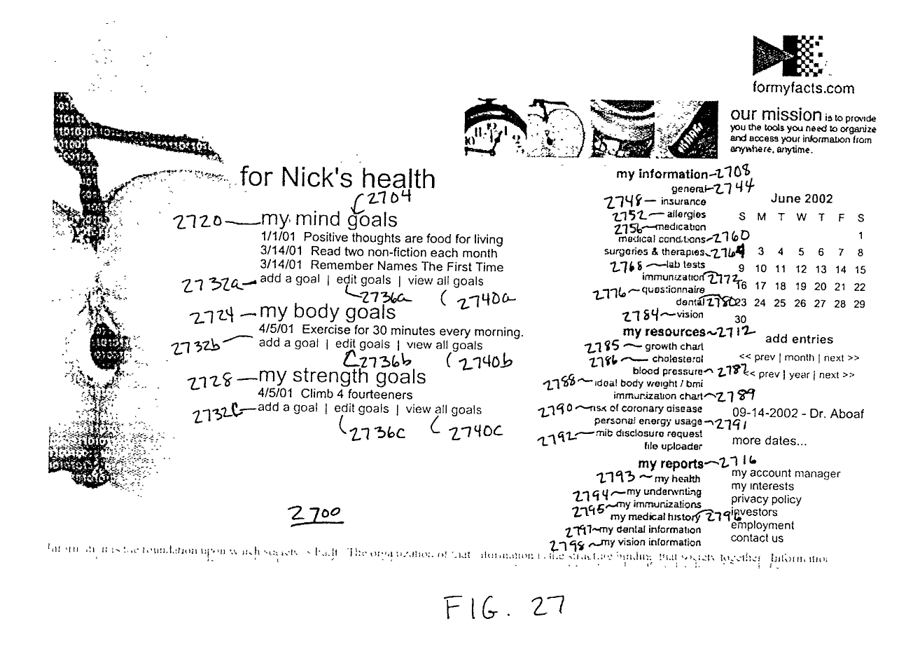

A resume selector page 2400 (FIG. 24) is presented in response to the selection of the my resume 984 link provided on the biography home page 900. The resume selector page 2400 allows the user 114 to select from a number of resume templates 2404. In response to clicking on the desired template 2404, the user 114 is presented with a resume 2500 (see FIG. 25) in the format of the selected template 2404, and populated with the user's biographical information 408. For example, name and address information 2504 may be obtained from biographical information 408 collected in connection with the general information form 944, the information regarding experience 2508 may be obtained from information collected in connection with the my career form 1600, the education information 2512 may be obtained from information collected in connection with the education form 1700, the interest and hobbies information 2516 may be obtained from information provided in connection with the hobbies/sports form 1900, and the accomplishments and involvements information 2520 may be obtained from information provided in connection with various forms, including the career form 1600 and the civic involvement form 1800. Accordingly, it can be appreciated that the report engine 444 may draw on various sources of information in populating a report template 440 and generating a finished report 508. The user 114 may choose to print the resume 2500 or store it electronically. In addition, the user 114 may deliver their resume 2400 to a third party 120 electronically through the communication network 108. Additionally or alternatively, the user 114 may make a copy of the resume 2400 maintained in the database 328 implementing the virtual file cabinet accessible to authorized third parties 120.

In FIG. 26, a transcript report 2600 generated in response to the selection of the transcript link 988 provided as part of the biography home page 900 is illustrated. In general, the transcript report 2600 may include information collected directly from the user 114, for example in connection with the educational information form 1700 and information, such as transcript information, provided by an educational institution. As with the resume 2500, the user 114 may print or store the transcript report 2600, and may selectively deliver or make available the transcript report 2600 to authorized third parties 120.

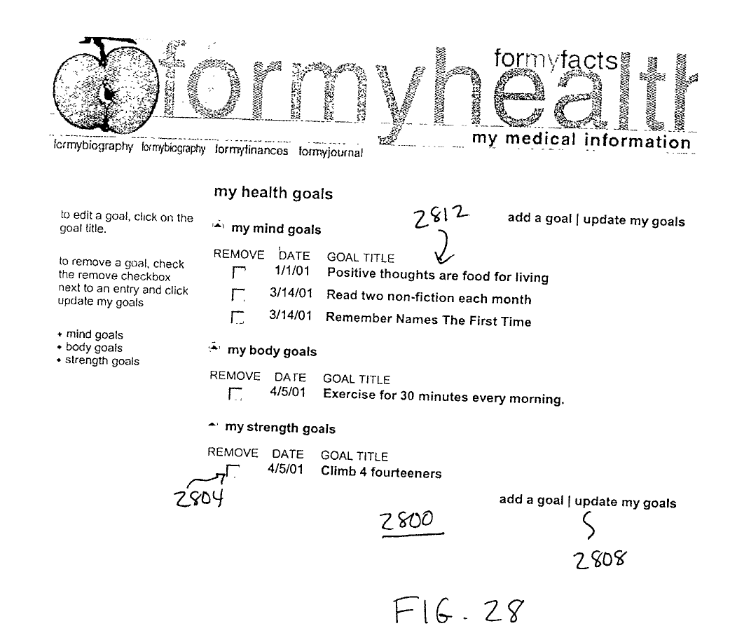

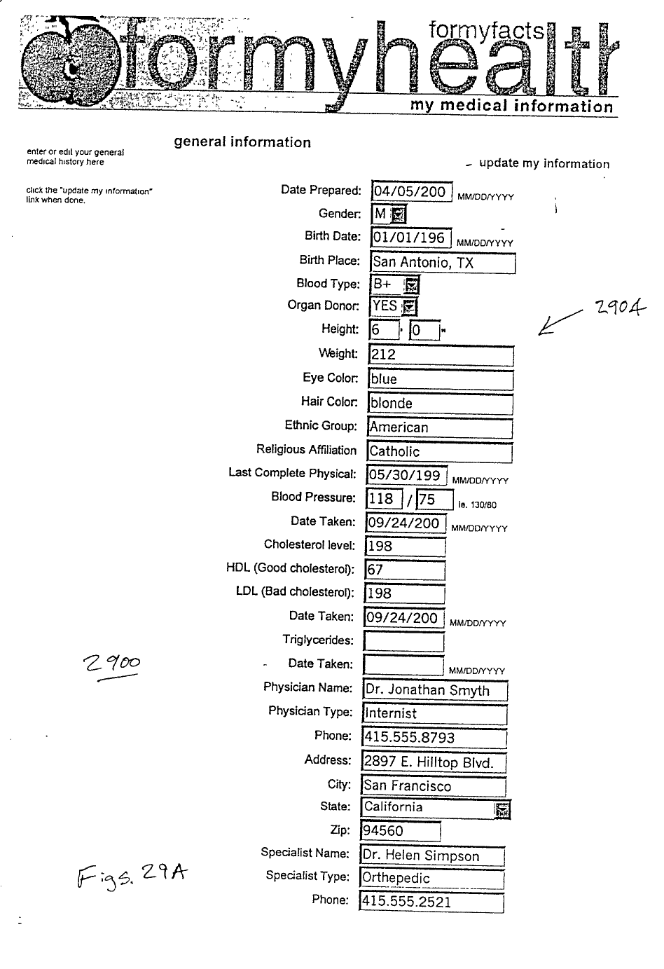

With reference now to FIG. 27, a health information home page 2700 in accordance with an embodiment of the present invention is illustrated. The health information home page 2700 may be accessed by clicking in the health information selection area 808 provided as part of the category selection page 800. The health home page 2700 may present health goals within a number of categories 2704. In addition, the user 114 may select from the various forms 2708, resources 2712, and reports 2716.

Within the health goals 2704, individual goals may be divided into mind goals 2720, body goals 2724, and strength goals 2728. By selecting an add a goal link 2732, the user 114 is presented with a child window that is similar to the window used to add a biographical goal (e.g., window 1000 in FIG. 10). In general, the category of goals 2720-2728 under which the add a goal link 2732 is selected determines the goal that appears in a goal category window. Similarly, by selecting an edit goals link 2736, the user 114 can choose to edit health goals that have already been entered. The view all goals link 2740 may be used to view all of the goals entered by the user 114 in connection with the health category.

With reference now to FIG. 28, a health goals edit or view all health goals page 2800 is shown. In general, the health goals page 2800 is presented to the user 114 in response to a selection of either an edit goals 2736 or view all goals 2740 link. The health goals page 2800 allows the user 114 to remove a goal by checking a provided box 2804, and by choosing to update the goals 2808. By selecting a goal title 2812, individual goals may be edited.

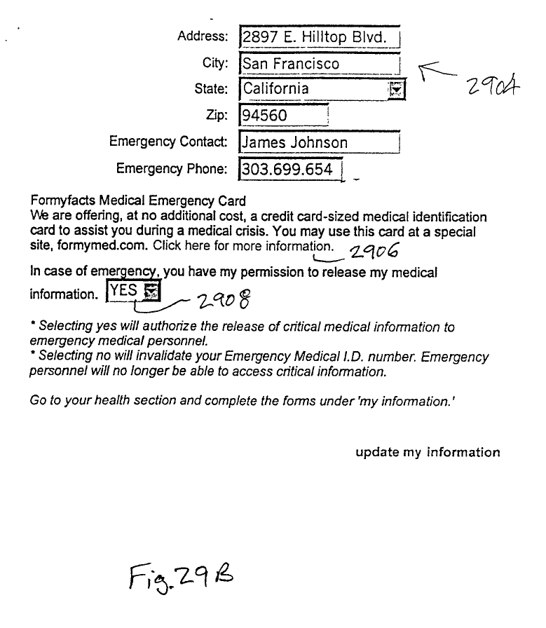

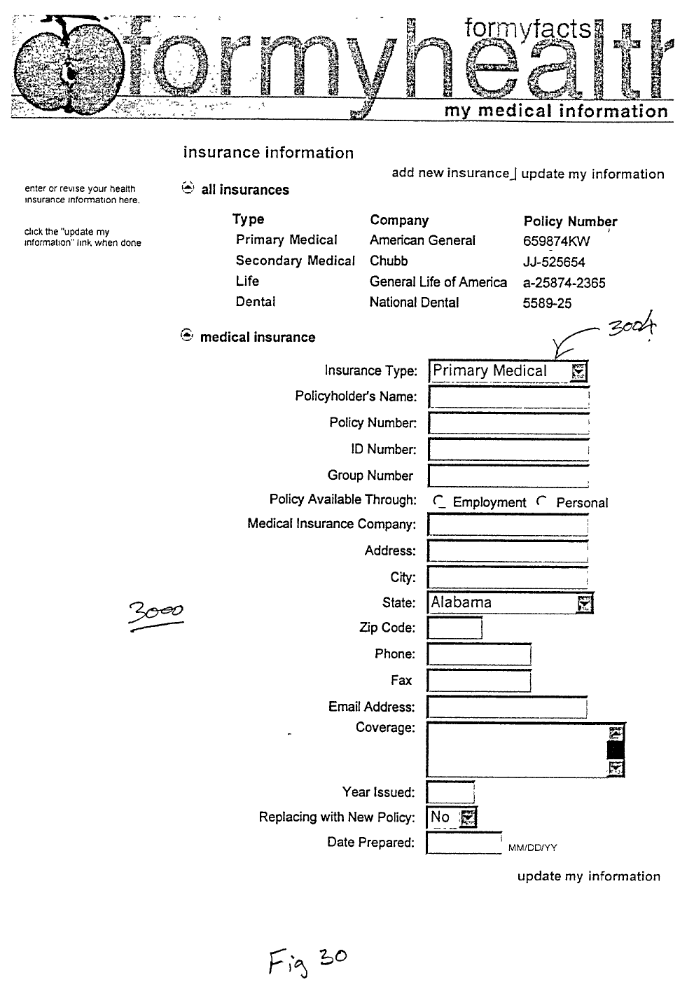

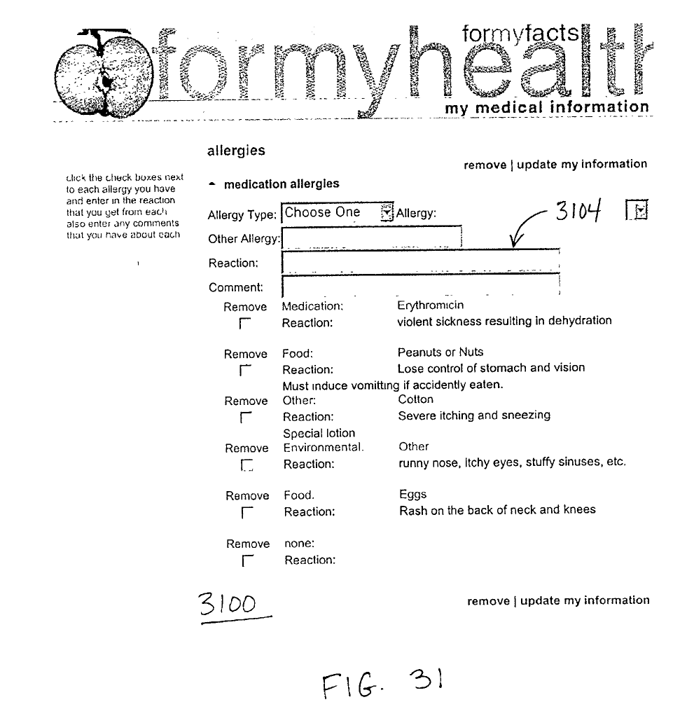

A general health information form 2900 accessed by selecting the general form link 2744 provided as part of the health home page 2700 is illustrated in FIGS. 29A-29B. The general health information form 2900 provides text boxes or data entry fields 2904 in which information regarding a variety of health issues or parameters can be entered. In addition, information regarding additional services available in connection with the virtual file cabinet may be provided. For example, information regarding a medical emergency card may be accessed by selecting a provided link 2906. The user 114 may also choose whether to permit release of medical information maintained in the virtual file cabinet in case of emergency by making an appropriate selection from a pull down menu box 2908. In accordance with an embodiment of the present invention, authorization by a user to permit access to medical information by emergency service providers allows such providers to gain access to such information by entering an authorization code appearing on or encoded in a card carried by a user 114.

FIG. 30 illustrates an insurance information form 3000 that may be accessed by selecting the insurance link 2748 provided as part of the health home page 2700. The insurance form 3000 may prompt the user 114 to enter information regarding various types of insurance held by the user 114 into data entry fields 3004.

FIG. 31 illustrates an allergy form 3100 that may be accessed by selecting the allergies link 2752 provided on the health home page 2700. The allergies form 3100 may prompt the user 114 to enter information regarding any known allergies into data entry fields 3104.

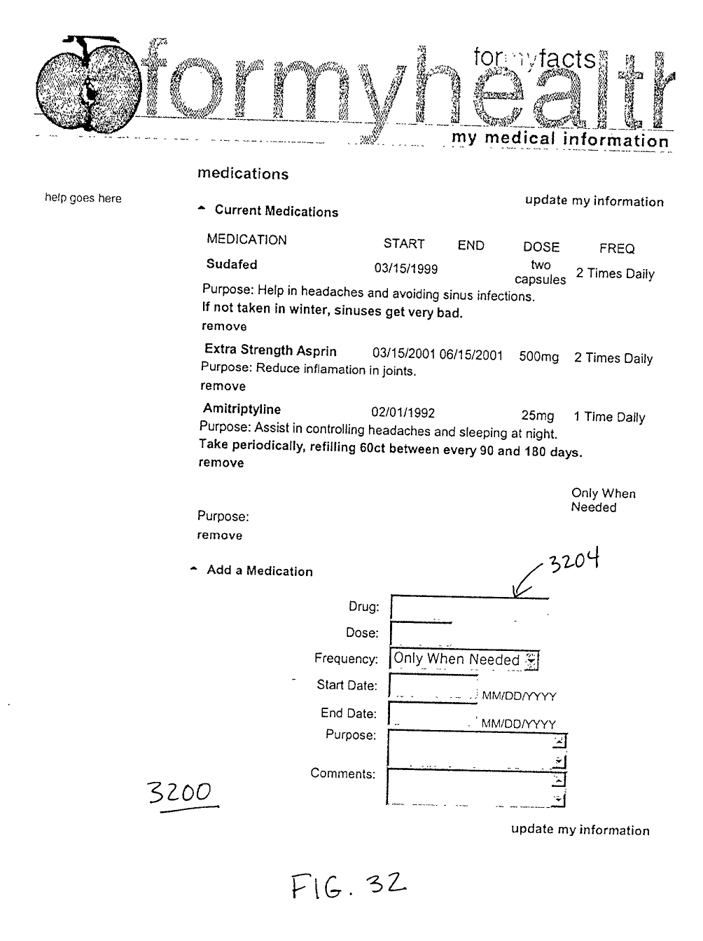

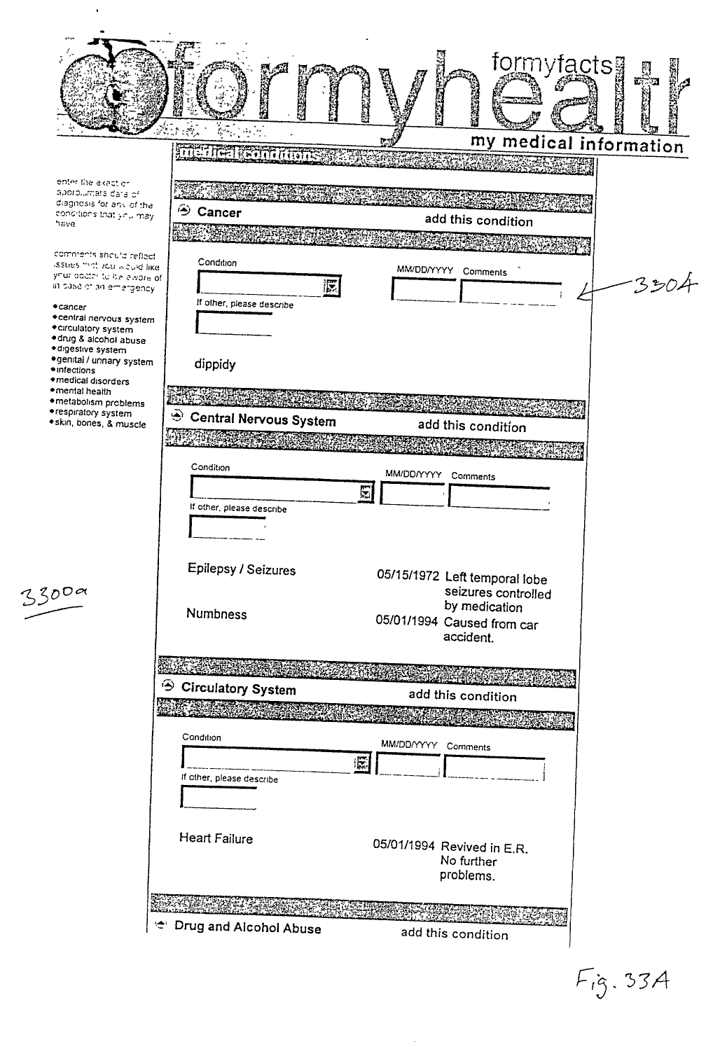

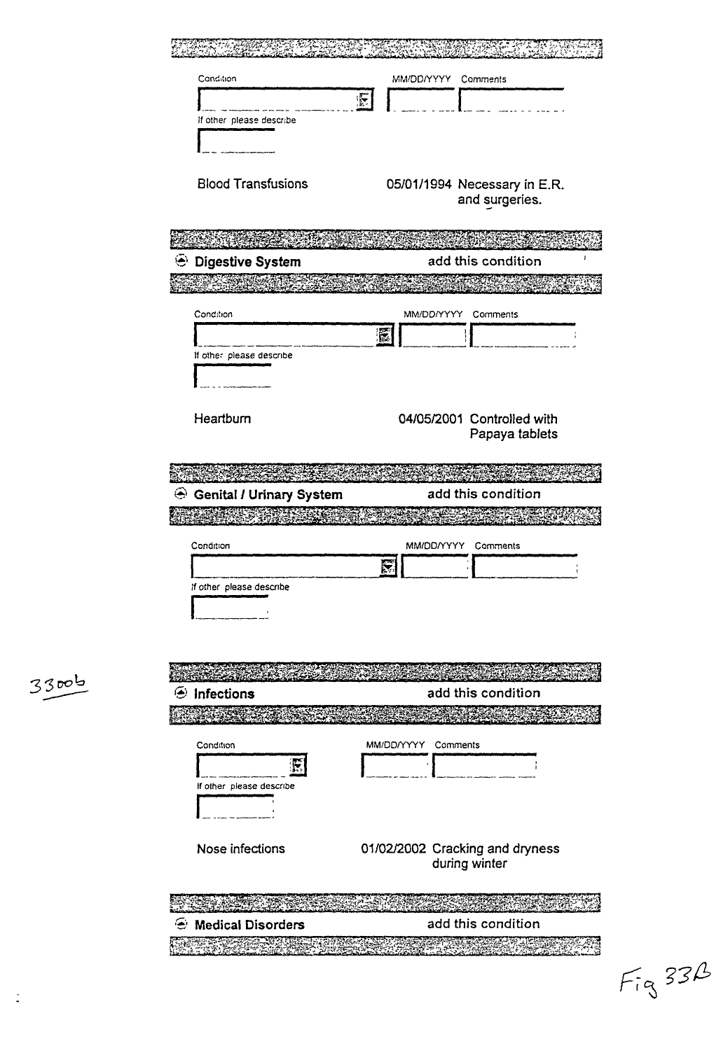

A medications form 3200 is shown in FIG. 32. The medications form 3200 is accessed by selecting the medication link 2756 from the health home page 2700. The medications form 3200 lists medications previously entered in connection with the user 114, and allows existing medication information to be removed. In addition, new medication information can be added using the medication form 3200 by entering information in data entry fields 3204. Information collected in connection with the medication form 3200 is stored as part of the health information 412 maintained in the virtual file cabinet in connection with the user 114.

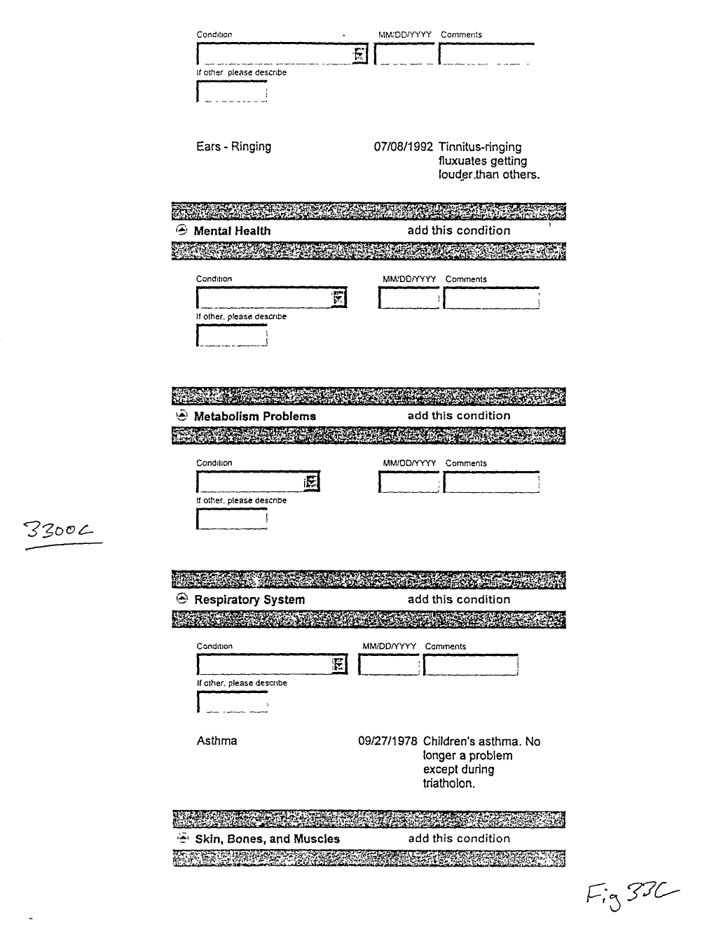

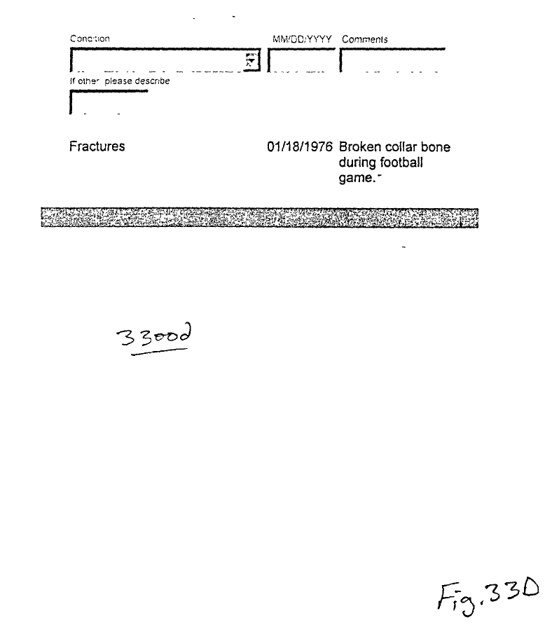

FIGS. 33A-33D illustrate a medical conditions form 3300 that may be accessed by selecting the medical conditions link 2760 of the health home page 2700. The medical conditions form 2700 may prompt the user 114 to enter information regarding various conditions that the user 114 may have into data entry fields 3304. Information provided by the user 114 is stored in the health information 412 for that user 114.

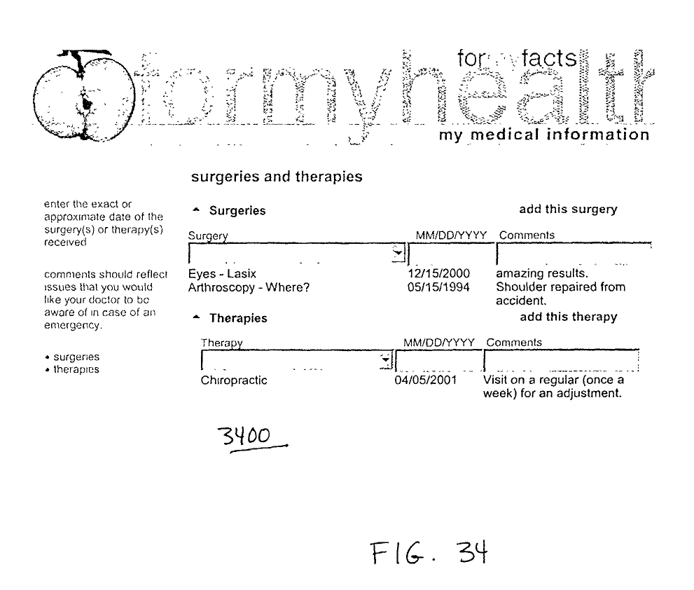

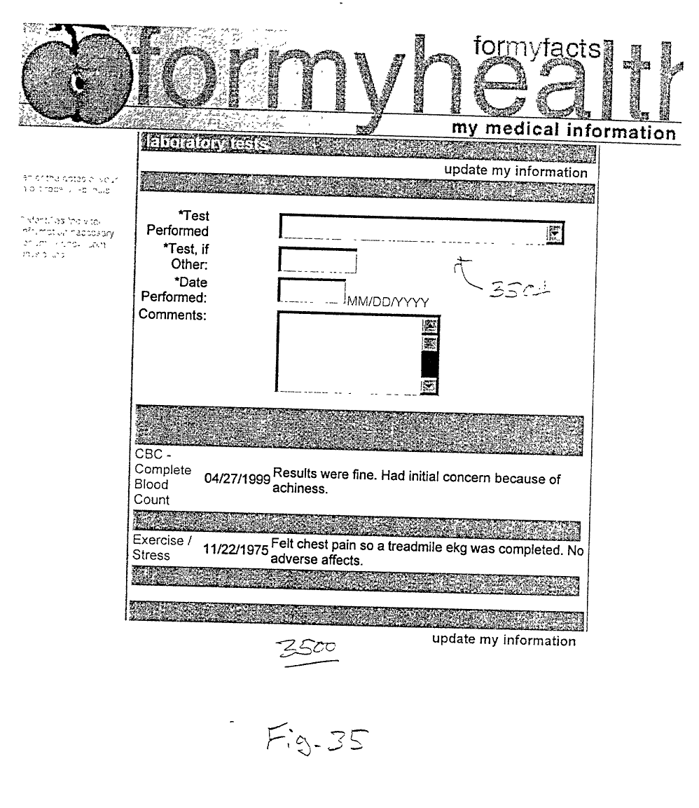

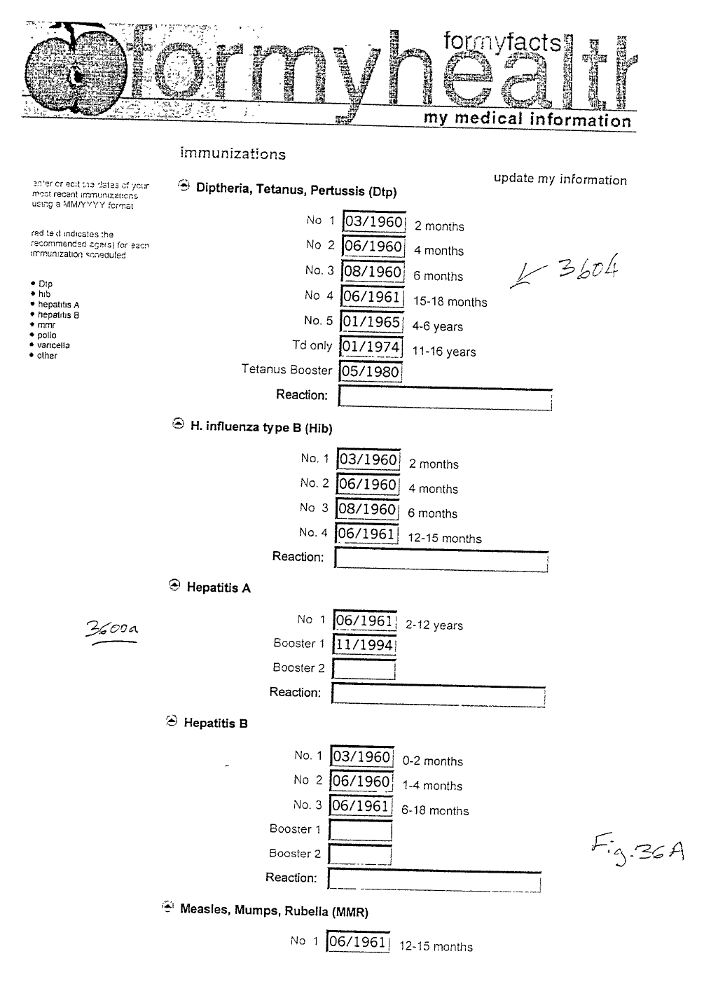

A surgeries and therapies form 3400 is illustrated in FIG. 34. The surgeries and therapies form 3400 may be accessed by selecting the surgeries and therapies link 2764 provided on the health home page 2700. The surgeries and therapies page 3400 may provide the user 114 with data entry fields 3404 into which information regarding surgeries or therapies that the user 114 has had may be entered. This information is stored in the health information 412 maintained in connection with the user 114.

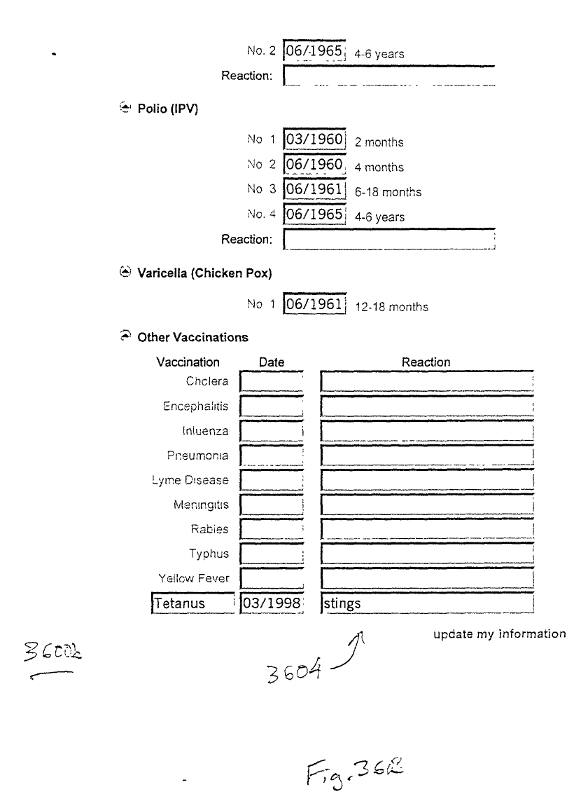

By selecting a lab test link 2768, the user 114 may access a lab test form 3500 (see FIG. 35). The lab test form 3500 may provide the user 114 with data entry fields 3504 in which information regarding laboratory tests that have been performed may be entered. Information collected in connection with the laboratory test form 3500 is stored as part of the health information 412 maintained in the virtual file cabinet for the user 114.

In FIGS. 36A and 36B, an immunization from 3600 in accordance with an embodiment of the present invention is illustrated. The immunization form 3600 may provide data entry fields 3604 with surrounding text that prompts a user 114 to enter information regarding that user's immunization history. Information provided in connection with the immunization form 3600 is stored in the health information 412. The immunization form 3600 may be accessed by selecting the immunization link 2772 or the health home page 2700.

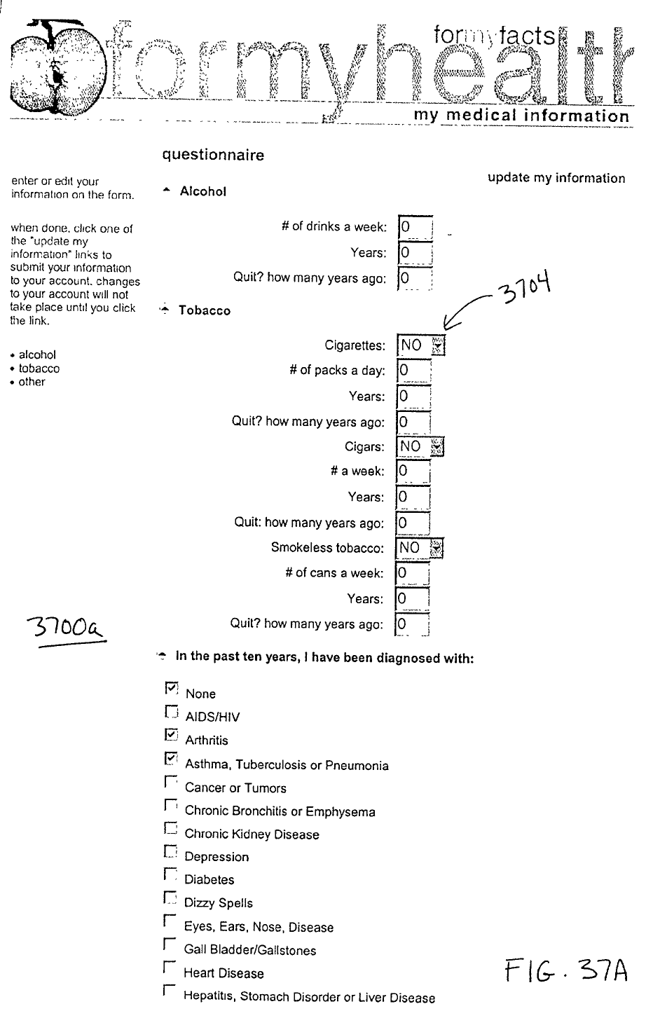

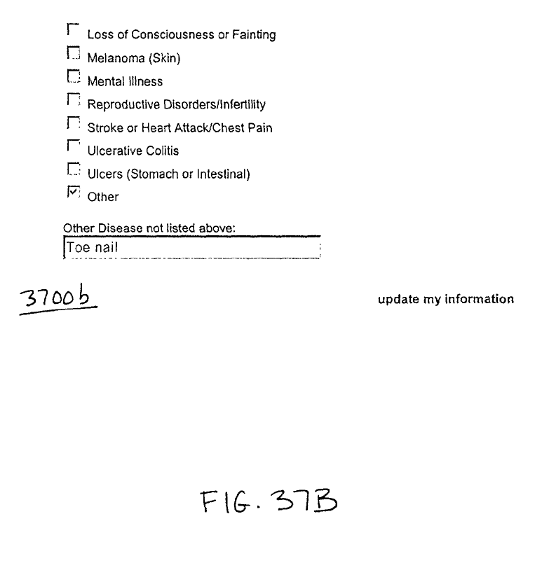

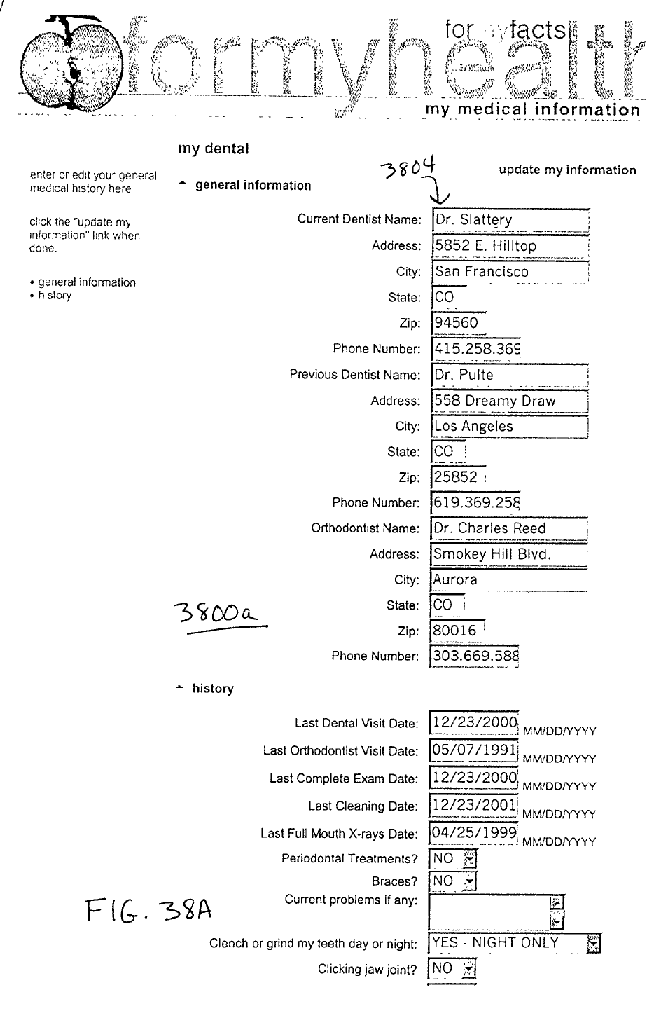

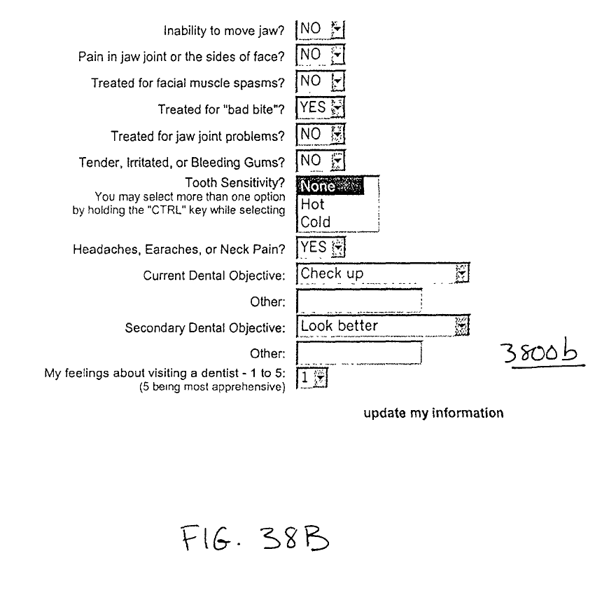

FIGS. 37A-37B illustrate a health questionnaire form 3700 in accordance with an embodiment of the present invention. The health questionnaire form 3700 may be accessed by selecting the questionnaire link 2776 provided as part of the health home page 2700. The health questionnaire form 3700 may provide data entry fields 3704 in which information related to the general health of the user 114 may be entered. Information collected in connection with the health questionnaire form 3700 is stored as health information 412 related to the user 114.

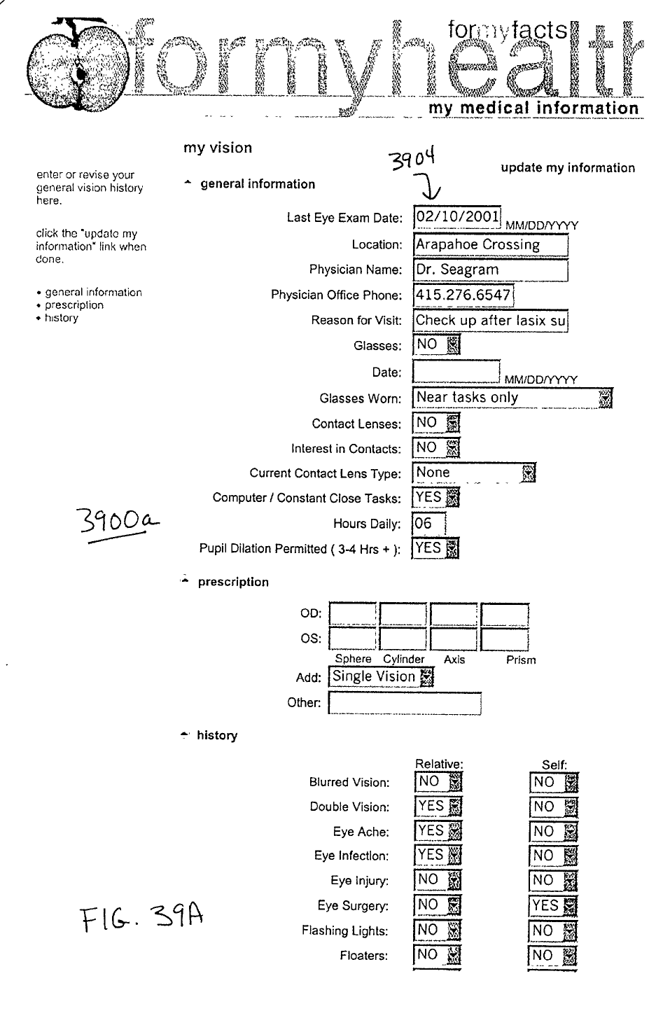

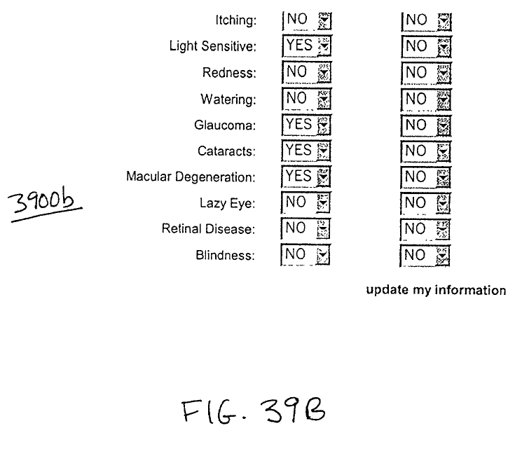

By selecting the dental link 2780, a user 114 may access the dental information form 3800 illustrated in FIGS. 38A and 38B. The dental information form 3800 may provide data entry fields 3804 in which various items of information regarding the dental health of the user 114 may be entered. Information collected in connection with the dental health form 3800 is stored as health information 412 in the virtual file cabinet.

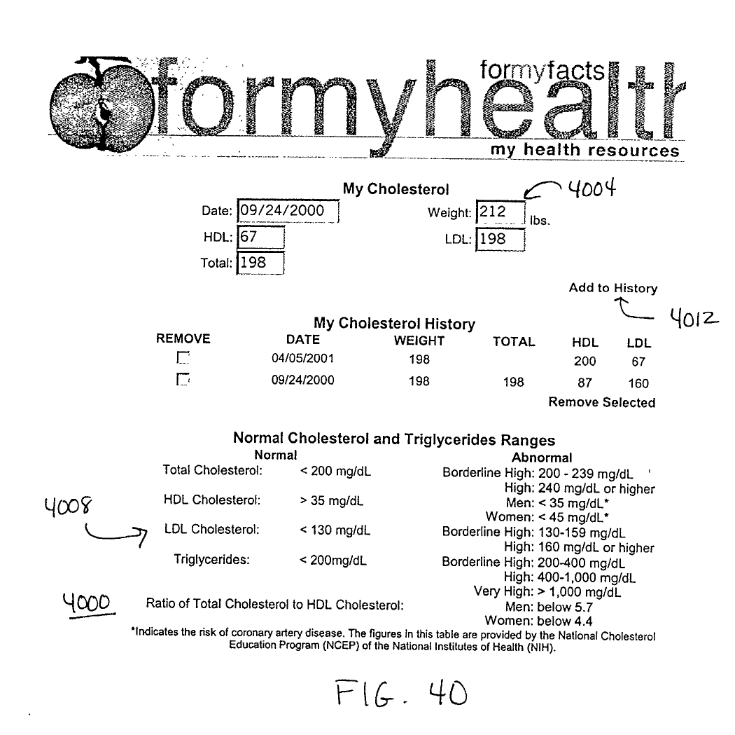

A vision information form 3900 is illustrated in connection with FIG. 39. The vision information form 3900 may be accessed by selecting the vision link 2784 provided on the health home page 2700. Data entry fields 3904 are provided in which the user 114 can add information. Data collected by the vision information form is stored as part of the user's health information 412.

A growth chart resource 4000 may be accessed by selecting the growth chart link 2785 provided on the health home page 2700. The growth chart 4000 may provide a static table according to a selected gender and age group.

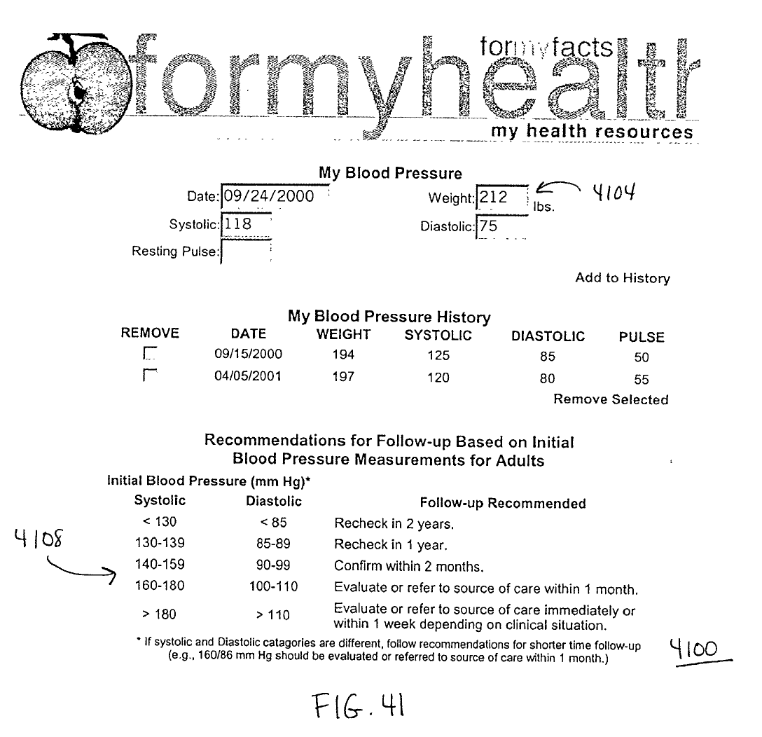

A cholesterol resource 4000 (FIG. 40) may be accessed by selecting a cholesterol link 2786 from the health home page 2700. The cholesterol resource 4000 may provide fields 4004 in which the user 114 may enter information related to their cholesterol. The entered information may be compared to normal ranges 4008 presented to the user 114 as part of the resource 4000. In addition, the cholesterol resource page 4000 allows the user 114 to add the cholesterol information that has been entered to the user's health history (i.e. to store the cholesterol information as part of the health information 412 maintained for that user 114) by selecting an add to history link 4012. Accordingly, the cholesterol resource page 4000 is an example of a resource that combines aspects of a form for collecting information and a resource for providing additional information to the user 114.

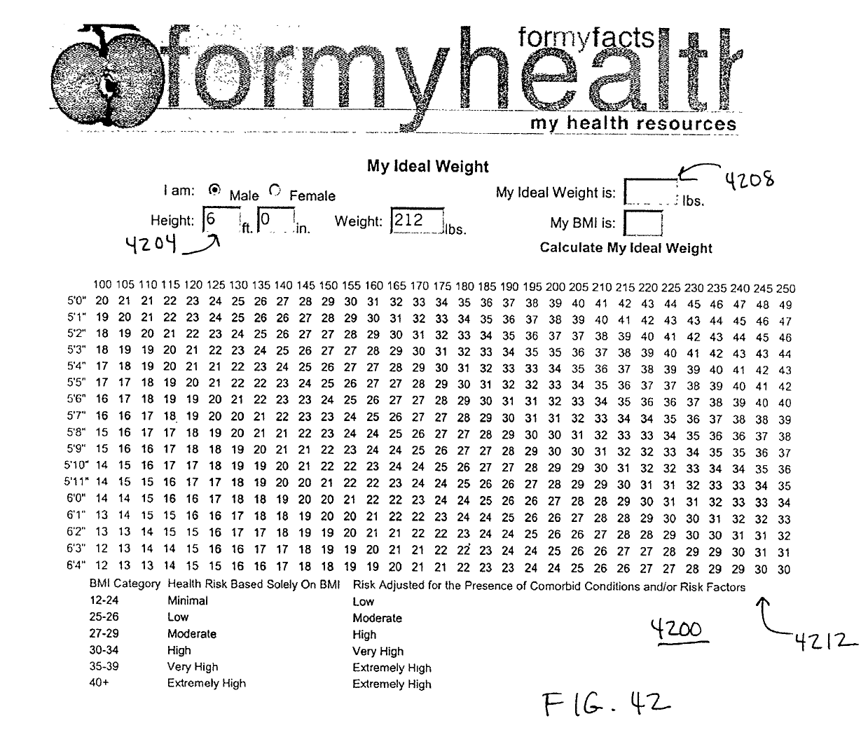

A blood pressure resource 4100 (FIG. 41) may be accessed by selecting a blood pressure link 2787 on the health home page 2700. The blood pressure resource 4100 may allow the user 114 to enter information in fields 4104. The resource may also present normal blood pressure information 4108. Like the example cholesterol resource 4000, the blood pressure resource 4100 is an example of a page that combines aspects of a form for collecting information and a resource for providing information to the user 114.

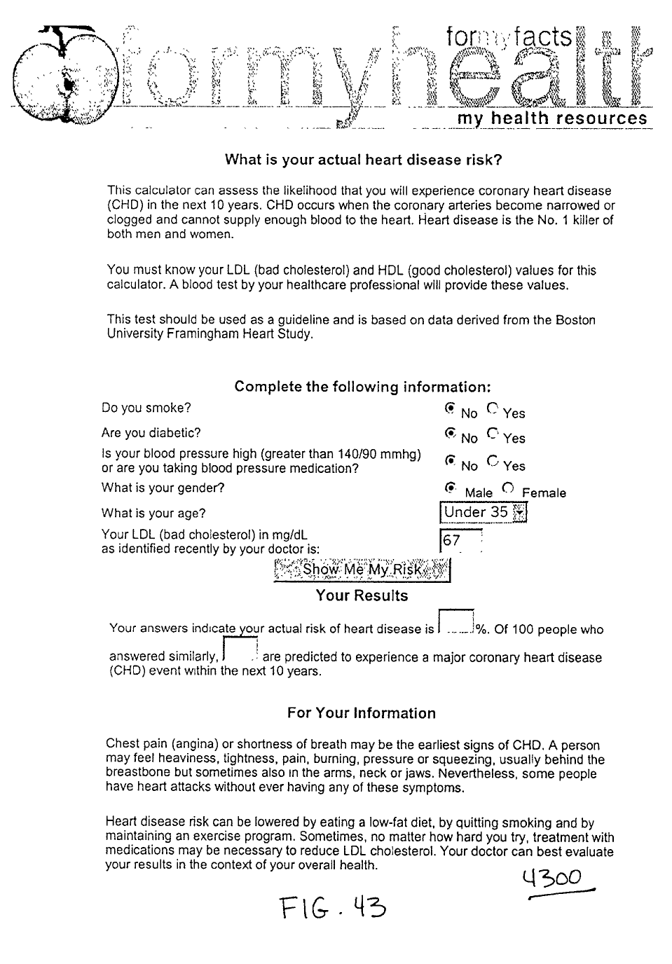

FIG. 42 illustrates an ideal weight resource 4200. The ideal weight resource 4200 may be accessed by selecting the ideal weight/BMI link 2788 provided on the health home page 2700. Fields 4204 may be provided to allow the user 114 to enter height and weight information. Calculated value fields 4208 may also be provided to display an ideal weight based on the height and gender of the user 114 and a calculated body mass index based on the height and weight of the user 114. The resource 4200 may additionally display a table 4212 of body mass indexes, and information characterizing body mass indexes.

By selecting an immunization chart link 2789, a user 114 may access information related to typical childhood immunization schedules. The immunization resource may be presented in the form of a static table.

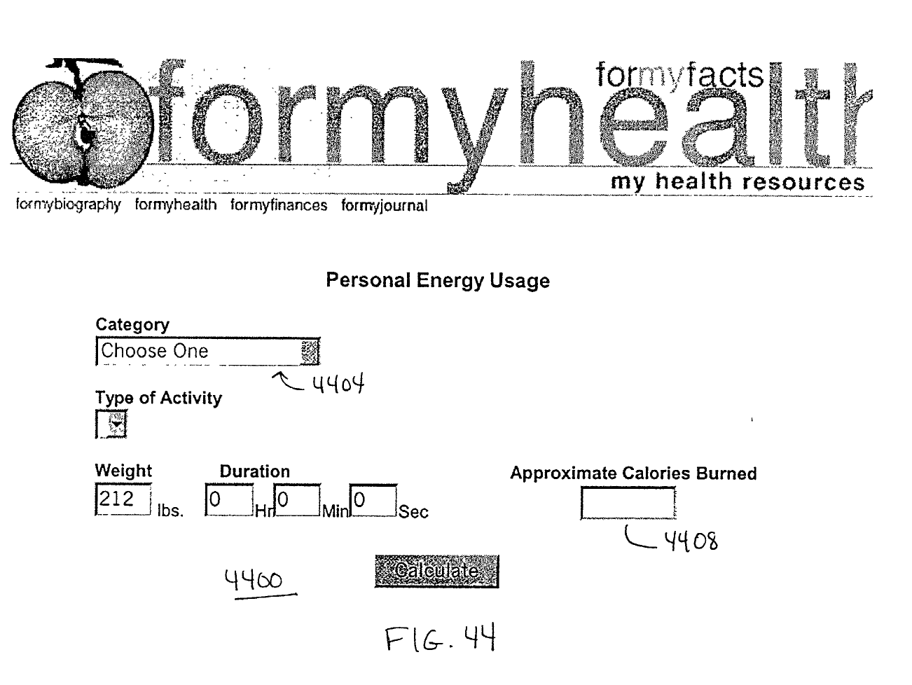

A risk of coronary disease link 2790 may be selected from the health home page 2700 to access a coronary disease risk resource 4300 (see FIG. 43). The coronary disease risk resource 4300 allows the user 114 to enter information related to risk factors for coronary disease, and returns results characterizing that risk.

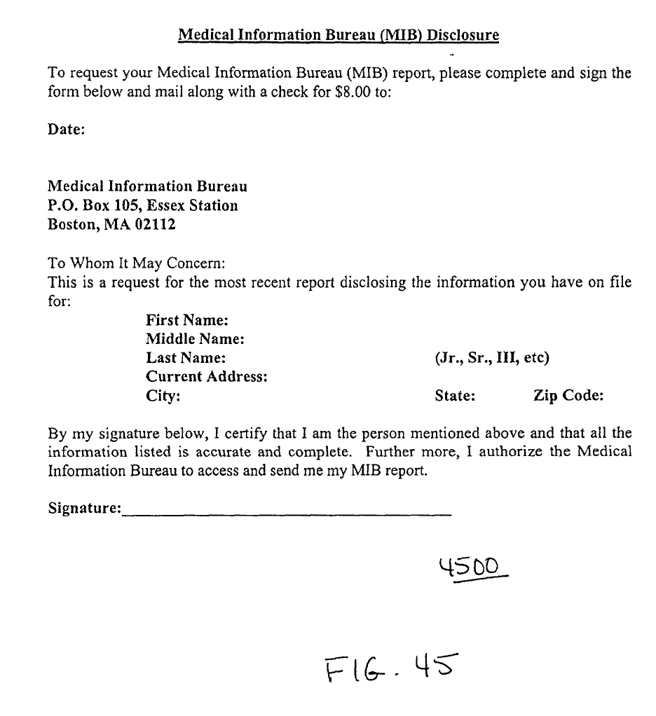

A personal energy usage resource 4400 (FIG. 44) may be accessed by selecting a personal energy usage link 2791 on the health home page 2700. The personal energy usage resource 4400 allows the user 114 to enter information regarding a physical activity, their weight, and the amount of time that the activity is engaged in using data entry fields 4404. A results field 4408 may then return the amount of calories burned based on the information entered by the user.

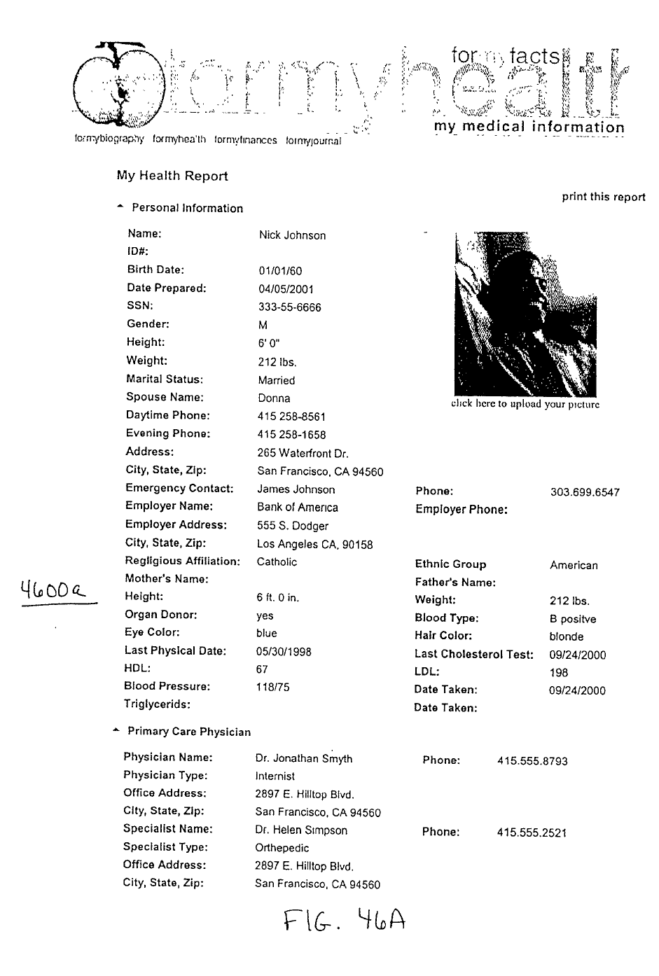

An example Medical Information Bureau (MIB) request form 4500 is illustrated in FIG. 45. The request 4500 may be accessed by selecting the MIB disclosure request link 2792 provided in connection with the health home page 2700. The Medical Information Bureau request form 4500 may provide spaces in which the user 114 can add identifying information. Alternatively, identifying information may be drawn from biographical information 408 maintained in the virtual file cabinet system 100 in connection with the user 114 to generate a completed request 4500.

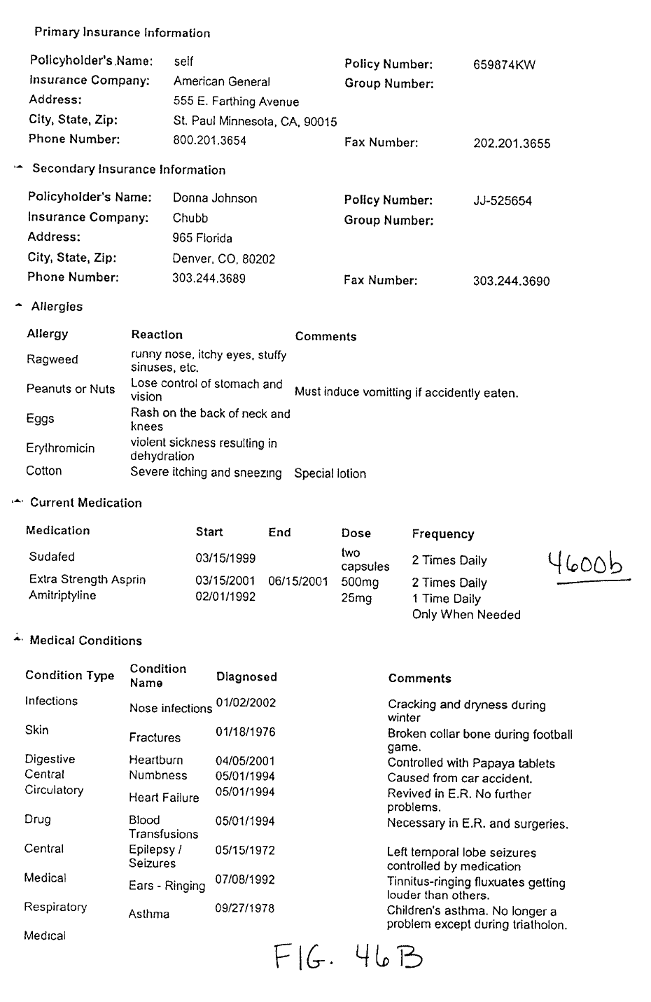

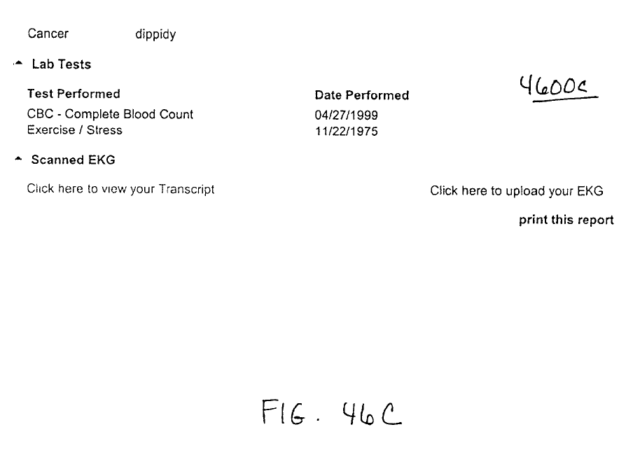

With reference now to FIGS. 46A-46C, a health report 4600 is illustrated. The health report 4600 may be accessed by selecting a health report link 2793 provided as part of the health home page 2700. The health report 4600 contains biographical information 408 and health information 412 related to the user 114. Accordingly, the report engine 444 draws on both biographical information 408 and health information 412 in populating the report template 440 and generating the completed report 508.

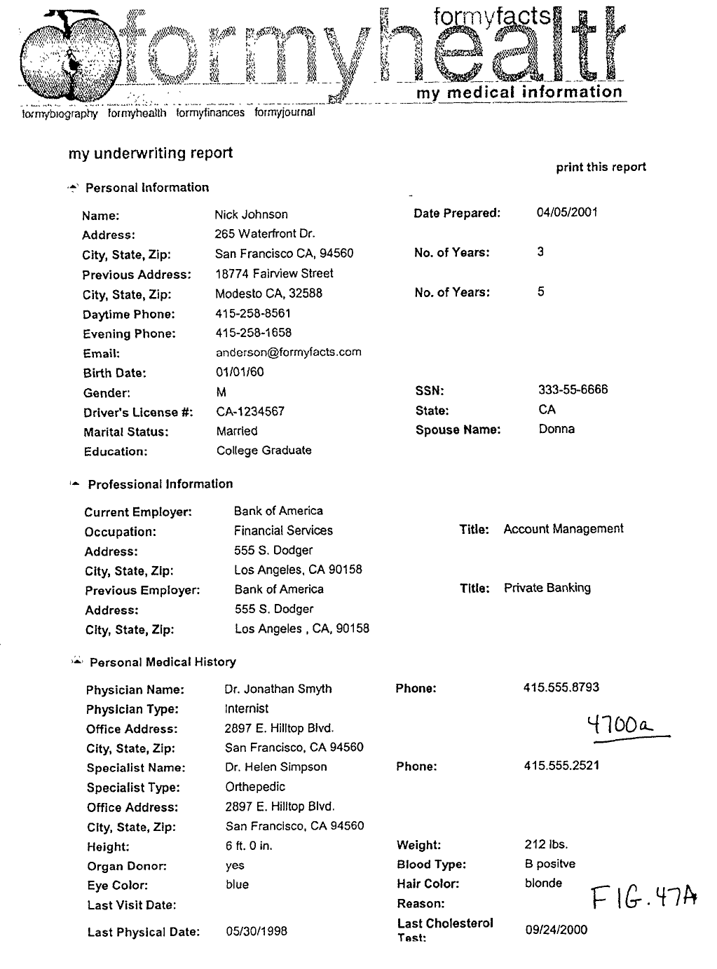

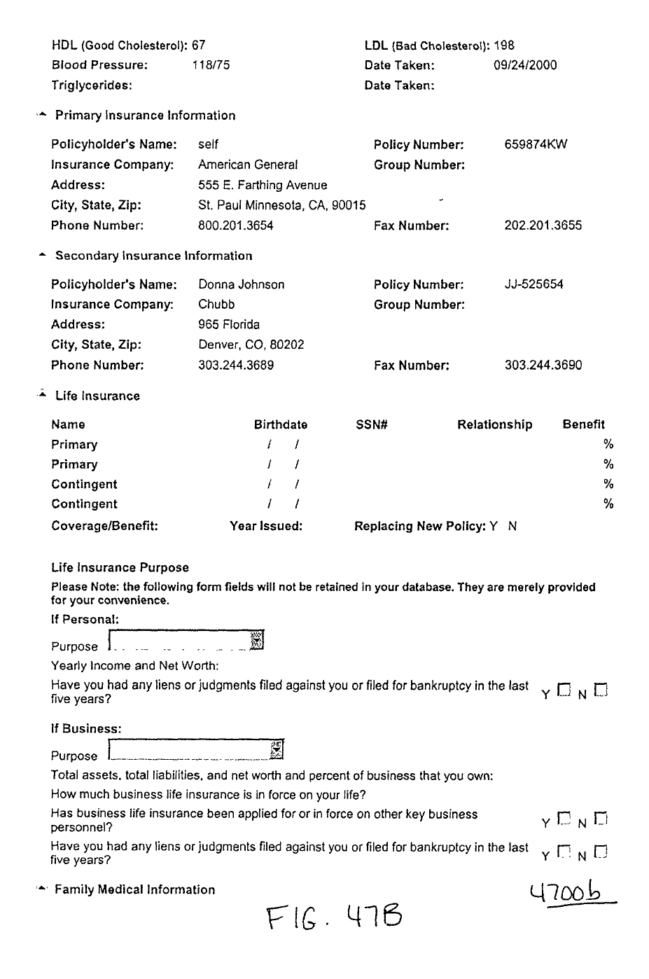

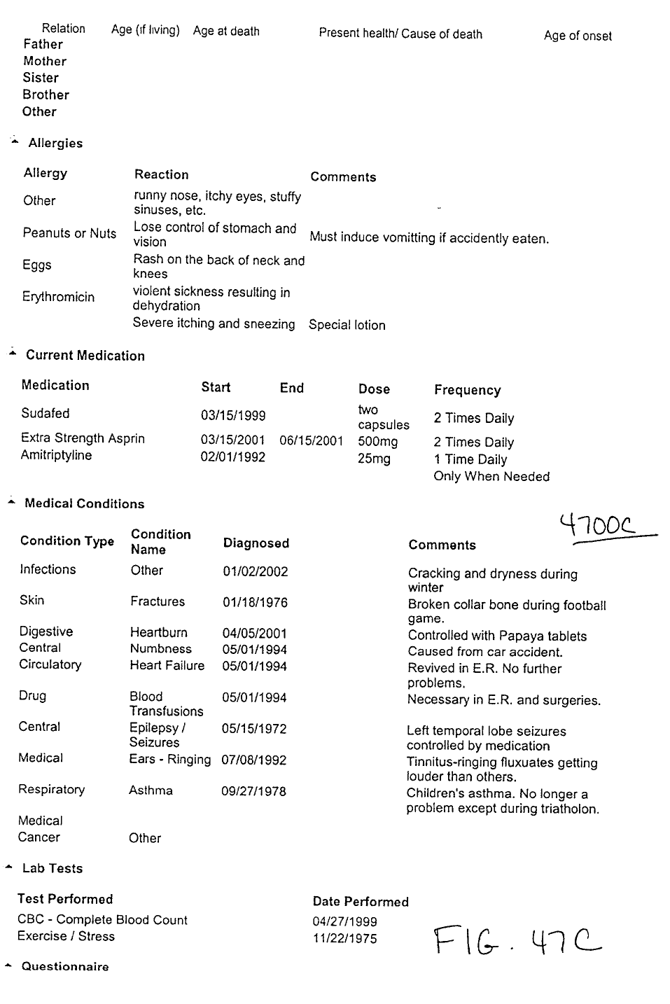

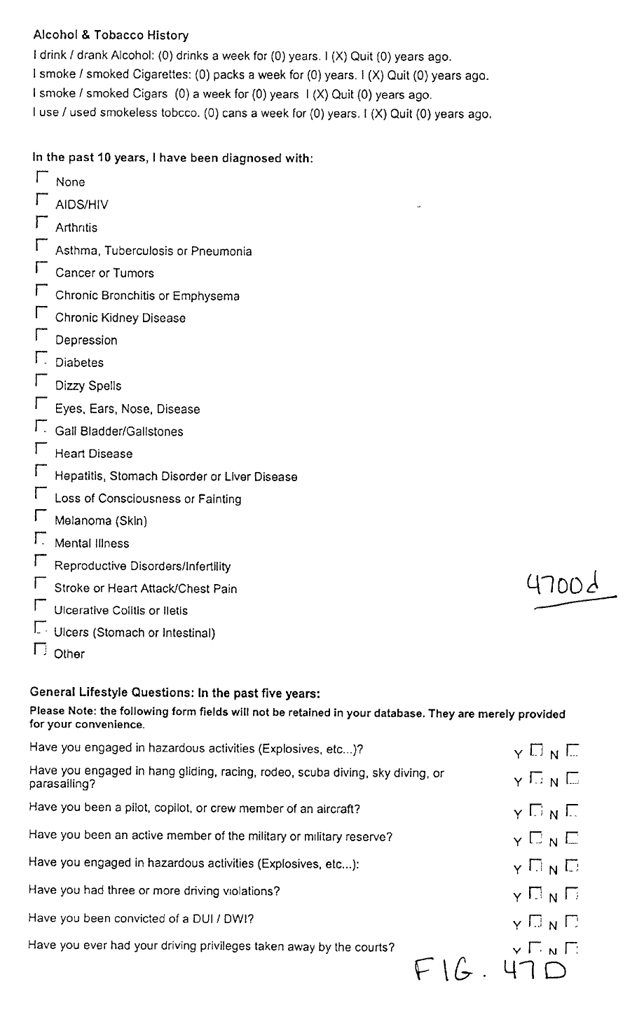

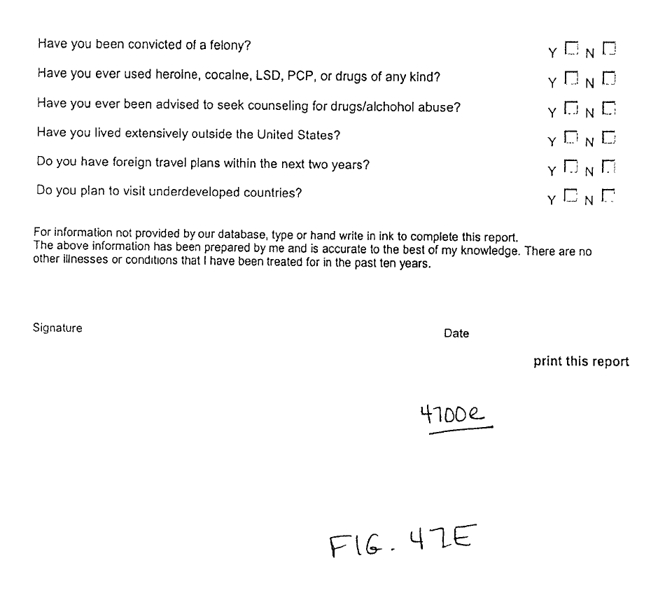

In FIGS. 47A-47D, an underwriting report 4700 in accordance with an embodiment of the present invention is illustrated. In generating the underwriting report 4700, the report engine 444 draws from biographical 408 and health 412 information. In addition, the report 444 may draw from financial information 416 maintained in connection with the user 114, for example, where the underwriting report 4700 is used in connection with a request for life insurance in which a business is the beneficiary. In general, the underwriting report 4700 provides items of information that are commonly required by insurers in determining whether to underwrite a request for insurance.

Accordingly, the underwriting report 4700 may be generated by a user 114 and presented to potential insurers, in lieu of manually completing a form that is then provided by individual insurers. The underwriting report 4700 may be accessed by selecting the underwriting link 2794 provided on the health home page 2700.

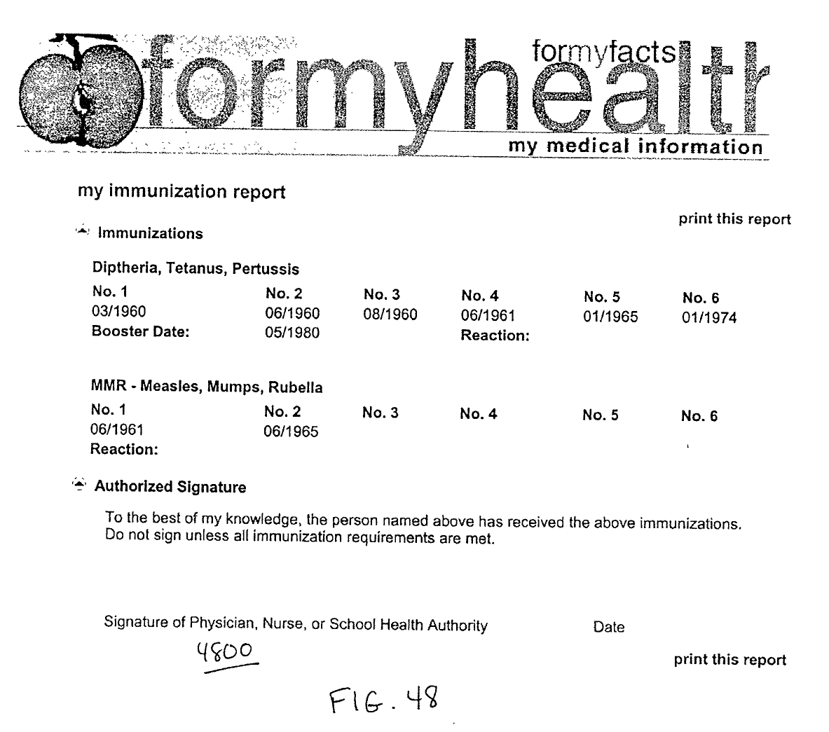

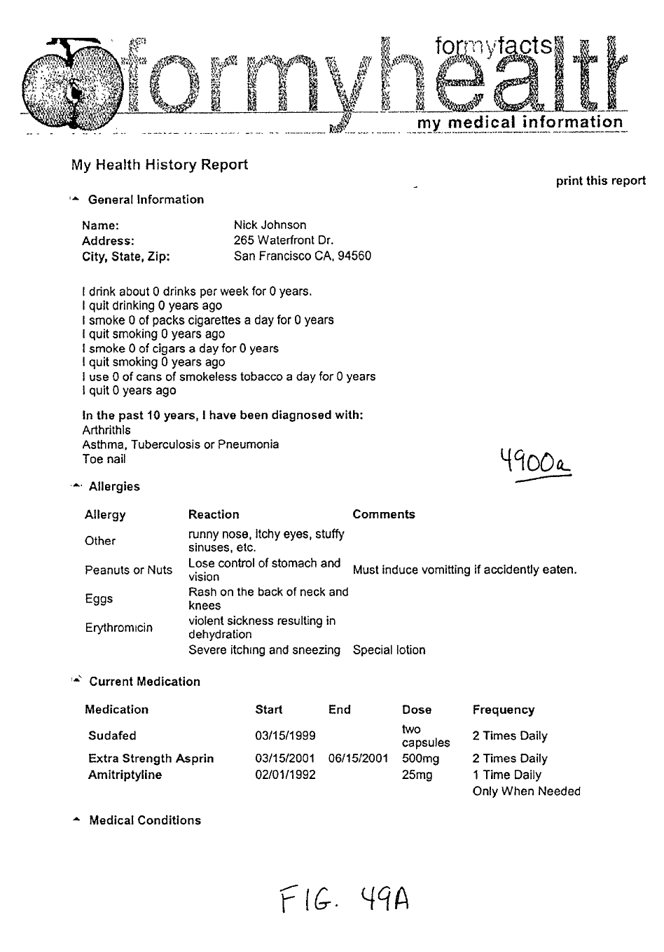

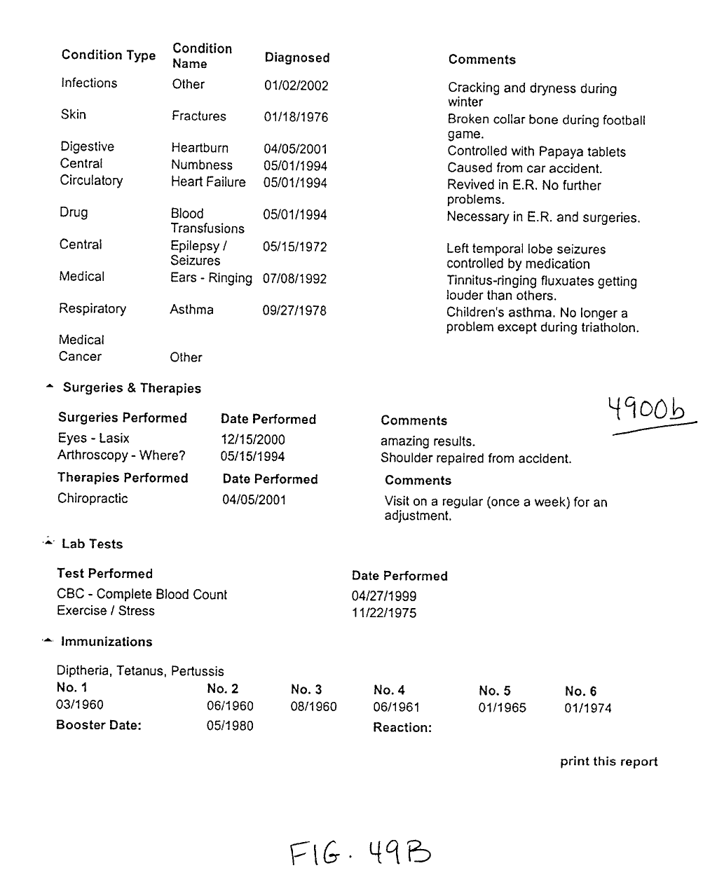

By selecting an immunizations link 2795, a user 114 may be provided with an immunization report 4800 (FIG. 48). The immunization report 4800 generally summarizes the user's immunization history. The immunization report 4800 may be provided to, for example, a physician, nurse, or health authority for signature, to verify the reported history, for example, in connection with proving the user's immunization history to an educational institution.

A medical history report 4900 may be accessed by selecting the medical history link 2796 provided by the health home page 2700. The health history report 4900 generally summarizes the health history of the user 114.

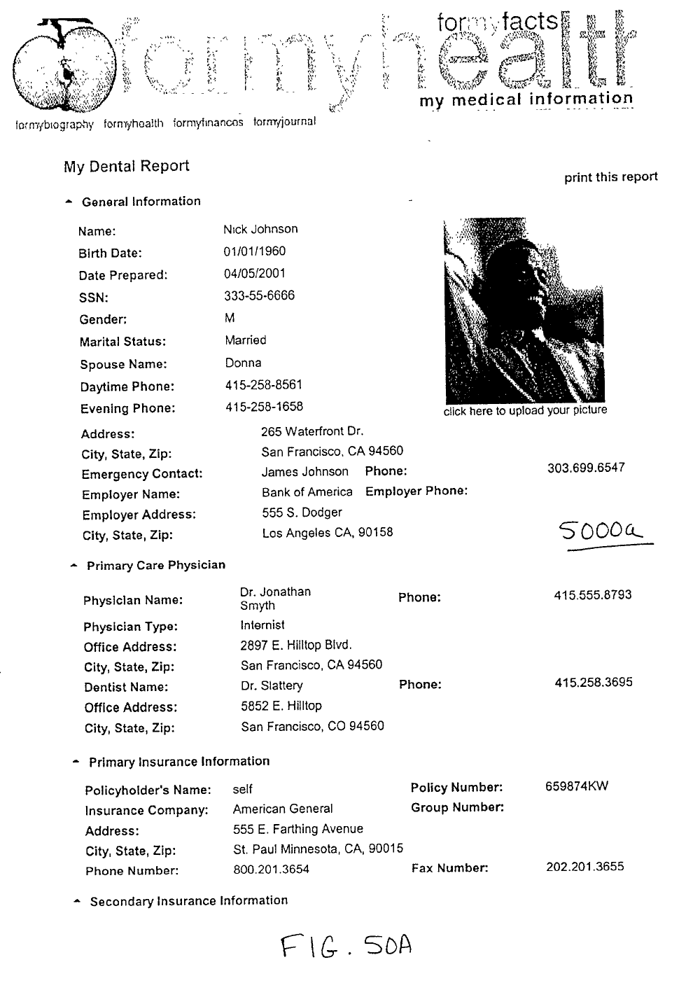

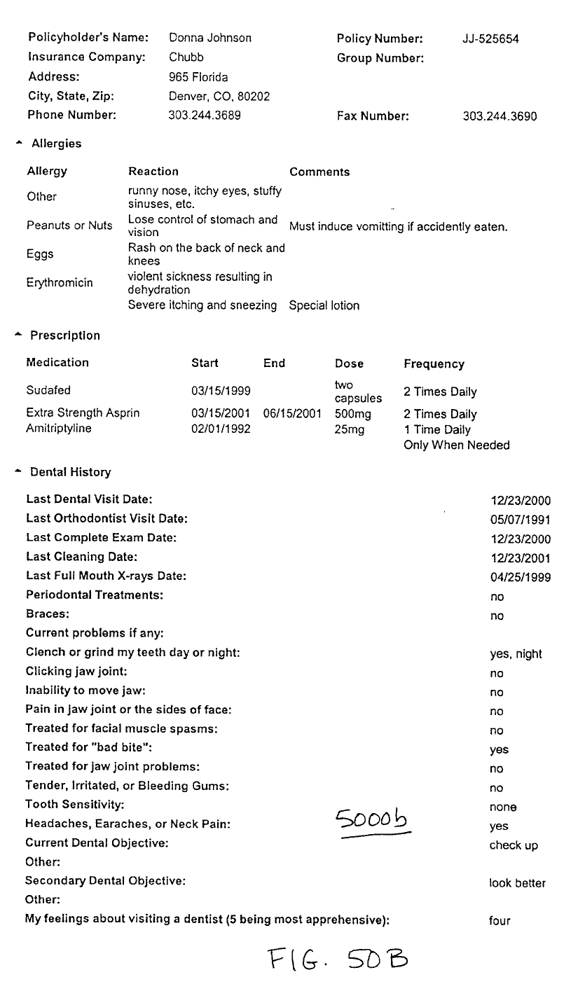

By selecting a dental information link 2797 from the health home page 2700, a user 114 may access a dental report 5000 (FIGS. 50A-50B). The dental report 5000 generally summarizes the dental history of the user 114, and may include insurance information and information regarding medical service providers.

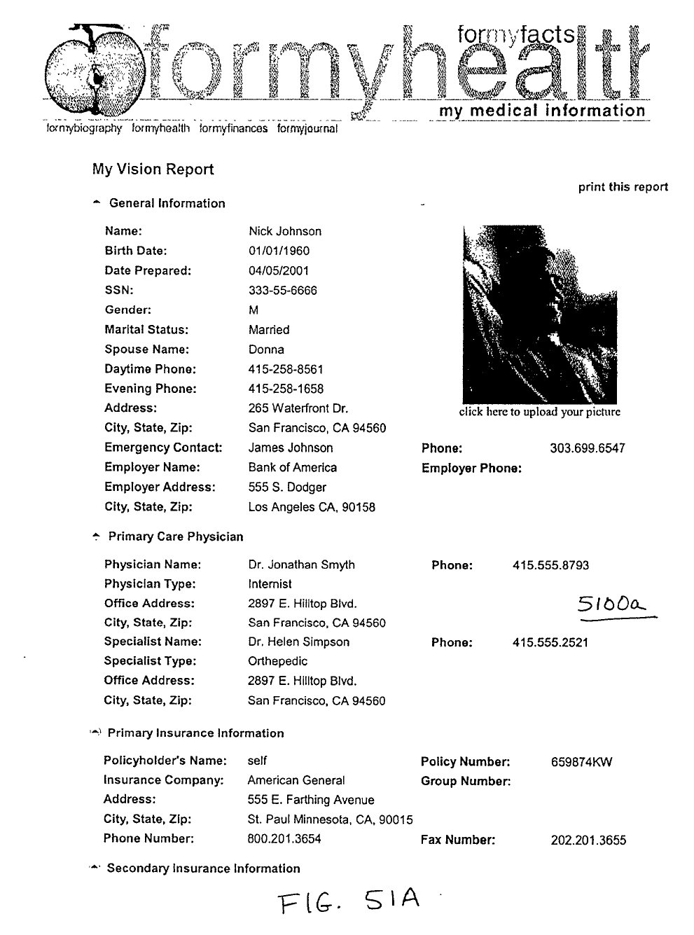

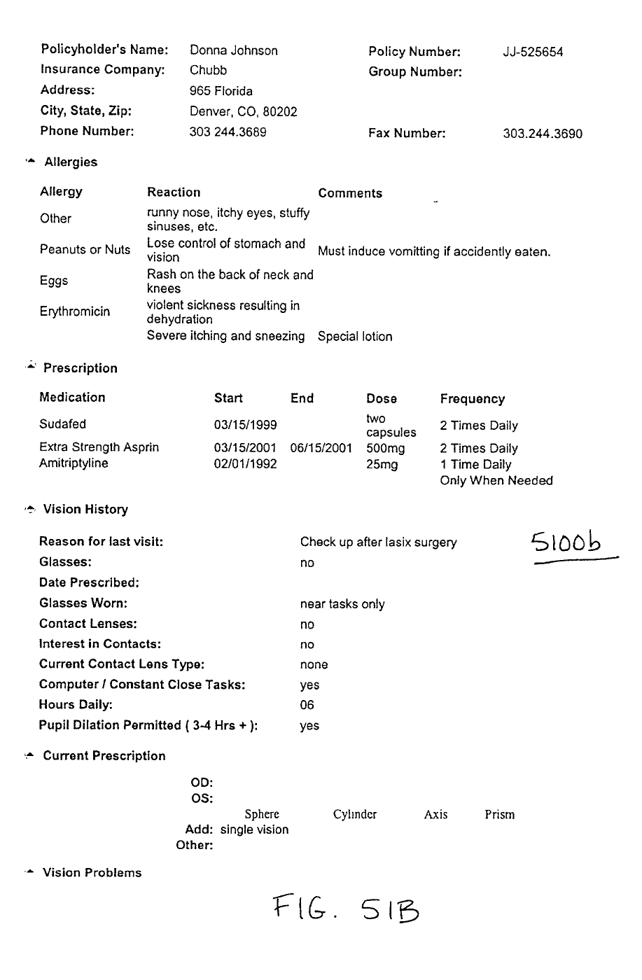

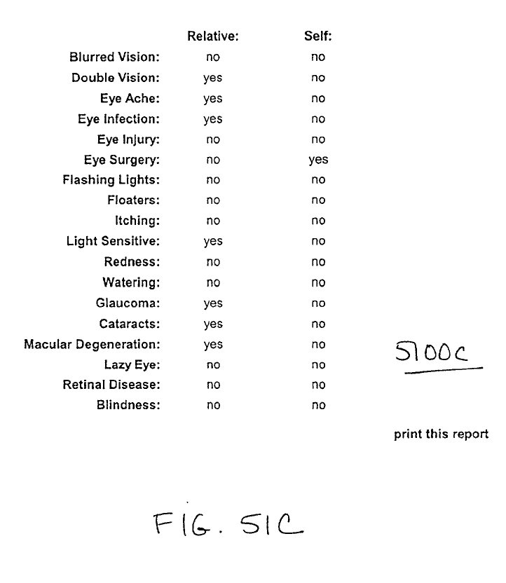

FIGS. 51A-51C illustrate a vision report 5100 that can be accessed by selecting a vision information link 2798 from the health home page 2700. The vision report 5100 may include prescription information and health history information relevant to the user's vision. In addition, information regarding insurers and medical service providers may be included.

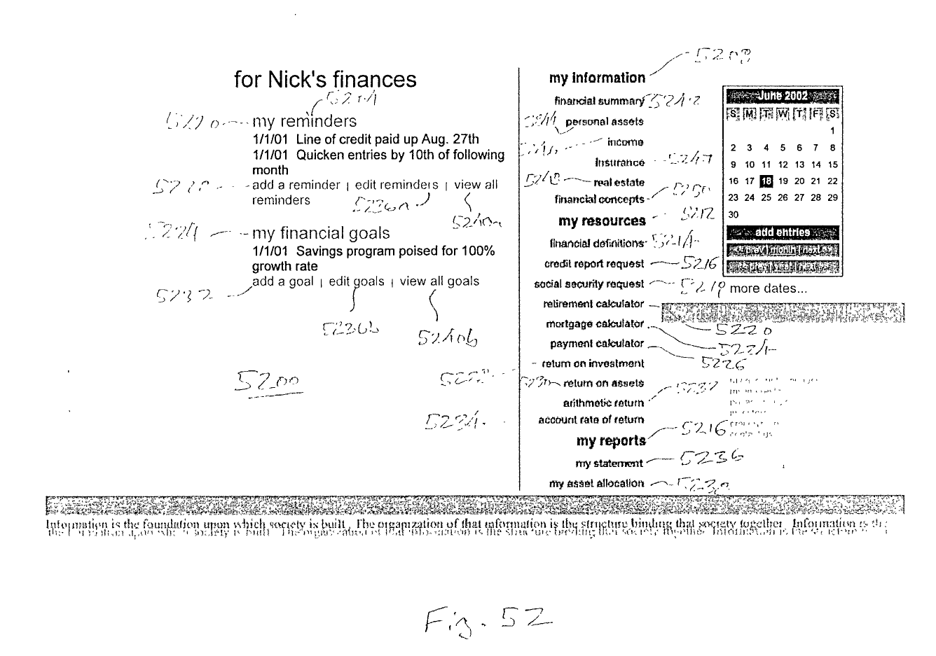

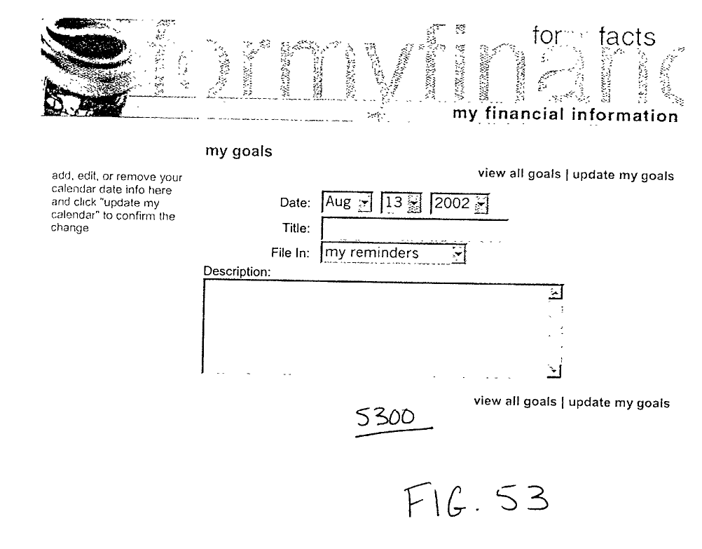

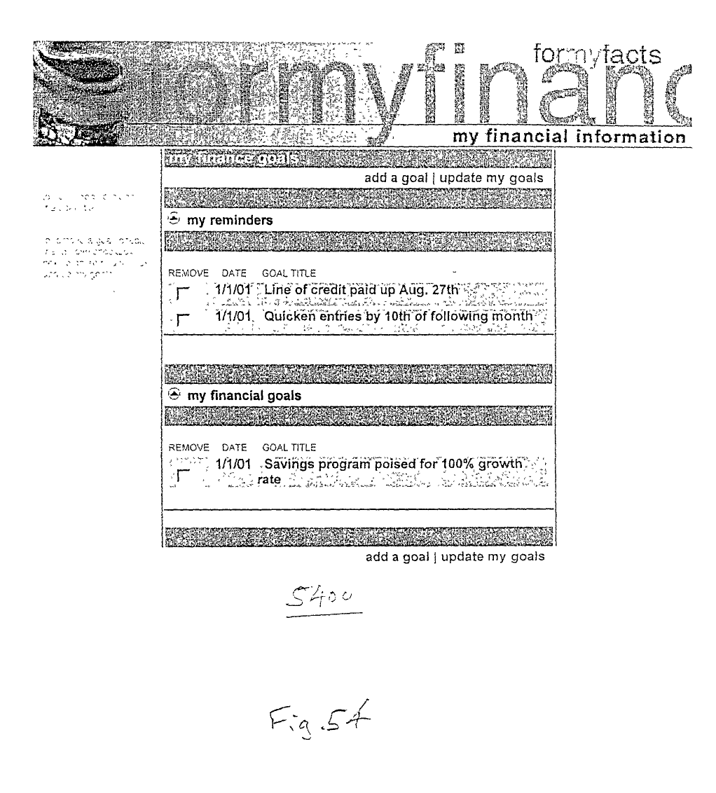

With reference now to FIG. 52, a finances home page 5200 in accordance with an embodiment of the present invention is illustrated. The finances home page 5200 includes a display of reminders and goals 5204. In addition, forms 5208, resources 5212, and reports 5216 may be accessed from the finances home page 5200. “Reminders” 5220 may generally include information regarding payment deadlines or tasks. “My financial goals” 5224 provides a place for a user to enter a list of financial goals. The user 114 may choose to add a reminder by selecting the add a reminder link 5228. In response to such a selection, an add a reminder page 5300 is presented to the user (FIG. 53). The user may then enter desired information regarding a new reminder. Similarly,, by selecting an add a goal link 5232, the user 114 may add a goal. By selecting an edit reminders (or edit goals) link 5236, or by selecting a view all reminders (or view all goals) 5240 link, the user 114 may be presented with an edit reminders and goals form 5400 (FIG. 54). Using the edit reminders and goals form 5400, the user 114 may delete, edit and revise reminders and goals.

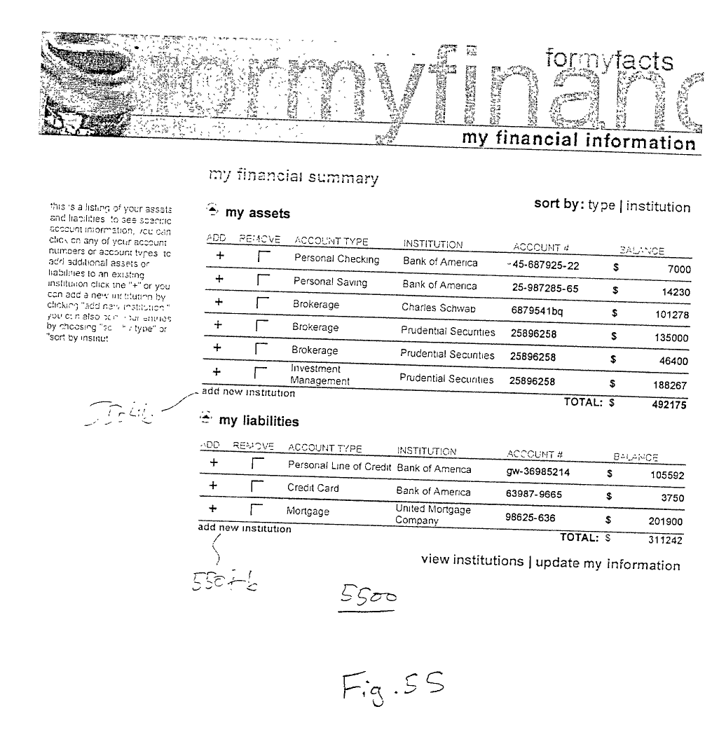

By selecting a financial summary link 5242, a user 114 may access a financial summary form 5500. The financial summary form 5500 generally allows the user 114 to enter, delete, and edit assets and liabilities information (FIG. 55).

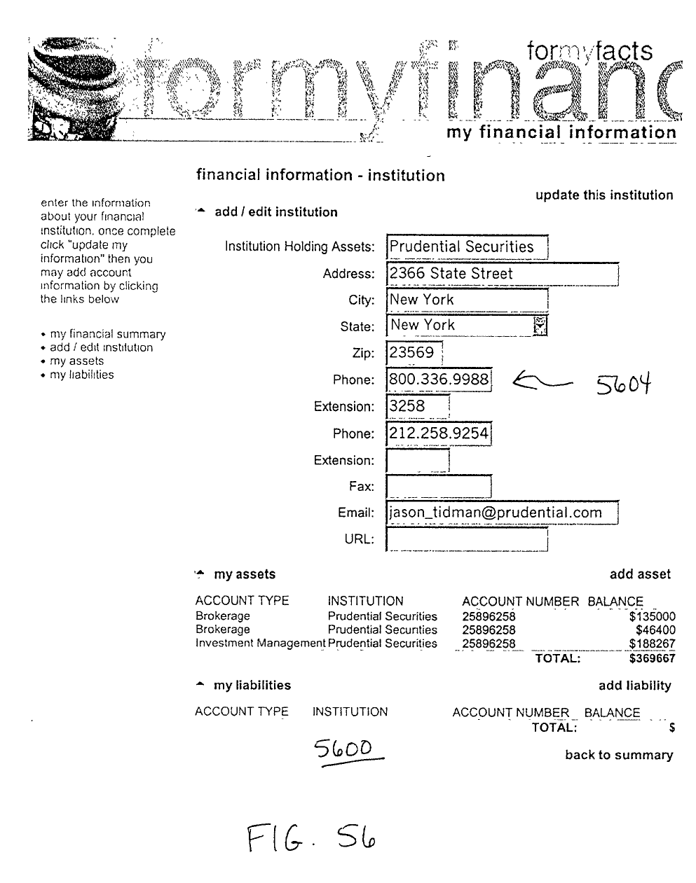

In FIG. 56, a financial information update form 5600 that is presented to a user 114 in response to selecting an existing asset or liability, or the add new institution link 5504 from the financial summary form 5500 is illustrated. In general, fields 5604 are provided for adding pertinent information. In addition, any assets or liabilities associated with the subject institution are shown on the form.

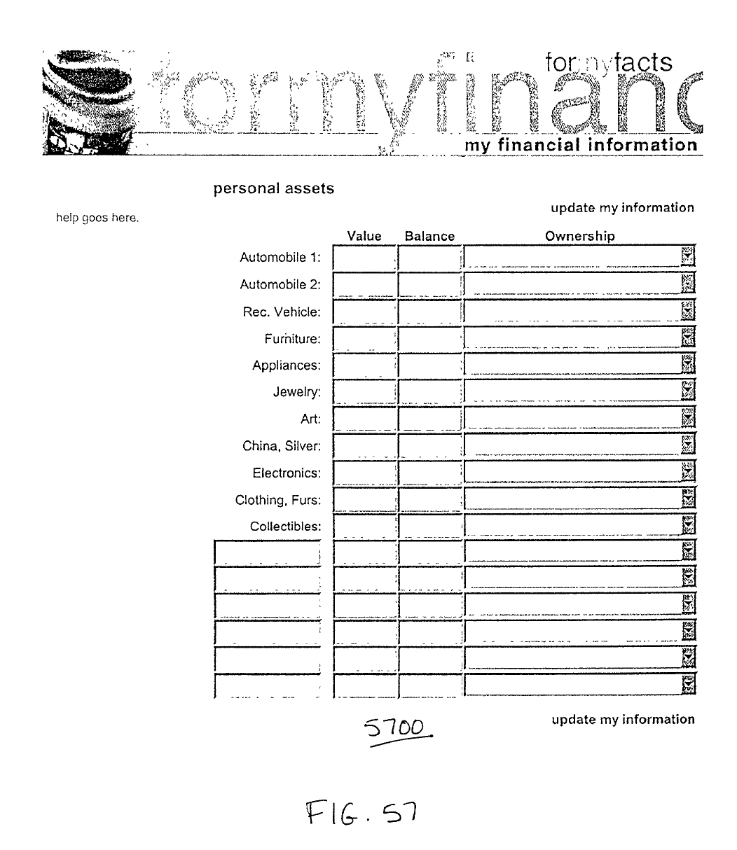

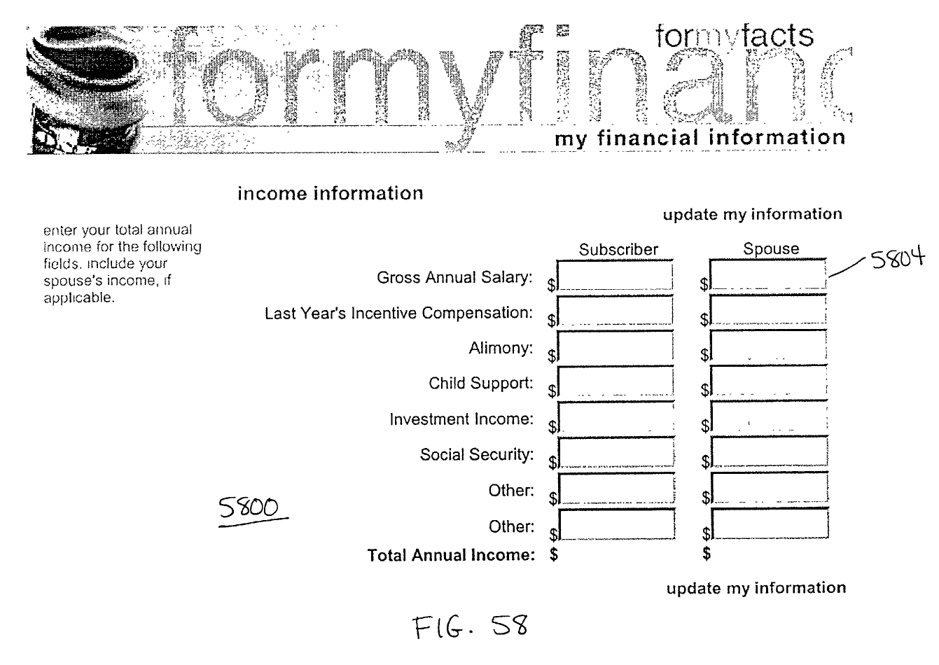

By selecting a personal assets link 5244 on the finances home page 5200, a user 114 may access a personal assets information form 5700 (FIG. 57). In general, the personal assets information form 5700 allows the user 114 to list personal assets by description, value, and any amount owed in connection with the asset.

An income information form 5800 may be accessed by selecting the income link 5246 provided as part of the finances home page 5200. The income information page 5800 provides fields 5804 in which information regarding the user's income and income from the user's spouse may be entered.

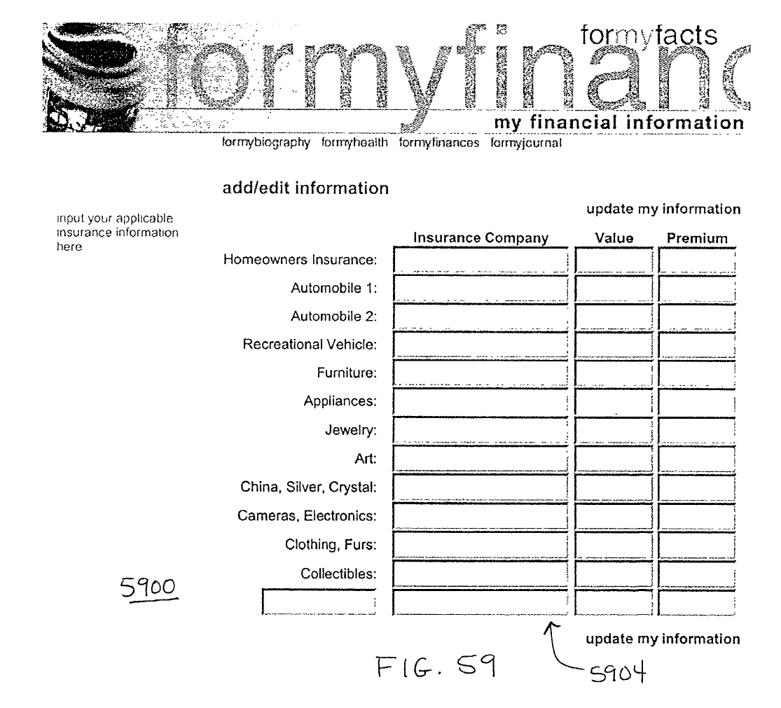

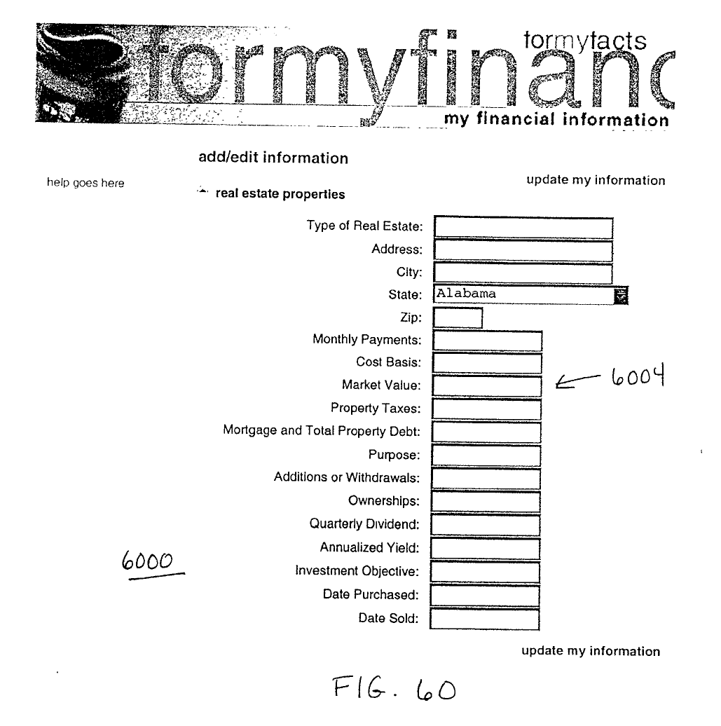

By selecting an insurance link 5247 from the finances home page 5200, a user 114 may access an insurance form 5900 (FIG. 59). The insurance form 5900 allows the user 114 to enter insurance information regarding various items in data entry fields 5904.

A real estate information form 6000 is accessed through a real estate link 5248 provided on the finances home page 5200. The real estate form 6000 provides data entry fields 6004 in which information identifying real estate owned by the user 114 and regarding the value of that real estate may be entered.

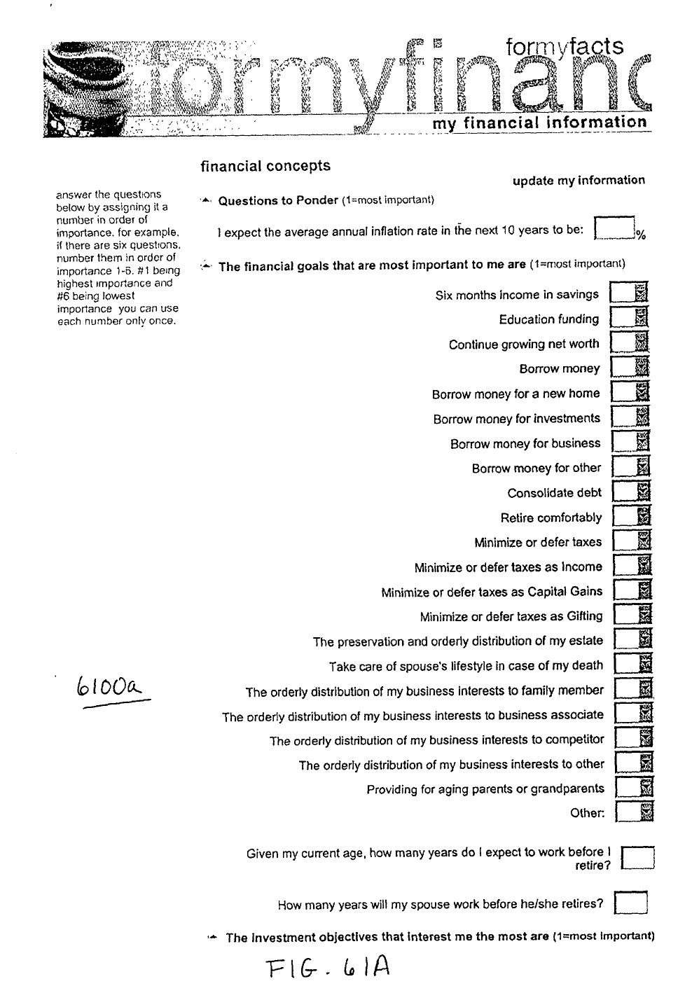

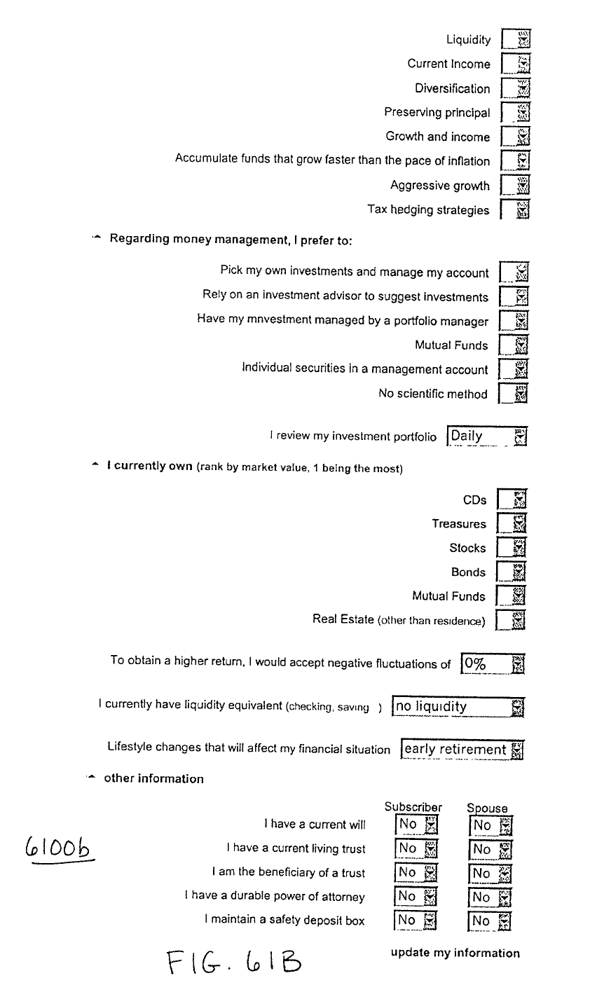

With references now to FIGS. 61A-61B, a financial concepts form 6100 is illustrated. The financial concepts form 6100 may be accessed by selecting the financial concepts link 5250 from the finances home page 5200. The financial concepts page 5200 generally provides fields 6104 in which the user 114 may characterize their behavior regarding finances, including important goals, money management style, preferred investments, and investments currently held.

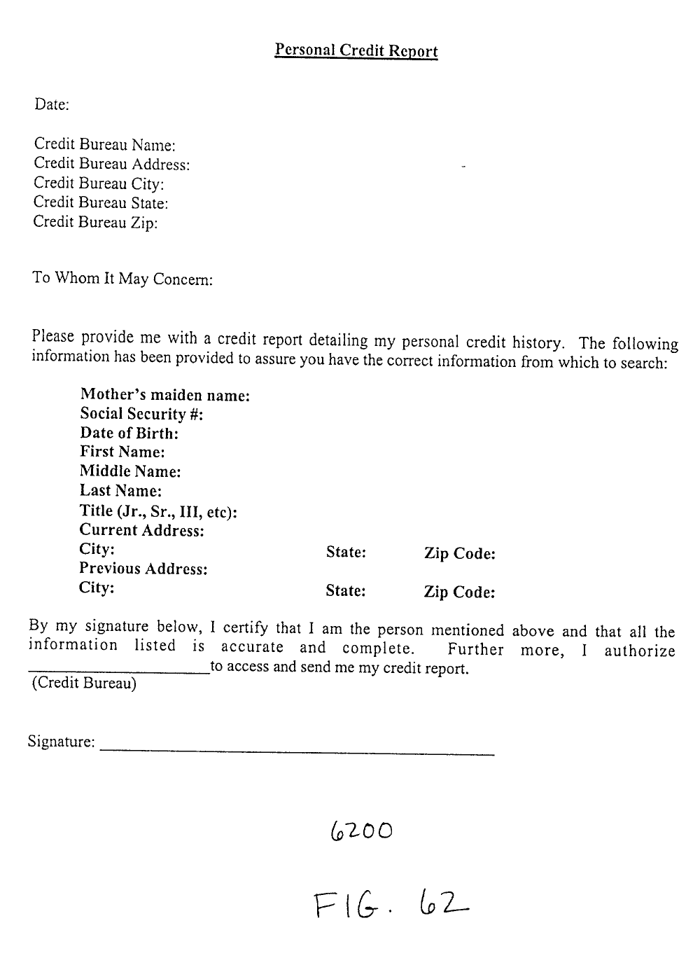

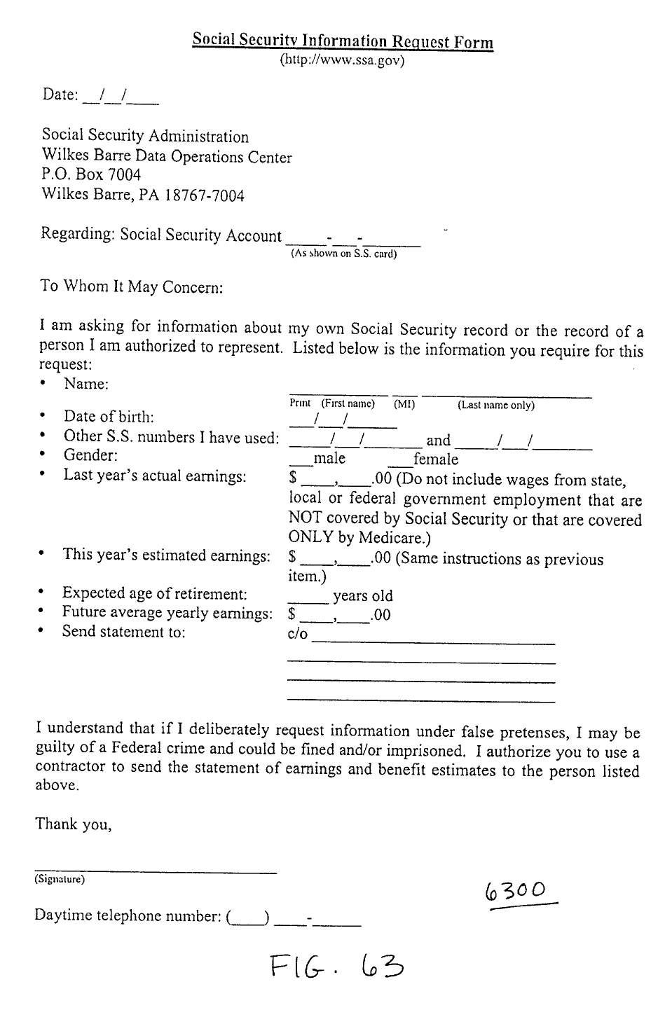

Several resources may be accessed from the finances home page 5200. For example, a financial definitions link 5214 may be provided to allow the user 114 to access a glossary of financial terms. A credit report request link 5216 allows the user 114 to generate a credit report request addressed to a selected credit reporting agency. An example personal credit report request 6200 is shown in FIG. 62. In connection with the credit report request page 6200, the user may be provided with general information regarding fees charged by credit reporting agencies in connection with the provision of reports. Similarly, a Social Security request link may be provided as part of the finances home page 5200 to allow a user 114 to generate a request for Social Security information. An example Social Security information request form 6300 is shown in FIG. 63. In accordance with an embodiment of the present invention, the Social Security information request form 6300 is at least partially populated with information automatically provided from information stored in the virtual file cabinet in connection with the user 114.

A retirement calculator resource may be accessed by selecting a retirement calculator link 5220. The retirement calculator generally allows a user 114 to enter information regarding their retirement goals and time line. The calculator may then access information maintained in the virtual file cabinet, for example, financial information 416 maintained in connection with the user 114, to provide information regarding anticipated retirement account values.

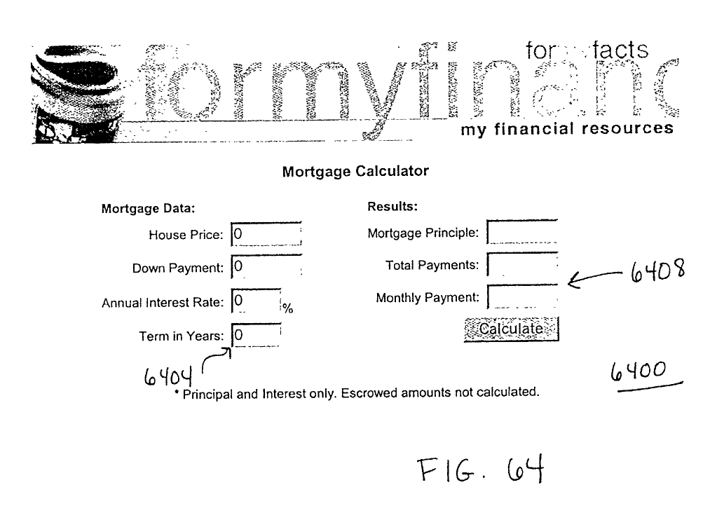

A mortgage calculator link 5224 may be selected from the finances home page 5200 to access a mortgage calculator resource 6400 (FIG. 64). The mortgage calculator 6400 allows the user 114 to input information in data entry fields 6404. Upon submission of the information, calculated results, including mortgage principal, total payments and monthly payment 6408 may be returned.

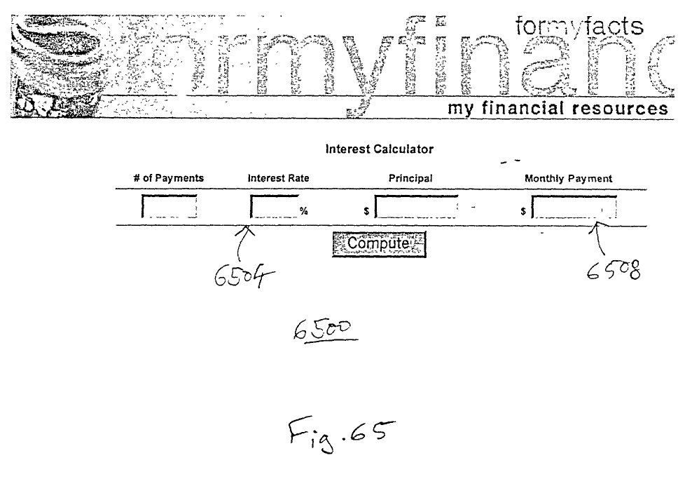

A payment calculator link 5226 may be selected from the finances home page 5200 to determine monthly payments based on loan information entered by the user 114 (see FIG. 65). Accordingly, fields 6504 may be provided for the entry of information, and a results field 6508 may contain a calculated value.

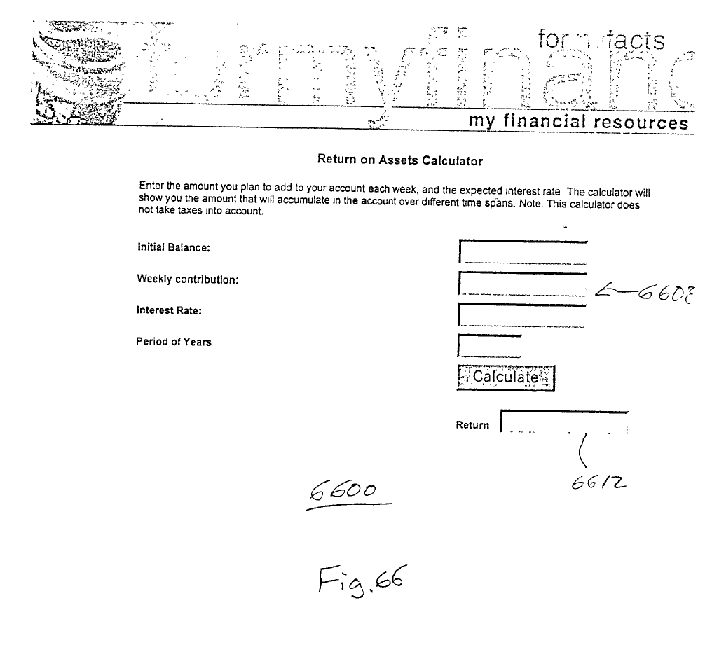

With reference now to FIG. 66, a return on investments calculator resource 6600 is illustrated. The return on investments calculator resource 6600 may be accessed by selecting the return on investment link 5228 provided as part of the finances home page 5200. The return on investments calculator resource 6600 provides fields 6608 in which asset information and a time period may be entered. A results box 6612 displays the calculated results to the user 114 after submission of the entered information.

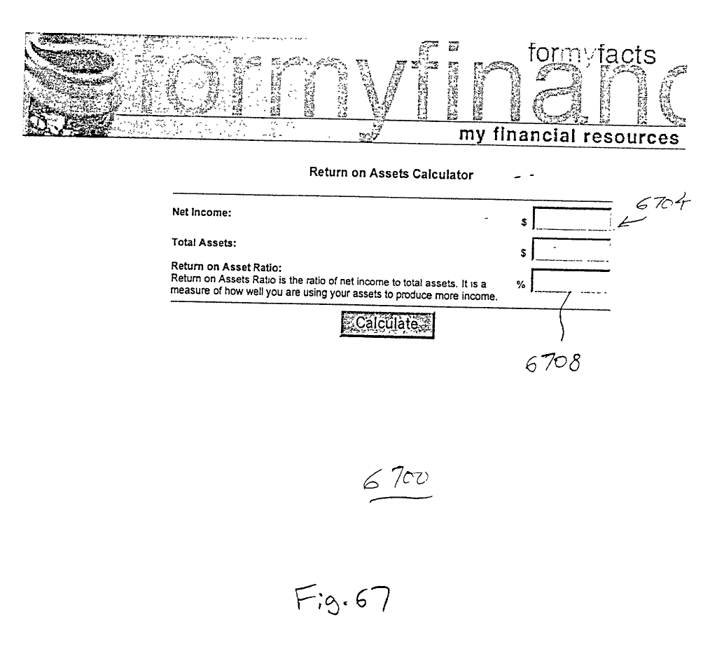

With reference now to FIG. 67, a return on assets calculator 6700 is illustrated. The return on assets calculator 6700 may be accessed by selecting the return on assets link 5230 provided as part of the finances home page 5200. The return on assets calculator 6700 may provide data entry fields 6704 for income and asset information. A return on asset ratio may then be displayed on a results field 6708 in response to submission of the entered information.

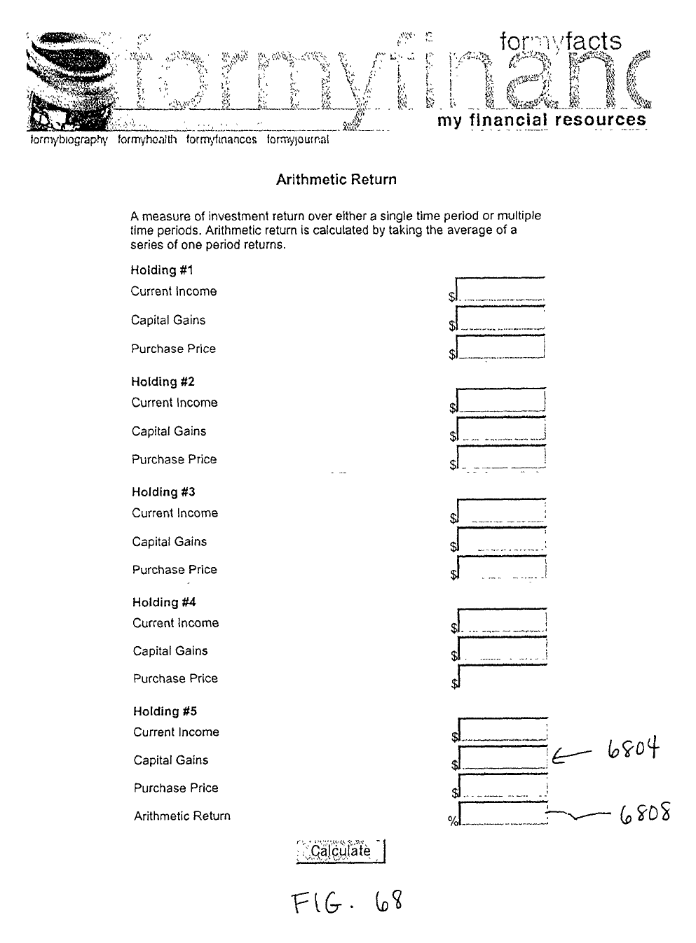

By selecting an arithmetic return link 5232 provided as part of the finances home page 5200, an arithmetic return resource 6800 may be accessed (FIG. 68). The arithmetic return resource allows calculation of an arithmetic return from various information provided in fields 6804 regarding investments or holdings. Results are returned in a results field 6808.

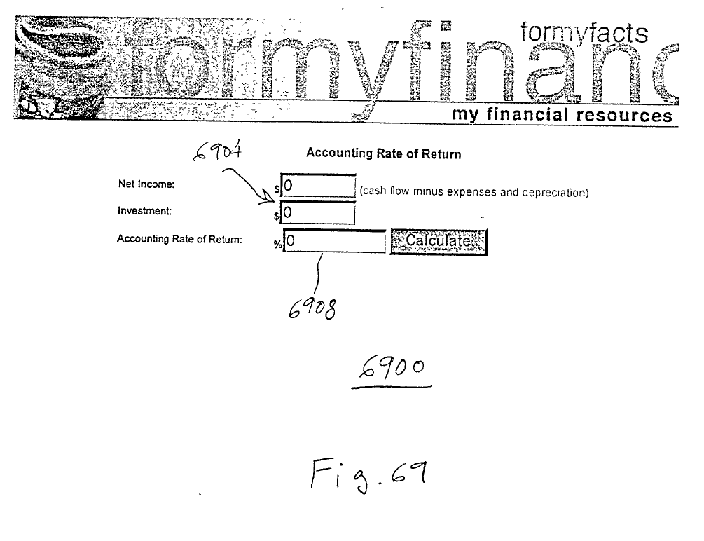

An accounting rate of return resource 6900 (FIG. 69) may be accessed by selecting the account rate of return link 5234 provided through the finances home page 5200. The accounting rate of return provides data entry fields 6904 in which the user 114 may enter net income and investment information. Upon submission of the information, the calculated accounting rate of return is provided in a results field 6908.

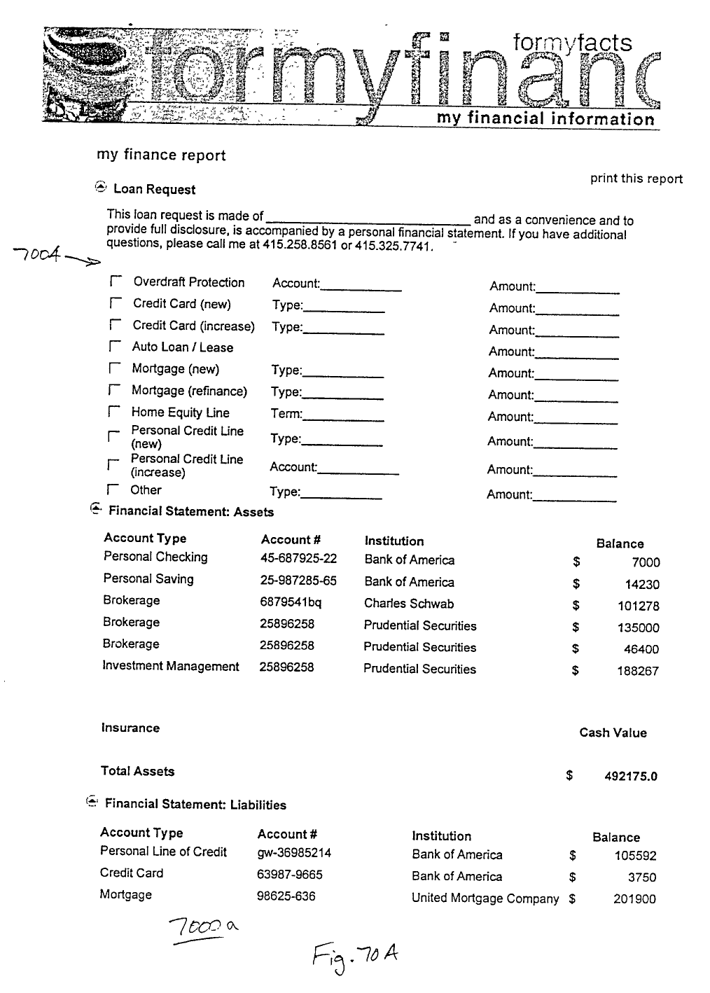

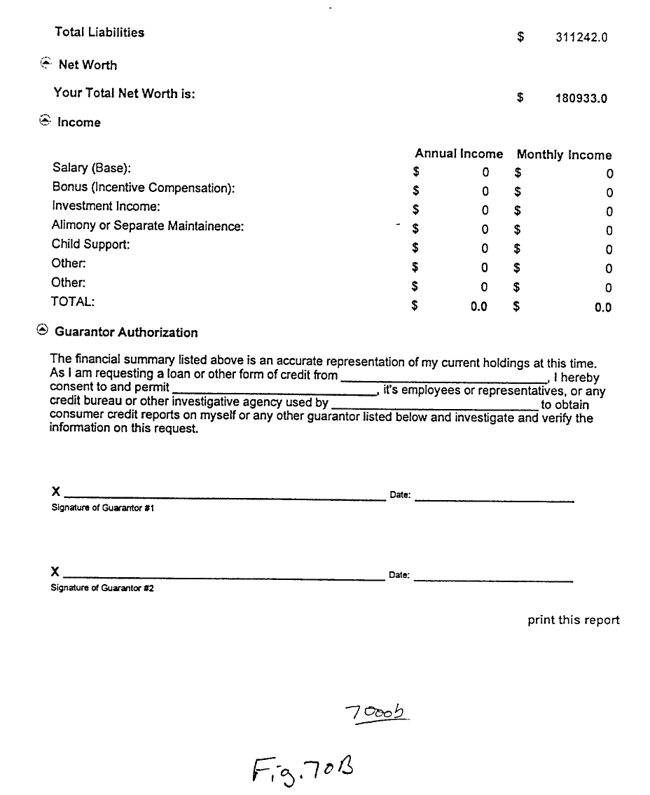

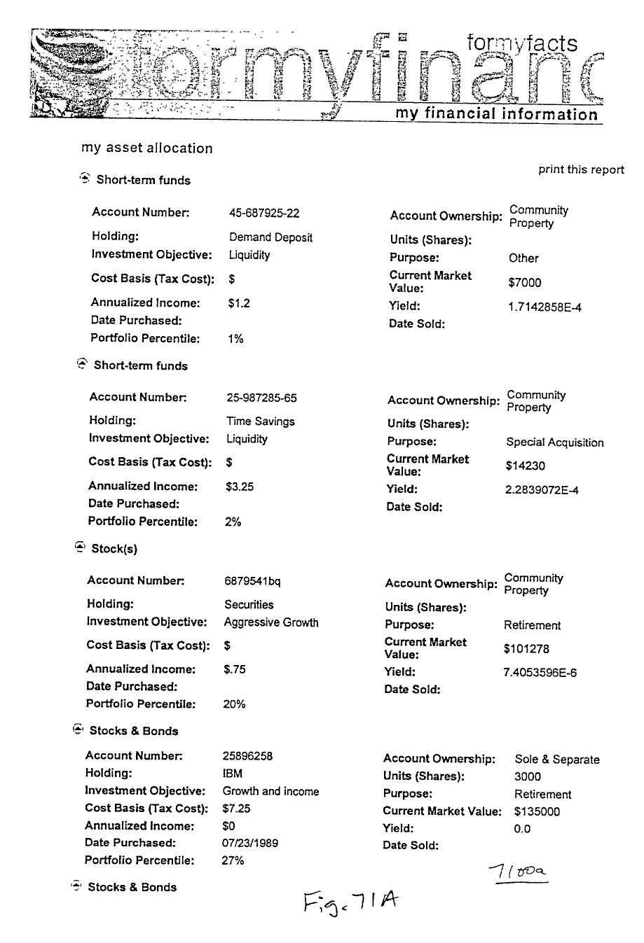

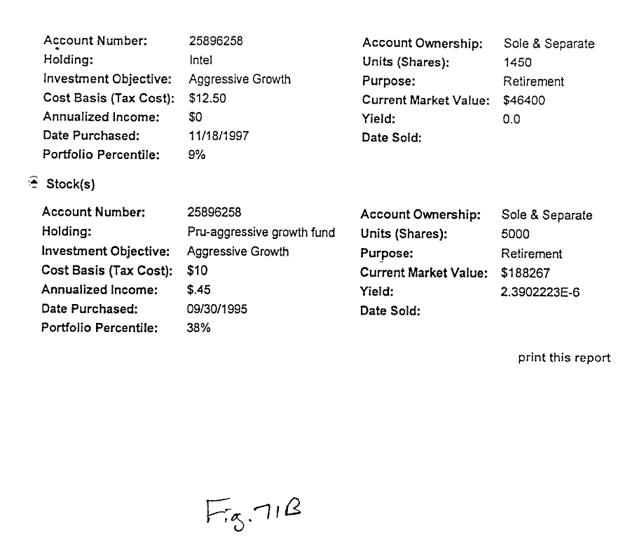

Reports that are accessible from the finances home page 5200 include a finance report or statement 7000 accessible through the my statement link 5236 (FIGS. 70A-70B) and an asset allocation report 7100 (FIGS. 71A-71B) accessible through the my asset allocation link 5238. The finance report 7000 summarizes asset, liability information, and insurance information regarding user 114. In addition, fields 7004 may be provided to allow a user 114 to enter parameters regarding a loan request. Accordingly, the finance report or statement 7000 may be generated by a user in connection with a loan request. The asset allocation report 7100 summarizes the various investments and other holdings of the user 114.

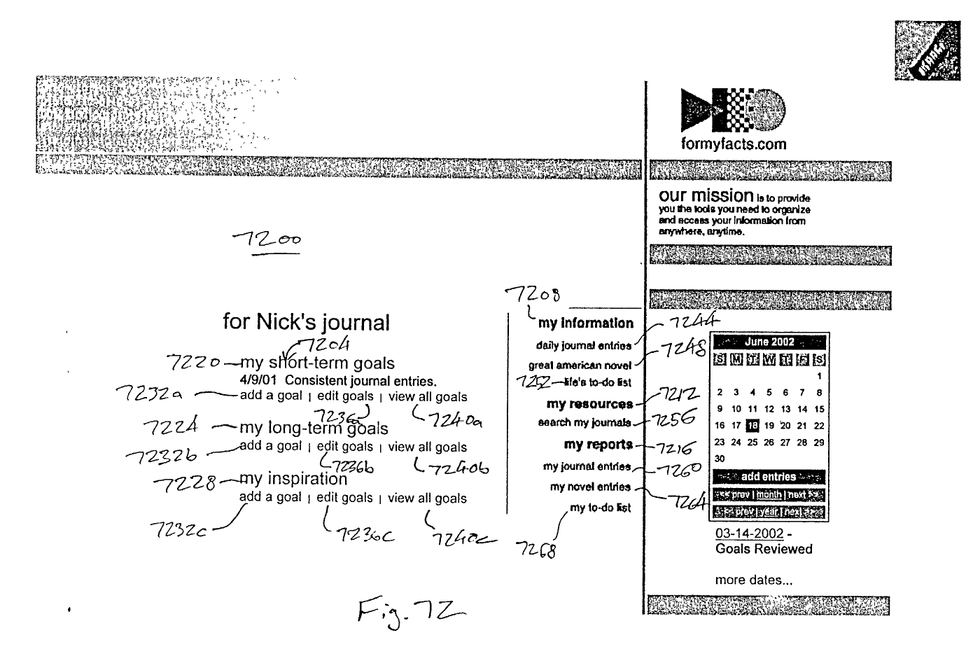

With reference now to FIG. 72, a journal home page 7200 in accordance with an embodiment of the present invention is illustrated. The journal home page 7200 may be accessed by making a selection within the journal selection area 816 of the category selection page 800. The journal home page 7200 generally includes displayed goals and inspirations 7204. In addition, forms 7208, resources 7212, and reports 7216 can be accessed through the journal home page 7200.

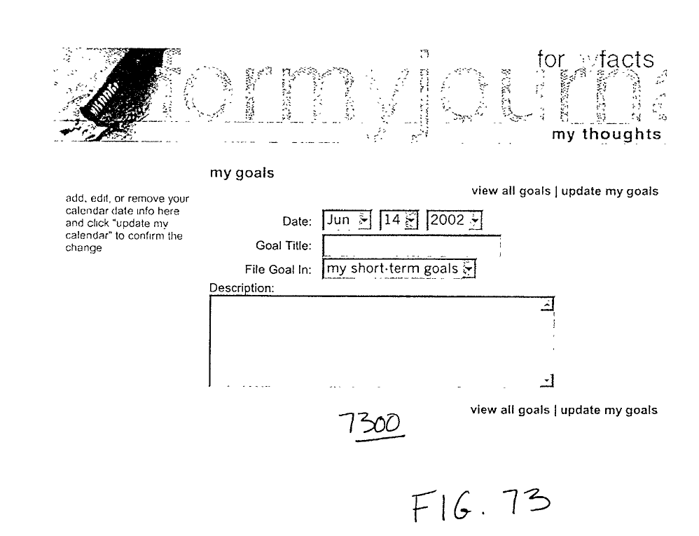

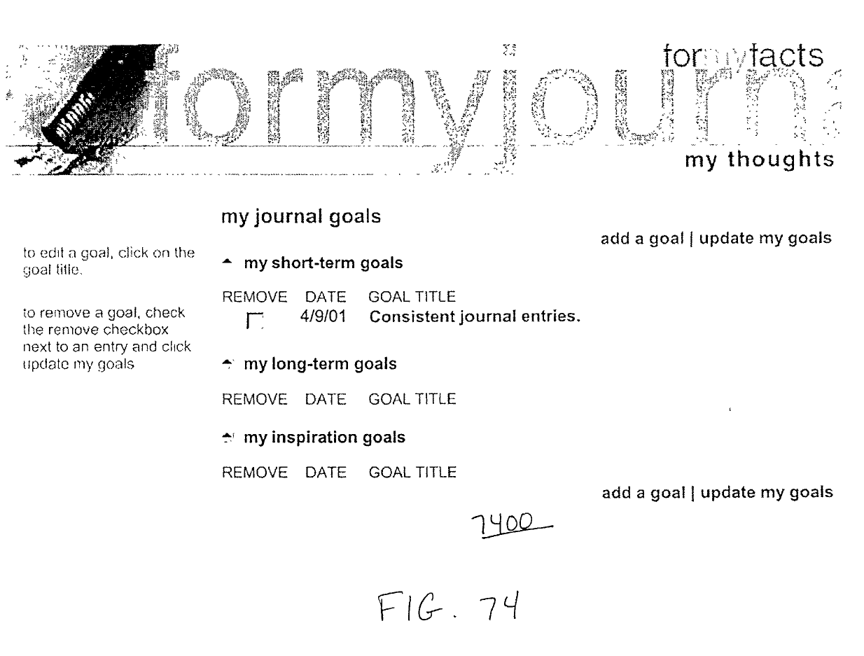

Goals and inspirations included in the journal home page 7200 include short term goals 7220, long term goals 7224, and inspirations 7228. By selecting an add a goal link 7232 under a category of goals or inspiration, the user is presented with an add a goal form 7300 (FIG. 73). Depending on the subcategory of goals 7204 under which the add a goal link 7232 that was selected appears, the subcategory will already be entered. In addition, the current date may be provided in the date fields. The user 114 may then enter a title and description for the goal. In response to a selection of an edit goals 7236 or view all goals 7240 link from the journal home page 7200, the user 114 is presented with an edit goals form 7400 (see FIG. 74). The edit goals form 7400 allows the user 114 to remove listed goals or to edit individual goals. In addition, the user 114 may add new goals from the forms 7400.

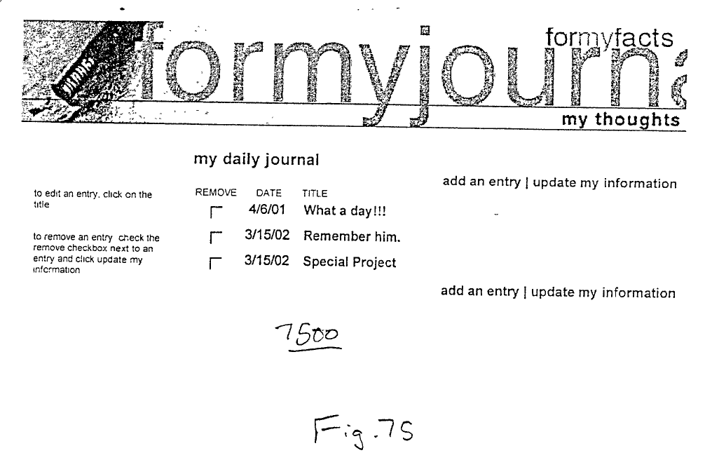

By selecting a daily journal entry link 7244, a user 114 may access a daily journal entry form 7500 (FIG. 75). From the daily journal form 7500, the user 114 may remove or edit existing journal entries, or add new entries.

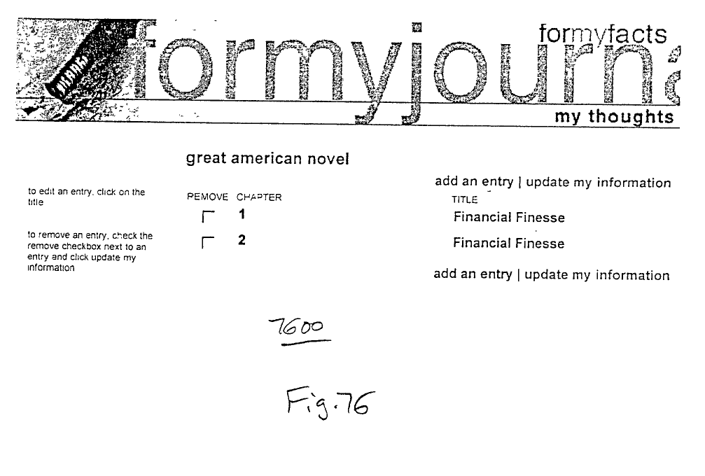

The user may access a great American novel form 7600 (FIG. 76) by selecting the great American novel link 7248 from the journal home page 7200. Using the great American novel form 7600, the user 114 may choose to remove or edit existing entries, or to add a new entry. In addition, the entries listed within the great American novel page 7600 may lead to additional pages that contain, for example, text, behind links provided on the great American novel form 7600. If desired, the text can be edited.

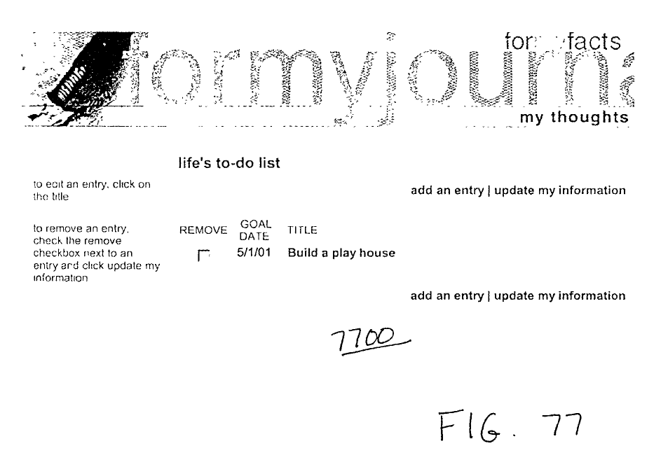

By selecting a life's to do list link 7252, a user 114 may access a life's to do list form 7700 (FIG. 77). The life's to do list form 7700 allows a user to remove or edit existing entries on the list. In addition, the user 114 may enter new to do list items.

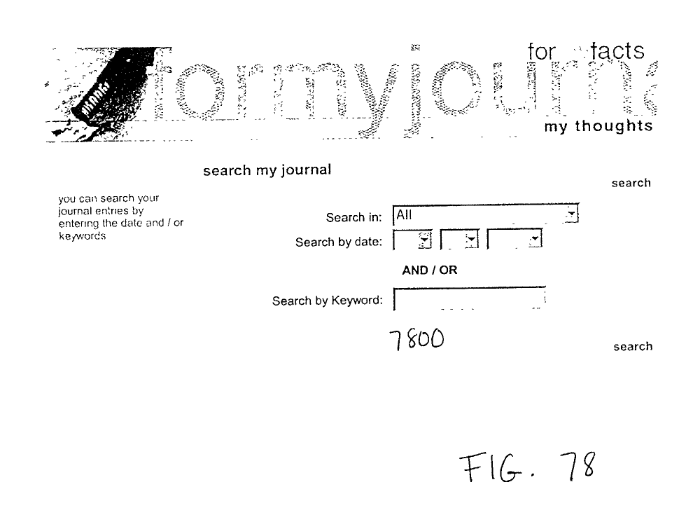

A search my journal resource 7800 (see FIG. 78) may be accessed by selecting a search my journals link 7256 from the journal home page 7200. The search my journal resource 7800 allows the user 114 to conduct searches of text stored in the user's journal.

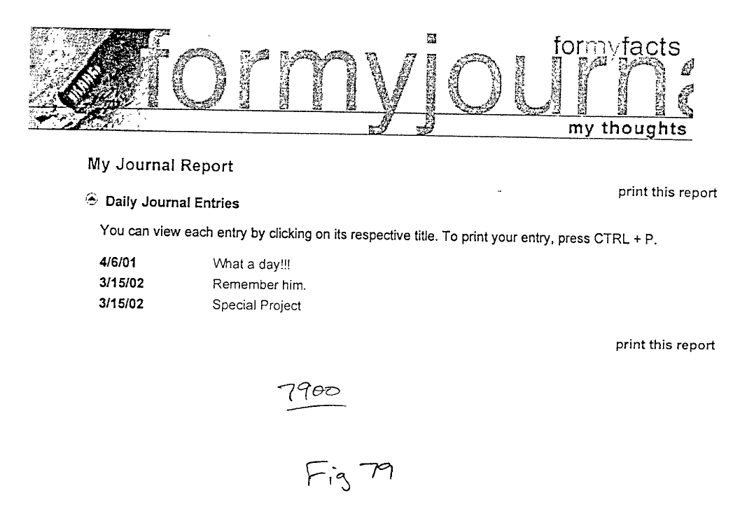

A journal report 7900 (FIG. 79) may be accessed by selecting a my journal entries link 7260 from the journal home page 7200. The journal report 7900 may list journal entries by date and title. By selecting a one of the journal entries, the text associated with the entry may be viewed.

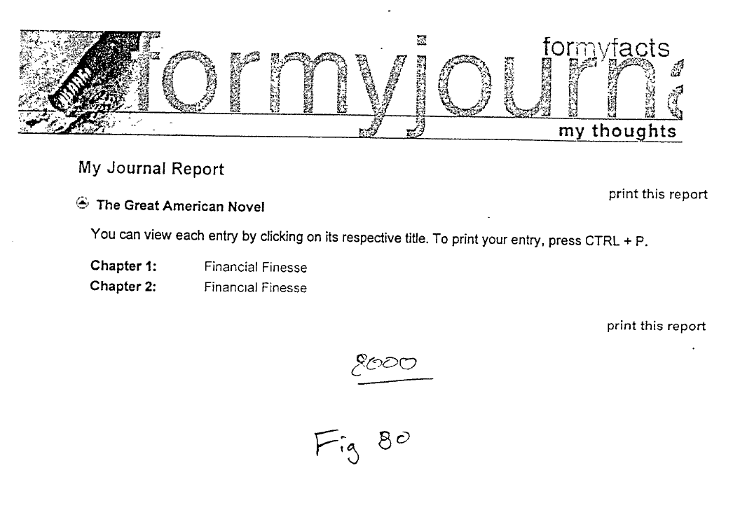

A novel entry report 8000 (FIG. 80) may be accessed by selecting a novel entries link 7264 provided on the journal home page 7200. The novel entries report 8000 provides a listing of novel entry headings. Text associated with the entered headings may be accessed by selecting an enumerated heading.

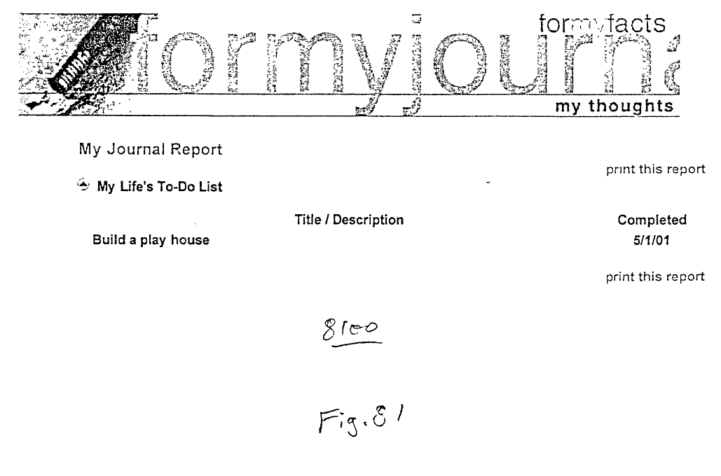

A to do list report 8100 (FIG. 81) may be accessed by selecting the to do list link 7268 provided on the journal home page 7200. The to do list report 8100 generally contains a listing of items provided in connection with the to do list form 7252.

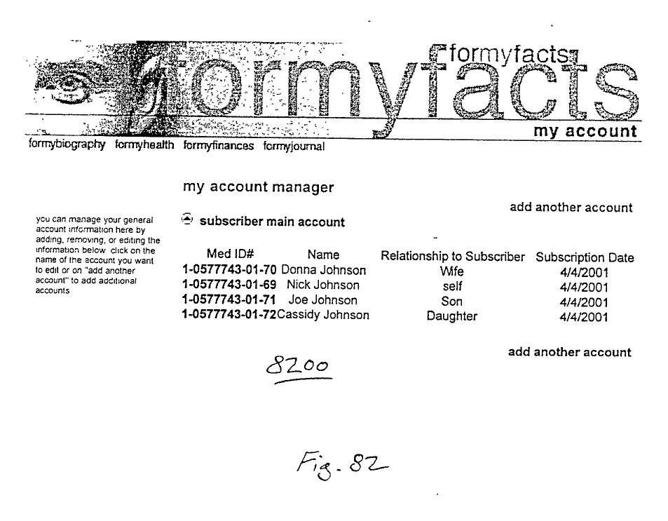

With reference again to FIG. 8, a calendar 820 may be provided as a convenient reference to the user 114. The calendar 820 may be provided on various pages. The calendar may indicate the current date, and may be used to enter appointments and other information. Calendar entries may be selectively listed below the calendar in a calendar entry space 824. In addition, links to various other features of the virtual file cabinet may be provided in connection with the category selection screen 800, and in connection with other screens, such as the category home pages 900, 2700, 5200 and 7200. These links may include a virtual file cabinet system 100 account manager link 828. In response to selection of an account manager link 828, the user 114 may be presented with an account manager page 8200 (FIG. 82).

The account manager page 8200 allows the user 114 to review or update information regarding accounts associated with the individual user 114. For example, the user 114 may provide account subscriptions for members of the user's immediate family. In addition, the account manager screen 8200 may list medical I.D. numbers assigned to the user 114 and the user's immediate family members.

An interest link 832 may also be provided. By clicking on the interest link 832, the user is presented with an interest update screen 8300 (FIG. 83). The interest update screen 8300 allows the user 114 to indicate whether permission is granted to utilize information provided by the user 114 to provide articles, web sites, promotional information and other items of information that may be of interest to the user 114. In addition to information regarding the user's interests that may be obtained from information provided in connection with the completion of various forms, the interest update screen 8300 may additionally allow a user 114 to select from a number of listed interests in connection with which the user 114 desires to receive information.

As can be appreciated from the description provided herein, a virtual file cabinet system 100 in accordance with the present invention provides a convenient means for an individual user 114 to organize and store personal information. In addition, the virtual file cabinet system 100 facilitates the collection and use of personal information. In particular, the present invention allows a user to conveniently prepare reports containing personal information that can be provided to third parties in connection with, for example, requests for services. The present invention additionally provides access to resources to assist a user in generating information derived from information stored in connection with the virtual file cabinet system 100 or provided by the user at the time the resource is used.

As can also be appreciated by one of skill in the art, various implementations of a virtual file cabinet system 100 are possible. For example, a database 328 established in connection with the present invention may be distributed among a variety of storage devices or storage subsystems. Furthermore, it can be appreciated that items of data described as being located within the database 328 can be sited elsewhere, in accordance with the present invention. For example, resources accessible in connection with a virtual file cabinet system 100 of the present invention may be located on servers or terminals 116 operated by third parties 120.

In addition to the various advantages described above, it should be appreciated that a virtual file cabinet system 100 in accordance with the present invention facilitates the electronic delivery of information. For example, by storing personal informnation in central location, and by allowing reports containing selected pieces of that information to be easily generated, selected information can be provided to third parties 120 in an automated or semiautomated fashion. In addition to being convenient, this capability allows the system 100 to be used in connection with providing potentially life saving informnation. For example, information can be electronically provided to emergency service providers regarding the health of a user 114 carrying an authorization card allowing a third party medical service provider 120 access to such informnation.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A method for using personalized, categorized information subject to limited access, comprising:
providing a network that includes a control and a plurality of terminals that can access said control and said plurality of terminals including a first terminal useable by a first user and a second terminal useable by a second user;
defining a plurality of categories including at least a first category and a second category, said first category being associated with a first one of biographical, health and financial information and said second category being associated with a second one of said biographical, health and financial information, said first one including first information related to the first user and second information related to the second user, said second one including third information related to the first user and fourth information related to the second user, said first and third information being accessible by the first user and not the second user and said second and fourth information being accessible by the second user and not the first user;
generating a first report using at least some of said first information and some of said third information using said control and said first terminal; and
generating a second report using at least some of said second information and some of said fourth information using said control and said second terminal.

2. A method, as claimed in claim 1, wherein:
said generating steps include providing a plurality of forms including at least a first form and each of said steps of generating said first report and generating said second report includes using input information responsive to said first form.

3. A method, as claimed in claim 1, further including:
having available a plurality of resources including at least a first resource related to said first category and a second resource related to said second category;
selecting said first resource by the first user using said control and said first terminal; and
selecting said first resource by the second user using said control and said second terminal.

4. A method, as claimed in claim 3, wherein:
said first resource relates to at least one of: a growth chart, ideal body weight calculator, a BMI calculator, cholesterol information, blood pressure information, immunization chart, MIB, picture and an EKG uploader.

5. A method, as claimed in claim 3, wherein:
said first resource relates to at least one of: financial definitions, assets and institutional organizer, mortgage calculator, return on investment calculator, social security request, and credit report request.

6. A method, as claimed in claim 3, wherein:
said first resource relates to at least one of: resume generator, resume tutorial, driving record request, hobbies, sports, scouting and advancements, and a transcripts uploader.

7. A method, as claimed in claim 1, further including:
providing a number of information generators including at least a first information generator; and
accessing said first information generator using said control and said first terminal by the first user; and
producing processed information using input information from the first user and said first information generator.

8. A method, as claimed in claim 1, wherein:
said first report comprises a compilation of information from a plurality of said categories.

9. A method, as claimed in claim 1, wherein:
said first report includes at least one of: a health report, an emergency medical report, an underwriting report, and immunization environmental report, a vision report, a dental report, and an insurance application.

10. A method, as claimed in claim 1, wherein:
said first report includes at least one of: an asset allocation report by worth, by institution and by goals, and a financial statement of liabilities, income, goals, a loan application and a general financial statement.

11. A method, as claimed in claim 1, wherein:
said first report includes at least one of: a resume, a biography report, a contact listing and an educational-related transcript.

12. A method, as claimed in claim 1, wherein said step of generating said first report includes:
providing a plurality of forms including at least a first form related to said first category and a second form related to said second category;
accessing information related to said first category by the first user using said control and said first terminal;
making a request using said first form to the first user;
inputting first input information by the first user using said first form, said first input information being related to said first information;
storing first stored information in a first memory area of a memory using said control, said first stored information being related to said first input information; and
obtaining from said first memory area at least some of said first stored information.

13. A method, as claimed in claim 1, wherein said step of generating said second report includes:
providing a plurality of forms including at least a first form related to said first category and a second form related to said second category;
accessing information related to said first category by the second user using said control and said second terminal;
making a request using said first form to the second user;
inputting second input information by the second user using said first form and said second terminal, said second input information being related to said second information;
storing second stored information in a second memory area of said memory using said control, said second stored information being related to said second input information; and
obtaining from said second memory area at least some of said second stored information using said control.

14. A method, as claimed in claim 1, wherein:
said first information includes special access information and said method further includes using identification information carried by the first user to obtain said special access information.

15. A method, as claimed in claim 1, wherein:
said first set of information includes approved information and said method further includes accessing said approved information by a person other than the first user and using a terminal different from said first terminal.

16. A method, as claimed in claim 1, wherein said defining step includes:
displaying on said first terminal information related to said first one of said biographical, health and financial information; and
displaying on said first terminal information related to said second one of said biographical, health and financial information.

17. A method, as claimed in claim 15, wherein:
said step of displaying related to said second one occurs at a time different from said step of displaying related to said first one.

18. A method, as claimed in claim 1, wherein each of said plurality of categories comprises subcategories.

19. A method, as claimed in claim 18, wherein said first category is associated with at least biographical information, and wherein subcategories within said biographical information include at least one of: general, contacts, education, community, career, hobbies, and sports.

20. A method for providing a virtual file cabinet, comprising:
defining a plurality of categories including at least a first category and a second category, said first category being associated with a first one of biographical, health and financial information and said second category being associated with a second one of said biographical, health and financial information;
providing a first form to a first user;
receiving first information from the first user responsive to said first form, wherein said first information is related to said first category;
storing said first information;
providing said first form to a second user;
receiving second information from the second user responsive to said first form, wherein said second information is related to said first category;
providing a second form to the first user;
receiving third information from the first user responsive to said second form, wherein said third information is related to said second category;
providing said second form to the second user;
receiving fourth information from the second user responsive to said second form, wherein said fourth information is related to said second category;
generating a first report, wherein said first report comprises some of said first information and some of said third information;
providing said first report to the first user, wherein said first report is not available to the second user;
generating a second report, wherein said second report comprises some of said second information and some of said fourth information;
providing said second report to the second user, wherein said second report is not available to the first user.

21. The method of claim 20, wherein said first report comprises less than all of at least one of said first information and said third information.

22. The method of claim 20, further comprising:
receiving a request to generate said first report from the first user, wherein said step of generating said first report is performed in response to said request.

23. The method of claim 20, further comprising:
providing said first report to a first authorized user, wherein said second report is not available to the first authorized user.

24. The method of claim 20, further comprising:
providing a first information generator;
producing processed information by providing at least one of at least a portion of said first information and at least a portion of said third information to said first information generator.

25. The method of claim 24, further comprising:
storing said processed information, wherein said processed information is accessible to the first user.

26. A virtual file cabinet system, comprising:
a control, including:
data storage;
a communication interface;
a communication network, wherein said communication network is interconnected to said communication interface of said control;
a plurality of user terminals, each including:
a user input;
a user output;
a communication interface, wherein each of said user terminals is interconnected to said control by said communication network,
wherein first information related to a first category input at a first of said user terminals by a first user and stored in said data storage is accessible to the first user but not to a second user,
wherein second information related to said first category input at a second of said user terminals by the second user and stored in said data storage is accessible to the second user but not the first user,
wherein third information related to a second category input at said first of said user terminals by the first user and stored in the data storage is accessible to the first user but not to the second user,
wherein fourth information related to said second category input at said second of said user terminals by the second user is accessible to the second user but not the first user,
wherein a first report generated by said control containing at least a portion of said first and third information is available to said first user and a first authorized party but not the second user, and
wherein a second report generated by said control containing at least a portion of said second information and fourth information is available to said second user and at least one of the first authorized party and a second authorized party but not to the first user.

27. The system of claim 26, wherein said control comprises a server, said plurality of terminals comprise client computers, and said communication network comprises the Internet.

28. A method for storing and compiling personal information, comprising:
receiving from a first user first personal information related to at least first and second categories of information;
storing said first personal information;
receiving from a second user second personal information related to at least said first and second categories of information;
storing said second personal information;
in response to receiving a request for information related to a first purpose from the first user, generating a first report containing at least a first portion of said first personal information;
providing said first report to the first user;
in response to receiving a request for information related to one of said first purpose from the second user, generating a second report containing at least a first portion of said second personal information; and
providing said second report to the second user.

29. The method of claim 28, wherein said first category of information is associated with a first one of biographical, health and financial information, and wherein said second category of information is associated with a second one of said biographical, health and financial information.

30. The method of claim 28, further comprising:
in response to receiving a request for information related to a second purpose from the first user, generating a third report containing at least a second portion of said first personal information.

31. The method of claim 28, further comprising:
providing said first report to a first authorized party.

32. The method of claim 28, wherein said first purpose is associated with at least one of a request for insurance, a request for credit and a job search.

33. The method of claim 28, wherein said first information is provided in response to a form.

34. The method of claim 28, further comprising:
providing a plurality of forms including at least a first form related to said first category of information and at least a second form related to said second category of information.

35. The method of claim 34, further comprising:
making a request to said first user using said at least a first form.

36. The method of claim 28, further comprising:
providing a portion of said first user personal information to a first authorized party, wherein none of said second user personal information is provided to said first authorized party.

37. The method of claim 28, wherein said first personal information includes special access information, wherein in response to receiving first identification informnation related to said first user said special access information is released.

38. A method for storing and retrieving personal information, comprising:
receiving a form requesting first information related to at least a first category of information, said first category being associated with at least a first one of biographical, health and financial information;
providing said first information;
receiving a form requesting second information related to at least a second category of information, said second category being associated with at least a second one of biographical, health and financial information;
providing said second information;
requesting a first report, wherein said first report is related to a first purpose; and
receiving said first report, wherein said first-report contains at least a first portion of said first information.

39. The method of claim 38, further comprising:
requesting a second report, wherein said second report is related to a second purpose; and
receiving said second report, wherein said second report contains at least a second portion of said first information, wherein said second portion is different from said first portion.

40. The method of claim 39, wherein said first portion of information and said second portion of information contain common pieces of information.

41. The method of claim 38, further comprising:
authorizing access to at least one of said first information, said second information, and said first report by an authorized user.
